(19) United States
(12) Patent Application Publication
(10) Pub. No.: US 2017/0072982 A1
(43) Pub. Date: Mar. 16, 2017

(54) Lightweight Collapsible Stroller

(71) Applicant: Thorley Industries LLC, Pittsburgh, PA (US)

(72) Inventors: Henry F. Thorne, Sewickley Heights, PA (US); Robert D. Daley, Pittsburgh, PA (US); Frederick Karl Hopke, Medway, MA (US); Justine Rembisz, Pittsburgh, PA (US); John J. Walker, Pittsburgh, PA (US); Elijah M. Wiegmann, Natrona Heights, PA (US); Mary J. Koes, Pittsburgh, PA (US)

(21) Appl. No.: 15/360,358

(22) Filed: Nov. 23, 2016

Related U.S. Application Data
(63) Continuation-in-part of application No. 14/660,342, filed on Mar. 17, 2015, now Pat. No. 9,505,423.
Application No. 14/660,342 is a continuation-in-part of application No. 14/581,094, filed on Dec. 23, 2014, now Pat. No. 9,446,779.
Application No. 14/581,094 is a continuation of application No. 13/672,038, filed on Nov. 8, 2012, now Pat. No. 8,944,457.
Application No. 13/672,038 is a continuation-in-part of application No. 13/109,328, filed on May 17, 2011.
Application No. 13/109,328 is a continuation of application No. 12/032,370, filed on Feb. 15, 2008, now abandoned.
(60) Provisional application No. 61/557,694, filed on Nov. 9, 2011.
(60) Provisional application No. 60/890,597, filed on Feb. 19, 2007.
(60) Provisional application No. 60/890,601, filed on Feb. 19, 2007.
(60) Provisional application No. 60/890,605, filed on Feb. 19, 2007.
(60) Provisional application No. 60/890,607, filed on Feb. 19, 2007.
(60) Provisional application No. 60/890,608, filed on Feb. 19, 2007.
(60) Provisional application No. 60/890,613, filed on Feb. 19, 2007.
(60) Provisional application No. 60/890,616, filed on Feb. 19, 2007.
(60) Provisional application No. 60/890,618, filed on Feb. 19, 2007.
(60) Provisional application No. 60/890,619, filed on Feb. 19, 2007.
(60) Provisional application No. 60/890,624, filed on Feb. 20, 2007.

(51) Int. Cl. B62B 7/06; B62B 9/26; B62B 7/08; B62B 7/00

(52) U.S. Cl. CPC B62B 7/068; B62B 7/006; B62B 7/066; B62B 9/26; B62B 7/086; B62B 2205/003; B62B 2205/02

(57) ABSTRACT

A lightweight collapsible stroller is provided. The stroller includes: a frame including a first portion movable relative to a second portion; a drive mechanism coupled to the frame, which moves the first portion relative to the second portion, thereby transitioning the frame between an open position and a closed position; and a latch mounted to the frame. The latch is positioned to engage at least a portion of the first portion or the second portion when the frame is in its open position to restrict the first portion from moving relative to the second portion. Upon actuation, the drive mechanism causes the latch to release, such that the first portion of the frame moves relative to the second portion of the frame, thereby allowing the frame to transition to the closed position.

### CROSS REFERENCE TO RELATED APPLICATIONS

This application is: a continuation-in-part of U.S. patent application Ser. No. 14/660,342, filed Mar. 17, 2015, which is a continuation-in-part of U.S. patent application Ser. No. 14/581,094, filed on Dec. 23, 2014, which issued as U.S. Pat. No. 9,446,779 on Sep. 20, 2016, which is a continuation of U.S. patent application Ser. No. 13/672,038, filed Nov. 8, 2012, which issued as U.S. Pat. No. 8,944,457 on Feb. 3, 2015, which claims priority to U.S. Provisional Patent Application No. 61/557,694 filed on Nov. 9, 2011; and a continuation-in-part of U.S. patent application Ser. No. 13/109,328, filed May 17, 2011, which is a continuation of U.S. patent application Ser. No. 12/032,370, filed Feb. 15, 2008, now abandoned, which claims priority to U.S. Provisional Application No. 60/890,597, filed Feb. 19, 2007; 60/890,601, filed Feb. 19, 2007; 60/890,605, filed Feb. 19, 2007; 60/890,607, filed Feb. 19, 2007; 60/890,608, filed Feb. 19, 2007; 60/890,613, filed Feb. 19, 2007; 60/890,616, filed Feb. 19, 2007; 60/890,618, filed Feb. 19, 2007; 60/890,619, filed Feb. 19, 2007; and 60/890,624, filed Feb. 20, 2007, the disclosure of each of which is hereby incorporated by reference in its entirety.

### BACKGROUND OF THE INVENTION

Field of the Invention

The present invention relates generally to strollers, and more particularly, to lightweight baby strollers adapted for use during active movement such as jogging.

Description of Related Art

Baby strollers, also referred to as baby carriages, baby buggies, or prams, have been used to hold and transport babies and young children for many years. Early baby strollers had parts that were fixedly secured to one another such that they did not fold for compactness. Baby strollers have been designed to have some parts which are movable relative to one another to allow movement of some parts of the stroller to achieve a more compact configuration when not in use. However, current strollers do not allow for movement or folding to compact configuration as desired, and are cumbersome and sometimes difficult to move between their collapsed (closed) positions and their operative (open) positions, particularly when attending to a baby or child. More recently, strollers that automatically transition between their collapsed and operative positions, such as a stroller that does so upon the push of a button via motorized movement, have recently been created.

In addition to designing baby strollers that are easily foldable to compact and transportable configurations, efforts have been directed to reducing the total weight of baby strollers so that the effort required to push the stroller is effectively reduced. Lightweight strollers are especially desirable for use during physically demanding activities such as pushing the stroller while jogging. In addition, lightweight strollers are clearly easier to transport (e.g., loading into cars, carrying up stairs) particularly for smaller users. Efforts to reduce the overall weight of a baby stroller include replacing metal structural materials with lightweight structural materials such as hard plastics. In addition, new stroller designs have been proposed which use fewer structural members, reduce the length and width of frame materials, or which replace structural framing materials with tubular hollow framing materials. However, lightweight strollers generally lack the improved functionality, structural stability, and stylish design which users expect from larger heavier models.

Therefore, a need exists for a lightweight jogging stroller formed substantially from lightweight materials such as hard plastics. The stroller should effectively achieve the functional advantages of heavier strollers (e.g., automatic folding, full suspension, expansive onboard storage, electric safety features such as day time running lights, safety sensors, etc.). The stroller should also exhibit good structural stability and should not bend or pivot when pushed on by a user. The stability of the device should inspire confidence in users. A lightweight stroller exhibiting at least these features is described herein.

### SUMMARY OF INVENTION

The present invention provides a lightweight stroller which can be quickly and easily transitioned between a closed position and an open position. The stroller includes a right frame and a left frame. Each frame has a front support rotatably connected to a rear support at a frame joint. The front support of each frame is a telescoping tube assembly which includes: an outer tube extending from an end of the front support to the frame joint of the support; an inner tube assembly partially inserted within the outer tube and protruding from the outer tube; and, a slot extending longitudinally along at least a portion of the outer tube. The stroller further includes a linkage comprising at least two substantially rigid members connected between the right frame and the left frame, the rigid members being connected to the front supports at a right slidable joint and a left slidable joint. The joints are received within the slot of the outer tube. A drive mechanism coupled to the right or left frame is also provided. The front support and the rear support of the right frame and the left frame are movable from an open position to a closed position by the drive mechanism. In addition, transitioning the stroller from the open position to the closed position causes the slidable joints to slide downward along the slots of the outer tube.

In certain configurations, the inner tube assembly of the stroller includes: an inner tube which is inserted partially within the outer tube and protrudes from the outer tube at the frame joint; a tube stiffening member inserted within the outer tube and disposed below the slidable joint when the front support is in the open position, the tube stiffener having a slot which corresponds with the slot of the outer tube; and, an extension member extending between an end of the inner tube which is inserted in the outer tube and the slidable joint. Optionally, the extension member is configured to push the slidable joint longitudinally through the slot of the tube stiffener and the slot of the outer tube when the stroller transitions from the open position to the closed position, and the extension member is received within the slot of the tube stiffener. The tube stiffener may further include an unbroken sidewall enclosing a hollow portion extending longitudinally through the tube stiffener.

In certain further configurations of the stroller, the drive mechanism includes a cable drive, a spool rotated by the cable drive, and a cable received by the spool, wherein the cable is coupled to the inner tube. The cable drive may be in direct rotational connection with the spool. Preferably, the cable is formed of a synthetic polymer, such as ultra-high molecular weight polyethylene. The stroller may also include a biasing member connected in series with the cable for removing slack from the cable while the drive mechanism is engaged. The drive mechanism may be powered by a battery, an electrical generator, a spring, compressed air, or any combination thereof.

In certain configurations, the linkage of the stroller is a scissor linkage configured such that the rigid members are connected between the front support of one frame and the rear support of the other frame and, wherein the rigid members of the scissor linkage are connected at a rotatable center joint such that as the stroller transitions from the open position to the closed position, the rigid members rotate about the center joint bringing ends of the rigid members closer together. Optionally, the stroller also includes an activation button for engaging the drive mechanism. The activation button may be a dead man switch. The stroller may further include a screen for presenting information to a user, wherein the information includes air temperature, battery power, time, speed, or distance traveled.

In certain configurations, the stroller further includes a parallelogram linkage connected between the right frame and the left frame, the parallelogram linkage comprising: a foldable upper horizontal member; a foldable lower horizontal member approximately parallel to the upper horizontal member; and, a latch, which when engaged, maintains the members in an extended position and when disengaged permits the members to fold. In addition, the stroller may further include a parallelogram drive mechanism coupled to the parallelogram linkage for transitioning the horizontal members of the parallelogram linkage from the extended position to the folded position.

In certain configurations, a storage assembly may be affixed to the stroller. Optionally, the storage assembly includes: a storage bag; at least one cable fixedly attached to the right frame and at least one cable fixedly attached to the left frame; and a flexible joint for connecting the cables to the bag. The storage assembly is configured such that the bag remains in an expanded position when the frame moves from the open position to the closed position.

In accordance with a further aspect of the present invention, a stroller is provided which includes: a right frame and a left frame, each frame comprising a front support rotatably connected to a rear support at a frame joint; a parallelogram linkage connected between the right frame and the left frame comprising a foldable upper horizontal member, a foldable lower horizontal member approximately parallel to the upper horizontal member, and, a latch, which when engaged, maintains the members in an extended position and when disengaged permits the members to fold; and, a drive mechanism coupled to the frame or parallelogram linkage. The invented stroller provides that the front support and the rear support of the right frame and the left frame are movable from an open position to a closed position, the horizontal members of the parallelogram linkage transition from the extended position to the folded position concurrently with the transition of the frame from the open position to the closed position, and movement of the frames or transition of the parallelogram linkage is effectuated by the drive mechanism.

In certain configurations, the drive mechanism includes a drive, a gear engaged with and driven by the drive, and a locking member connected to the gear. Optionally, the locking member engages the upper or lower horizontal member of the parallelogram linkage for transitioning the parallelogram linkage from the extended position to the folded position. The drive mechanism includes a manual clutch configured to selectively engage and disengage the drive from the gear. Furthermore, the drive may be configured such that as the drive is being engaged with the gear, the drive applies a light preload pressure to align the drive and gear before a full force of the drive is applied to the gear.

In accordance with a further aspect of the present invention, a stroller is provided which includes a frame movable from an open position to a closed position and a drive mechanism coupled to a portion of the frame. The drive mechanism includes: a cable drive; a spool rotated by and in direct rotational connection with the cable drive; a cable received by the spool; and, a biasing member connected in series with the cable for removing slack from the cable when the drive mechanism is engaged.

According to another aspect of the disclosure, a lightweight collapsible stroller is provided. The stroller includes: a frame comprising a first portion movable relative to a second portion; a drive mechanism coupled to the frame, which moves the first portion relative to the second portion, thereby transitioning the frame between an open position and a closed position; and a latch mounted to the frame. The latch is positioned to engage at least a portion of the first portion or the second portion when the frame is in its open position to restrict the first portion from moving relative to the second portion. Upon actuation, the drive mechanism causes the latch to release, such that the first portion of the frame moves relative to the second portion of the frame, thereby allowing the frame to transition to the closed position.

According to another aspect of the disclosure, a stroller includes: a frame having a fixed outer tube and an inner tube at least partially slidably inserted in the outer tube; a drive mechanism coupled to the frame, which causes the inner tube to slide into the outer tube as the frame transitions between an open position and a closed position; and at least one latch mounted to the outer tube. The latch is positioned to engage at least a portion of the inner tube when the frame is in its open position to restrict the inner tube from sliding into the outer tube. Upon actuation, the drive mechanism causes the latch to release the inner tube, thereby allowing the frame to transition to the closed position.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

For the purpose of facilitating understanding of the invention, the accompanying drawings and description illustrate preferred embodiments thereof, from which the invention, various embodiments of its structures, construction and method of operation, and many advantages may be understood and appreciated.

FIG. 1 is an isometric view of a stroller embodying various features of the present invention, with the illustrated stroller shown in its open position;

FIG. 2 is a bottom view of the stroller of FIG. 1 shown in its open position;

FIG. 3 is a side view of the stroller of FIG. 1 shown in its open position;

FIG. 4 is an isometric view of the stroller of FIG. 1 shown in its partially open position;

FIG. 5 is a bottom view of the stroller of FIG. 1 shown in its partially open position;

FIG. 6 is a side view of the stroller of FIG. 1 shown in its partially open position;

FIG. 7 is an isometric view of the stroller of FIG. 1 shown in its fully closed position;

FIG. 8 is a bottom view of the stroller of FIG. 1 shown in its fully closed position;

FIG. 9 is a side view of the stroller of FIG. 1 shown in its fully closed position;

FIG. 10 is a top view of the stroller of FIG. 1 shown in its fully closed position;

FIG. 11 is a schematic isometric view illustrating the drive mechanism of the stroller of FIG. 1;

FIG. 12 is a side schematic view of the drive mechanism of FIG. 11;

FIG. 13 is a bottom view illustrating of the drive mechanism of FIG. 12;

FIG. 14 is a partial side schematic view of the linkage of the handle bar of the stroller of FIG. 1 shown in its fully open position;

FIG. 14A is an enlarged view of a latching mechanism;

FIG. 15 is a partial side schematic view of the linkage of FIG. 14 shown in its partially closed position;

FIG. 16 is a partial side schematic view of the linkage of FIG. 14 shown in its fully closed position;

FIG. 17 is an isometric schematic view of a stroller embodying various features of the present invention shown in its fully open position;

FIG. 18 a side view of the stroller of FIG. 17 shown in its fully open position;

FIG. 19 is a side view of the stroller of FIG. 17 shown in its partially open position;

FIG. 20 is a side view of the stroller of FIG. 17 shown in its fully closed position;

FIG. 21 is a schematic partial view of a latch and latch release mechanism of the stroller of FIG. 17 illustrating various features of the present invention; and

FIG. 22 is a partial isometric schematic view of the preferred latch release mechanism of the stroller of FIG. 17;

FIG. 23 is a partial isometric schematic view of the preferred latch drive mechanism of the stroller of FIG. 17;

FIG. 24 is a partial isometric view of a stroller embodying various features of the present invention shown in its fully open position;

FIG. 25A is a partial enlarged view of a handle bar linkage for interconnecting lateral handle bar components in the stroller of FIG. 1, with the handle bar linkage shown in its fully open position;

FIG. 25B is a partial enlarged view of the handle bar linkage of FIG. 25A shown in a partially closed position;

FIG. 26 is a forwardly directed perspective view of a collapsible stroller, according to an embodiment of the present invention, shown in its open position;

FIG. 27 is a front view of the stroller of FIG. 26 shown in its open position;

FIG. 28 is a rear view of the stroller of FIG. 26 shown in its open position;

FIG. 29 is a side view of the stroller of FIG. 26 shown in its open position;

FIG. 30 is a perspective view of the stroller of FIG. 26 shown in its fully closed position;

FIG. 31 is a front view of the stroller of FIG. 26 shown in its fully closed position;

FIG. 32 is a side view of the stroller of FIG. 26 shown in its fully closed position;

FIG. 33 is a forwardly directed perspective view of the stroller of FIG. 26 having a seat and a storage bag affixed thereto;

FIG. 34 is a rearwardly directed perspective view of the stroller of FIG. 26 having a seat and a storage bag attached thereto;

FIG. 35 is a perspective view of the inner tube assembly of the front support of the stroller of FIG. 26;

FIG. 36 is a perspective cross-sectional view of the angled member of stroller of FIG. 26 with an inner tube nested within an outer tube;

FIG. 37 is a magnified side view of the stroller of FIG. 26 focusing on the drive mechanism for the frame;

FIG. 38 is a cross-sectional view of the drive mechanism of FIG. 37;

FIG. 39 is a cross-sectional view of the upper portion of the inner tube of the angled member of the stroller of FIG. 26;

FIG. 40 is a magnified rear view of the stroller of FIG. 26 focusing on the parallelogram linkage and driving mechanism for the parallelogram linkage;

FIG. 41 is a magnified cross-sectional view of the drive mechanism for the foldable linkage of the stroller of FIG. 26 with the horizontal members in the extended position;

FIG. 42 is a top view of the stroller of FIG. 26 focusing on the a handles, activation button, and LCD screen;

FIG. 43 is a magnified view of the LED screen of the stroller of FIG. 26, positioned on the handle bar assembly;

FIG. 44 is a block diagram depicting the activation sequence of the stroller of FIG. 26;

FIG. 45 is a block diagram depicting the folding sequence of the stroller of FIG. 26;

FIG. 46 is a forwardly directed perspective view of another embodiment of a collapsible stroller, according to an aspect of the invention, shown in its open position;

FIG. 47 is a rearwardly directed perspective view of the stroller of FIG. 46 shown in its open position and focusing on a rear linkage assembly;

FIG. 48 is a back view of the stroller of FIG. 46 shown in its open position and focusing on the rear linkage assembly;

FIG. 49 is a back view of the stroller of FIG. 46 in its closed position and focusing on the rear linkage assembly;

FIG. 50 is a perspective view of a portion of the stroller of FIG. 46 in its open position and focusing on a stand structure;

FIG. 51 is a perspective view of a portion the stroller of FIG. 46 in its closed position and with the stand structure in an extended position;

FIG. 52A is a perspective view of a stroller with an automatically releasing latch according to an aspect of the disclosure;

FIG. 52B is an enlarged perspective view of the stroller of FIG. 52A enclosed by circle 52B;

FIG. 53 is another enlarged perspective view of the stroller of FIG. 52A with the latch in a locked position;

FIG. 54 is another enlarged perspective view of the stroller of FIG. 52A with the latch in a popped out position;

FIG. 55A is cross-sectional view of a telescoping tube assembly of the stroller of FIG. 53B taken at line 55A, in an open position;

FIG. 55B is cross-sectional view of the telescoping tube assembly of the stroller of FIG. 53B in an intermediate position; and

FIG. 55C is cross-sectional view of the telescoping tube assembly of the stroller of FIG. 53B, in a closed position.

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

### Power Folding Stroller

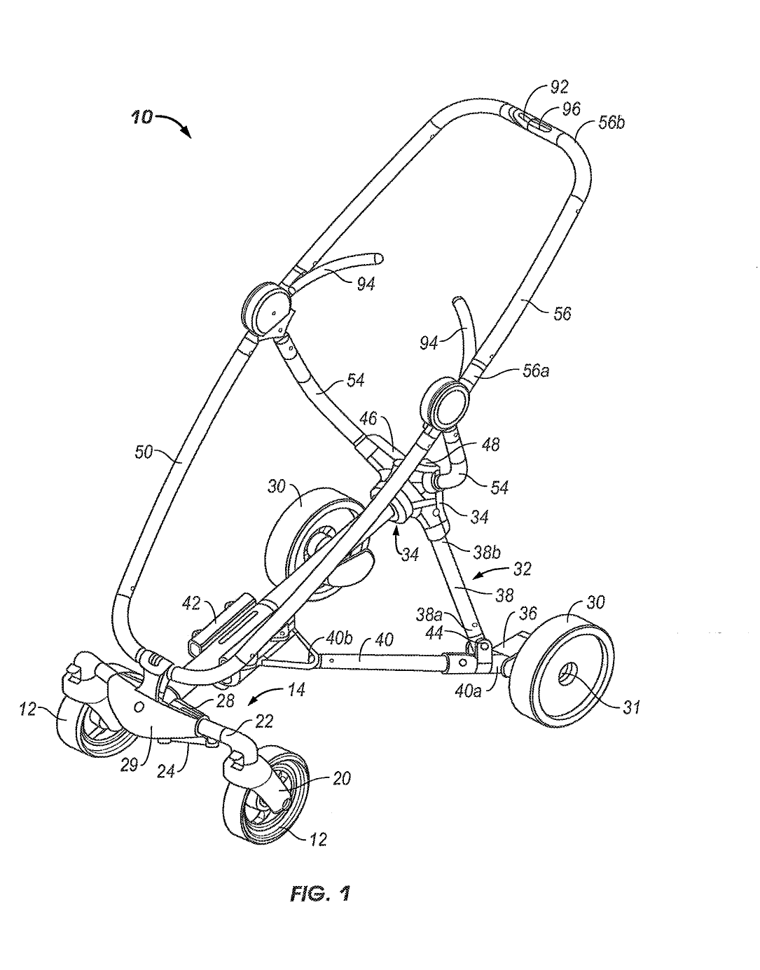

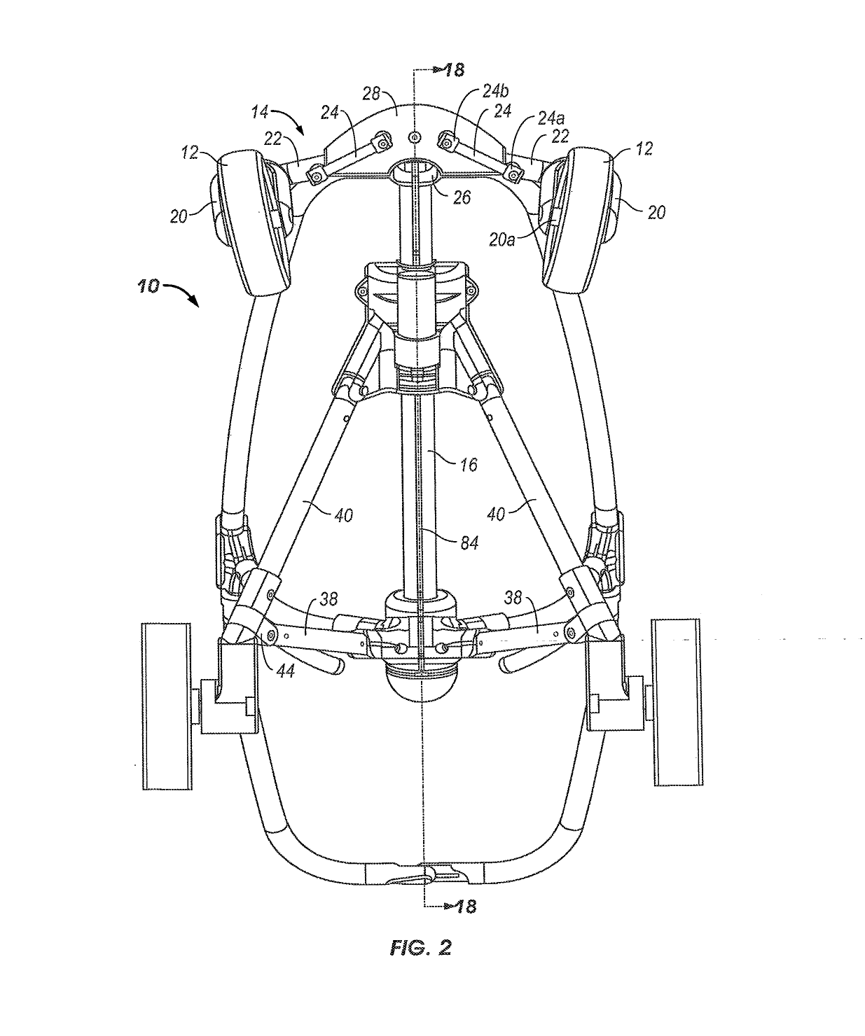

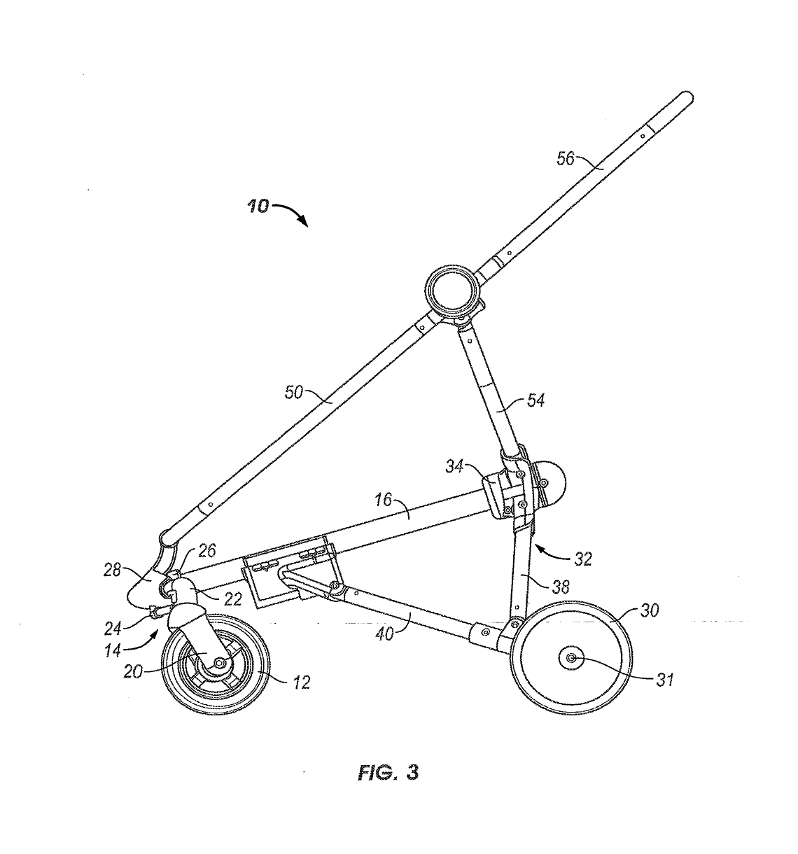

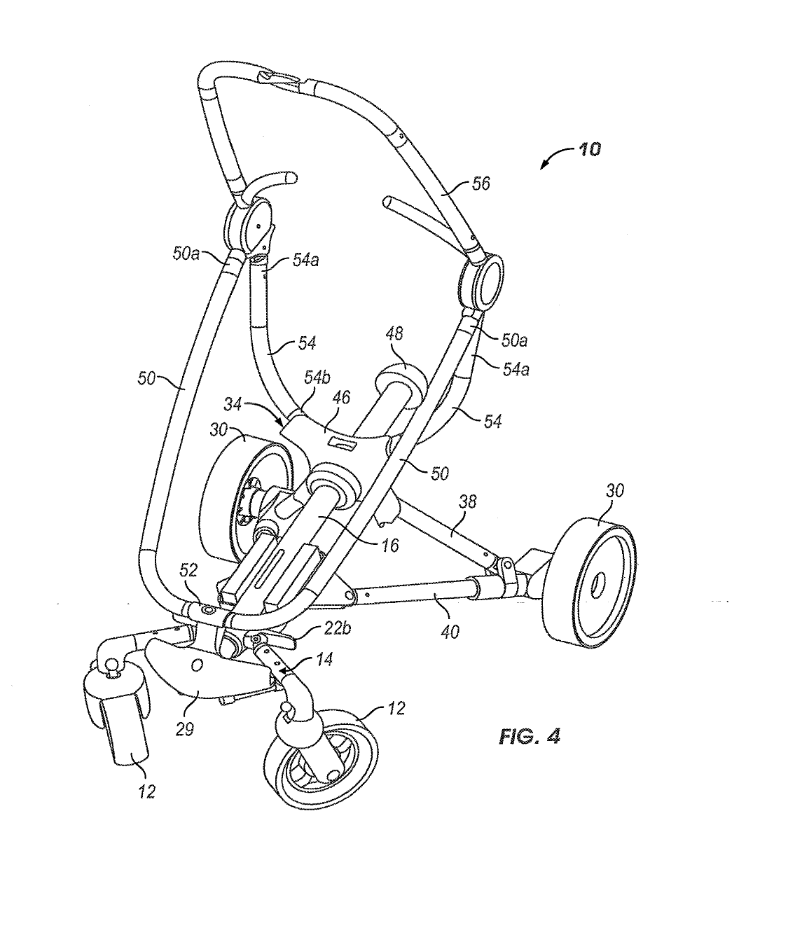

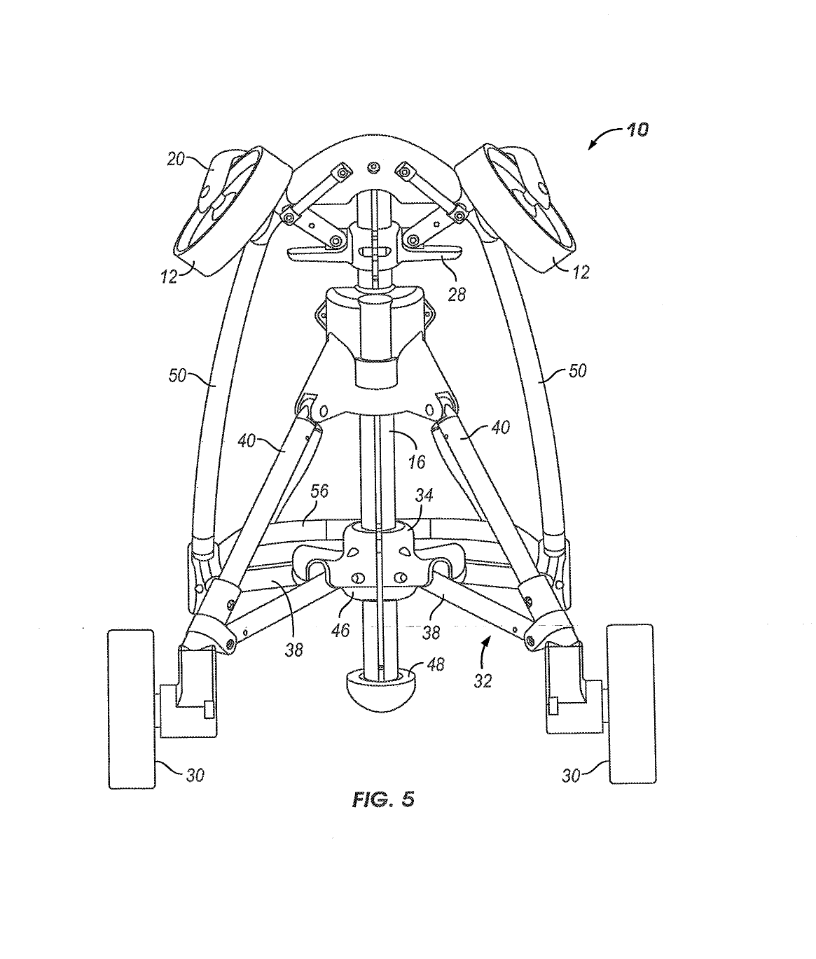

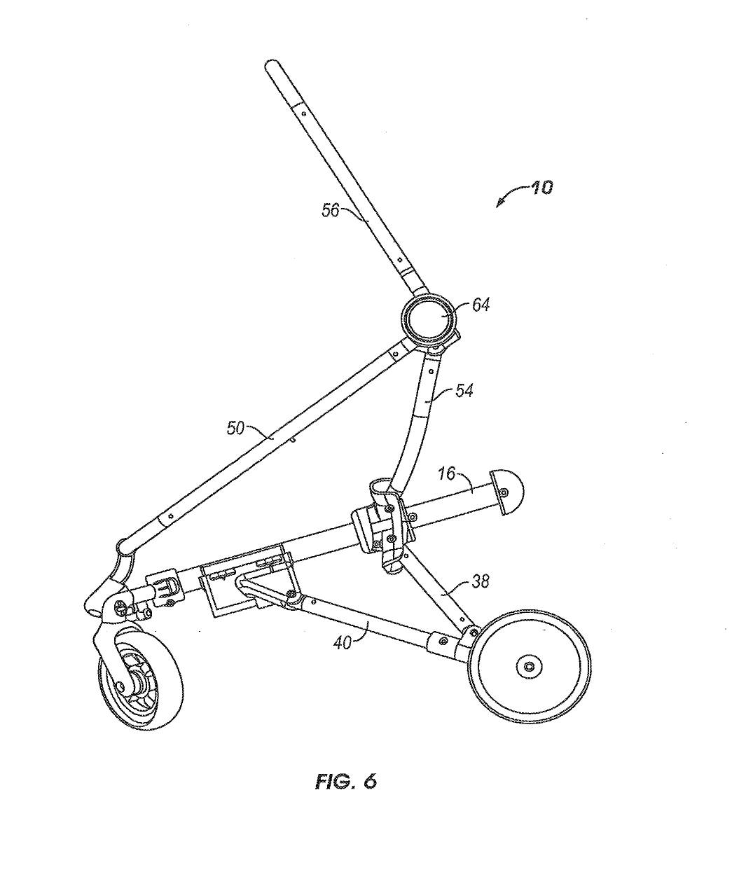

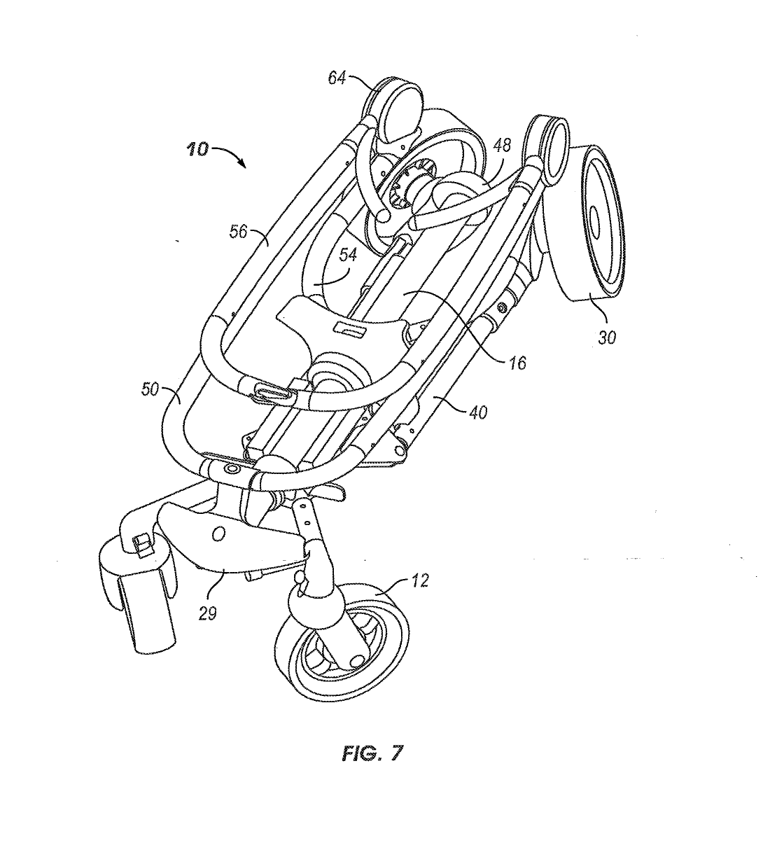

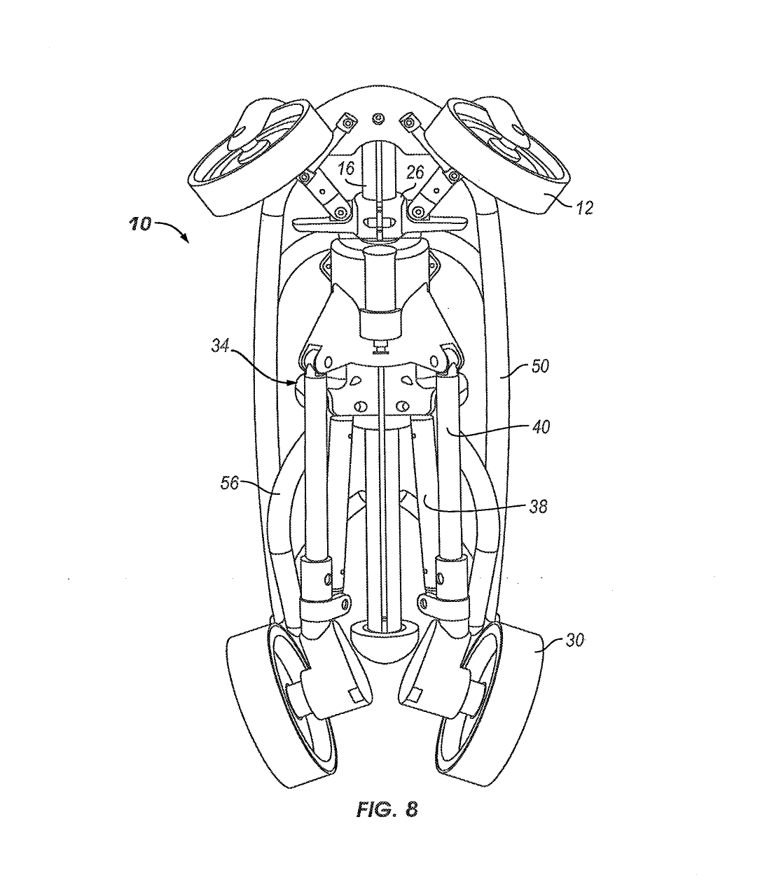

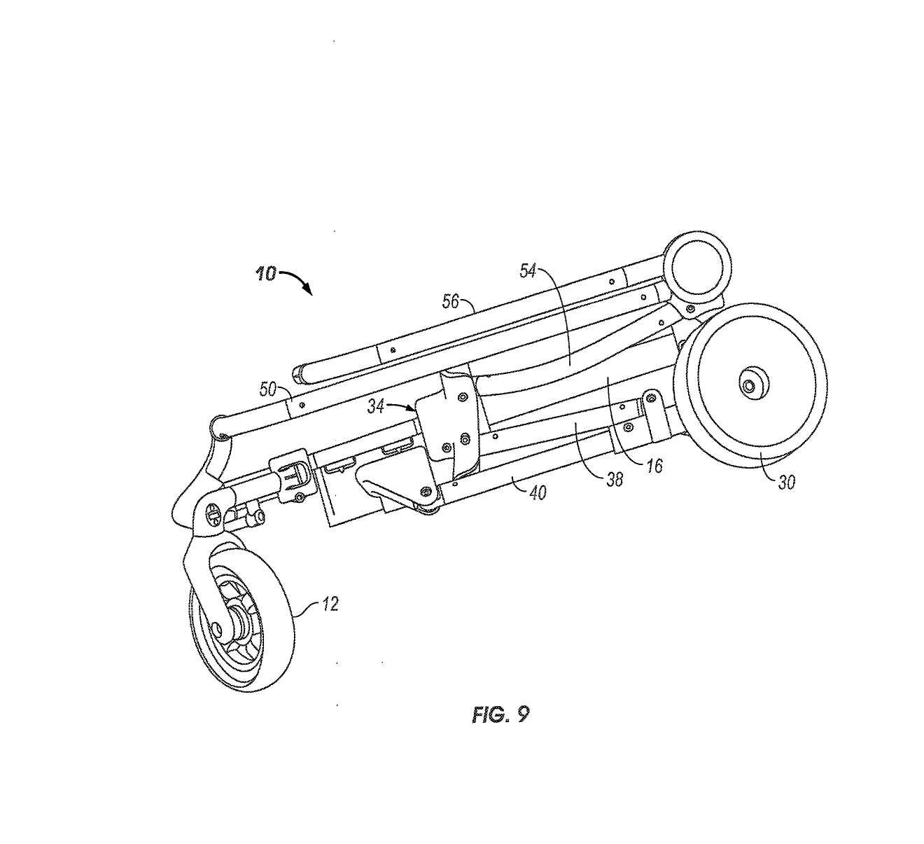

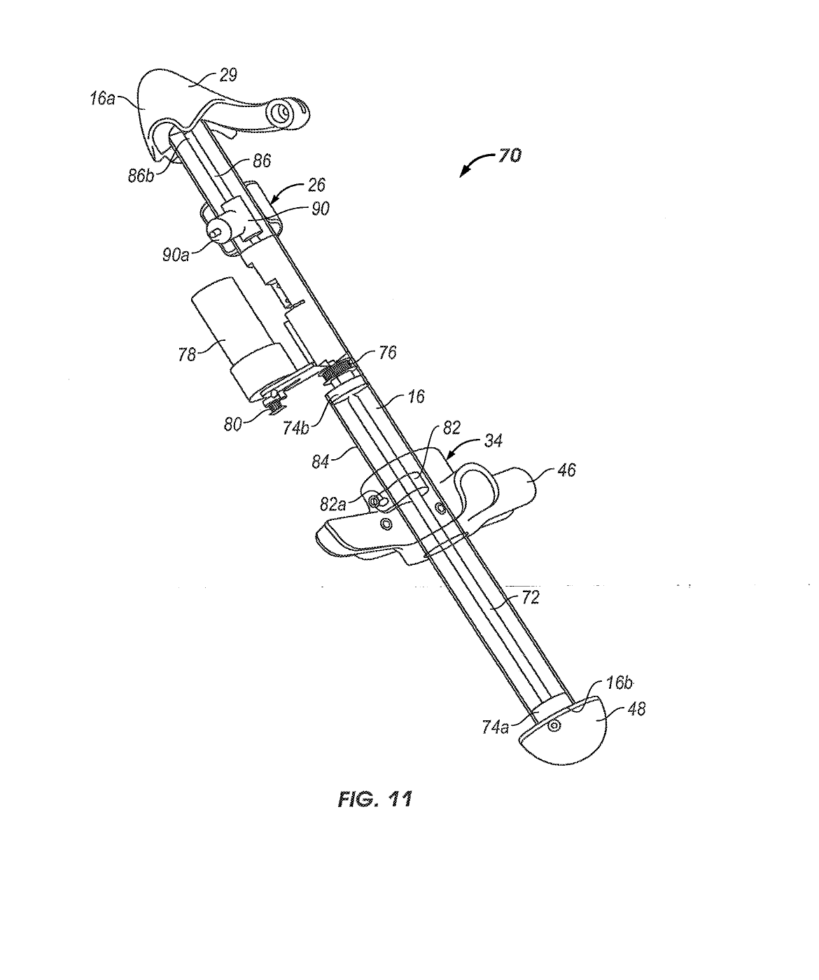

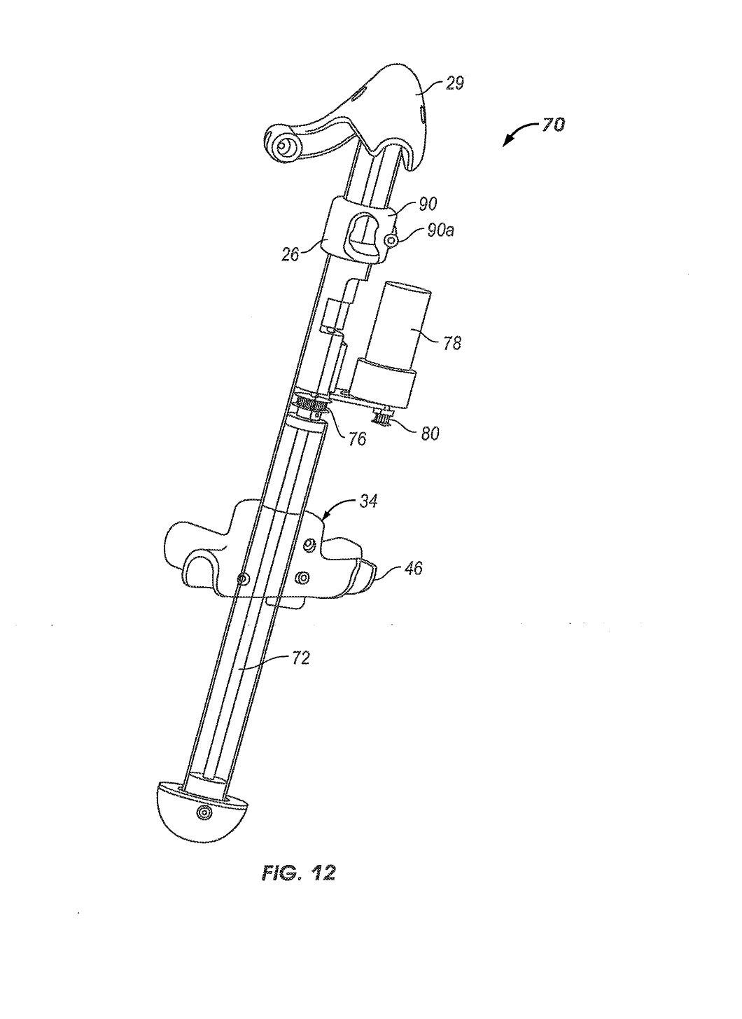

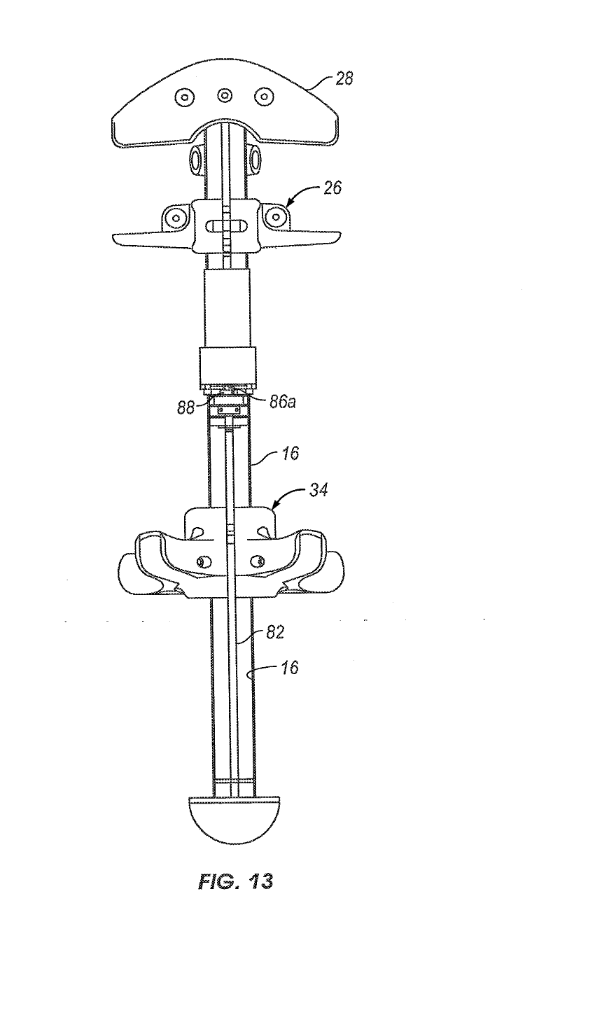

With reference to FIGS. 1-4 a stroller 10 is illustrated which comprises a pair of front wheels 12 having a front wheel support structure 14 for supporting the front wheels 12. The front wheel support structure 14 is slidably engaged with a guide rail 16 for sliding movement of the front collar portion 26 of the front wheel support structure 14 along the longitudinal axis 18 (see FIGS. 11-13) of the guide rail 16. The front wheel support structure 14 has members 20, 20a, 22, 24 and 26 which are movable between an open position (see FIGS. 1-4) and a collapsed position (see FIGS. 7-10) upon movement of the front collar 26 of the front wheel support structure 14 along the longitudinal axis 18 of the guide rail 16.

More specifically, the illustrated front wheel support structure 14 comprises a pair of generally U-shaped wheel receiving members 20 for receiving respective wheels 12, and axles 20a to allow the wheels 12 to roll about their respective axles 20a. The front wheel receiving members 20 are pivotally connected to a first end 22a of front wheel connector 22 to allow the wheels 12 to pivot about respective axes substantially parallel to their axes 20a to accommodate changes in the rolling direction of the front of the stroller. The second end 22b of the front wheel connector 22 is pivotally connected to the front collar 26. Struts 24 are pivotally connected at a first end 24a to the front wheel connector 22, and the struts 24 are pivotally connected at a second end 24b to the front abutment plate 29.

Accordingly, the front wheel connector 22, strut 24 and front collar 26 form a linkage whereby the front wheels 12 and their associated front wheel support structure 14 are movable between their collapsed positions (FIGS. 7-10) and their open positions (FIGS. 1-4) upon movement of the front collar 26 along the longitudinal axis 18 of the guide rail 16. A front abutment plate 29 is fixedly connected to the front end 16a of the guide rail 16 and receives the front wheel connectors 22 when the front wheel support structure 14 is in its fully open position, such that when the stroller 10 is in its fully open position the front wheel members 22 are secured between the front abutment member 29 and the front wheel connector securing portion 28 of the front collar 26 as shown in FIG. 1. A pair of seat support arms 94 are provided to support a seat (not shown).

With continued reference to FIGS. 1-4 the stroller 10 further comprises a pair of rear wheels 30 having a rear wheel support structure 32 for supporting the rear wheels 30. The rear wheel support structure 32 is slidably engaged with the guide rail 16 for sliding movement of the rear collar portion 34 of the rear wheel support structure 32 along the longitudinal axis 18 of the guide rail 16. The rear wheel support structure 32 has members 34, 36, 38 and 40 which are movable between an open position (see FIGS. 1-4) and a collapsed position (see FIGS. 7-10) upon movement of the rear collar 34 of the rear wheel support structure 32 along the longitudinal axis 18 of the guide rail 16.

More specifically, the rear wheel support structure 32 of stroller 10 comprises a rear axle supporting member 36 at each of the rear wheels 30 for supporting the respective axles 31 of the rear wheels 30 to allow the rear wheels 30 to roll about their respective axles 31. The rear axle support members 36 preferably each have a braking mechanism of the type well known in the art for selectively locking the rear wheels to prevent inadvertent rolling movement of the stroller when the braking mechanism is locked. The rear axle support members 36 are fixedly connected to the rear ends 40a of the rear legs 40, with the front ends 40b of the rear legs 40 pivotally connected to the central collar 42 which is attached in a fixed position to the guide rail 16. The guide rail may be configured to define a suitable mounting position for the central collar 42, and to maintain the central collar 42 at a suitable longitudinal position along the guide rail 16. The rear ends 40a of the rear legs 40 are pivotally connected to the lower ends 38a of the rear wheel connectors 38 through brackets 44, with the upper ends 38b of the rear wheel connectors 38 pivotally connected to the rear member securing portion 46 of the rear collar 34. Accordingly, the rear wheel connector 38, rear leg 40 and rear collar 34 form a linkage whereby the rear wheels 30 and their associated rear wheel support structure 32 are movable between their collapsed positions (FIGS. 7-10) and their open positions (FIGS. 1-4) upon movement of the rear collar 34 along the longitudinal axis 18 of the guide rail 16.

The rear member securing portion 46 of the rear collar 34 has a pair of recesses for receiving the upper ends 38b of the rear wheel connectors 38, and a rear abutment member 48 is fixedly connected to the rear end 16b of the guide rail 16 such that when the stroller 10 is in its fully open position the upper ends 38b of the rear wheel connectors 38 are secured between the rear abutment member 48 and the rear member securing portion 46 of the rear collar 34.

A generally U-shaped frame member comprised of two separate lateral frame components 50 is pivotally connected to the front end 16a of the guide rail 16 through a frame mounting portion 52 of the front abutment member 29, to allow each of the lateral frame components 50 to pivot or rotate relative to the front abutment member 29. A pair of arcuate frame supporting members 54 each have a lower end 54b pivotally connected to the rear member securing portion 46 of the rear collar 34 and an upper end 54a pivotally connected to a respective upper end 50a of the two lateral frame members 50. The rear member securing portion 46 of the rear collar 34 has a pair of recesses for receiving the respective lower ends 54b of the frame supporting members 54 when the rear collar 34 is in its fully open position. Hence, when the rear collar 34 is in its fully open position the lower ends 54b of the frame supporting members 54 are secured between the rear member securing portion 46 of the rear collar 34 and the rear abutment member 48.

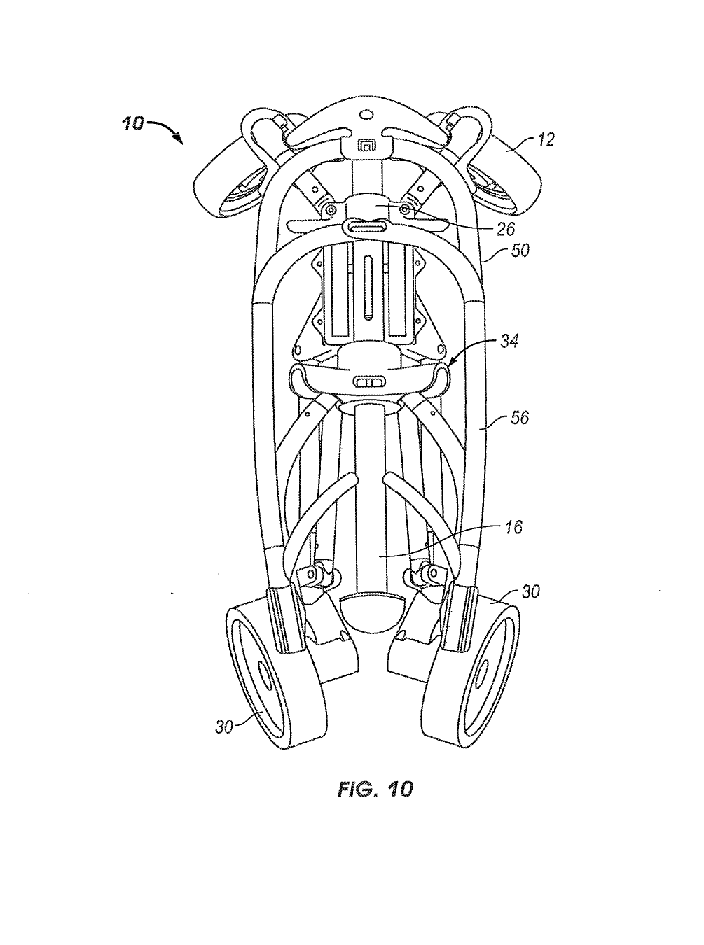

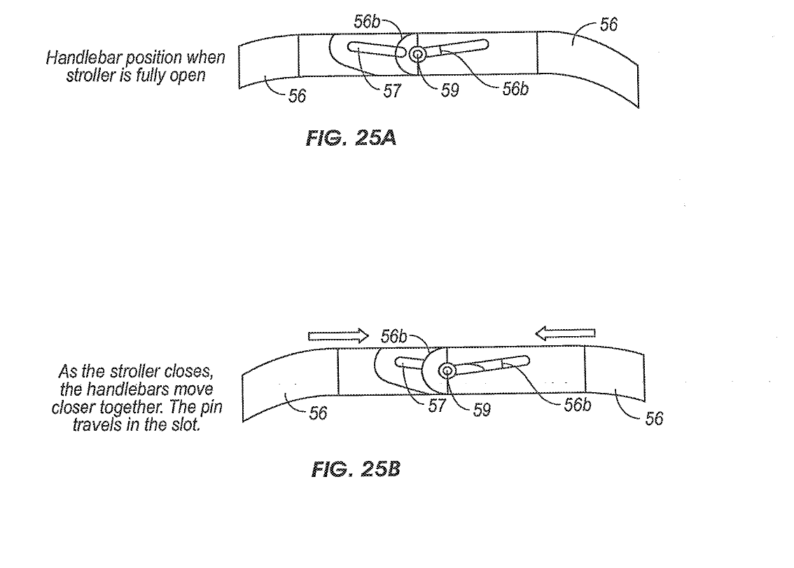

As best seen in FIGS. 1, 10, 25A and 25B, a generally U-shaped handle bar is provided comprised of two lateral handle bar components 56 having lower ends 56a pivotally connected to respective upper ends 50a of the frame member. Adjacent the upper end 56b of one of the lateral handle bar components 56 an elongated slot 57 is provided, and adjacent the upper end 56b of the other lateral handle bar component 56 a suitable pin 59 is provided which is slidably received and retained within the slot 57 of the other lateral handle bar component 56. This slidable linkage allows the upper ends 56b of the lateral handle bar components 56 to move toward and away from one another (as seen in comparing FIGS. 25A and 25B) as the lateral handle bar components 56 pivot between their collapsed and open positions. This allows the overall width of the generally U-shaped handle bar to decrease (consistent with the decrease in the lateral width of the wheels) as the lateral handle bar components 56 move from their open position as shown in FIG. 1 to their collapsed positions shown in FIG. 10 wherein a portion of the upper ends 56b of the lateral handle bar components 56 overlap one another to provide a compact configuration. As best seen in FIGS. 25A and 25B, the handle bars have an inclined portion adjacent their ends at the area in which the upper end portions of the handle bar members overlap to facilitate sliding and overlapping movement of the end portions without requiring pivotal movement of either of the lateral handle bar members. Accordingly, the two lateral handle bar components 56 act as a single generally U-shaped handlebar when the two lateral handle bar components 56 are in their open positions as in FIG. 1 at which they function as a single handle bar unit due to the pin-in-slot linkage maintaining the upper ends 56b of the two lateral handle bar components 56 connected together.

In accordance with an aspect of the invention, two lateral handle bar components which are not permanently interconnected at their upper ends may be utilized. It may be desirable to provide a handle bar latch mechanism (not shown) which engages the upper ends 56b of the two lateral handle bar components 56 to retain them interconnected when the handle bar components 56 are in their open position, but which allows release of the two lateral handle bar components 56 to allow them to move independently of one another when not in their open position. The release of the handle bar latch mechanism may be automated so that the latch mechanism releases or unlatches upon actuation of a control switch or a controller. The stroller may be constructed such that release of the handle bar latch mechanism, either manually or automatically, may actuate automatic movement of one or more additional stroller components as suitable.

With reference now to FIGS. 1 and 14-16, each of the two lateral handle bar components 56 and the frame supporting members 54 are pivotally connected to the upper ends 50a of the frame member. More specifically, the frame supporting member 54 has a frame gear member 58 fixed thereto such that upon pivoting movement of the frame supporting members 54 relative to the frame member 50 about pivot pin 60 the frame gear member 58 pivots about pivot pin 60 in the same rotational direction. The ends 56a of the handle bar 56 have handle bar gear members 62 fixed thereto and in engagement with the frame gear member 58 such that upon pivotal movement of the frame supporting members 54 relative to the frame member 50 the handle bar components 56 are pivoted relative to the frame member 50. This defines a simultaneous folding and unfolding gear arrangement referred to generally at 51.

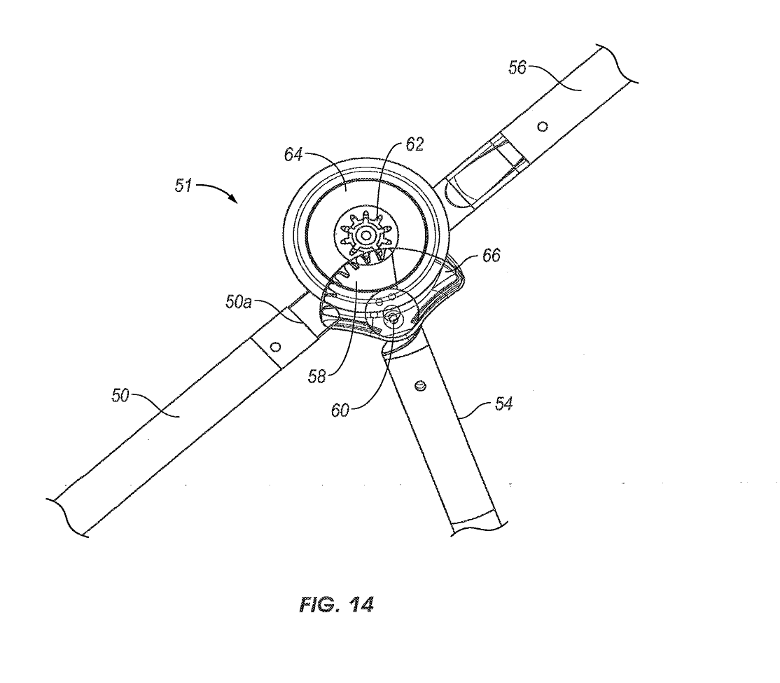

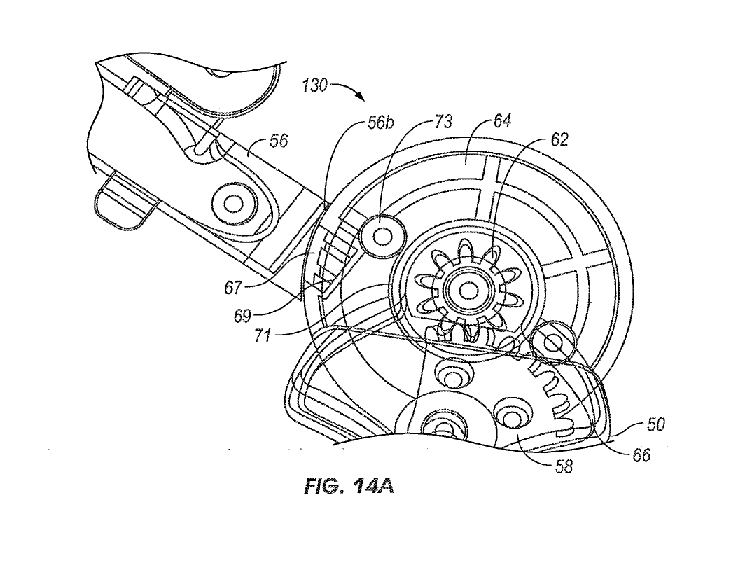

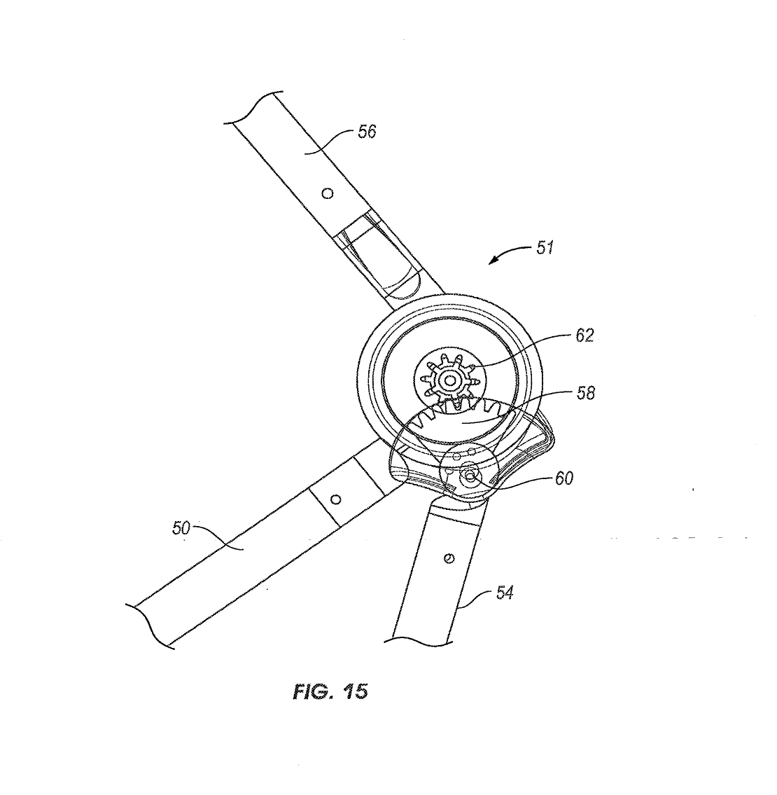

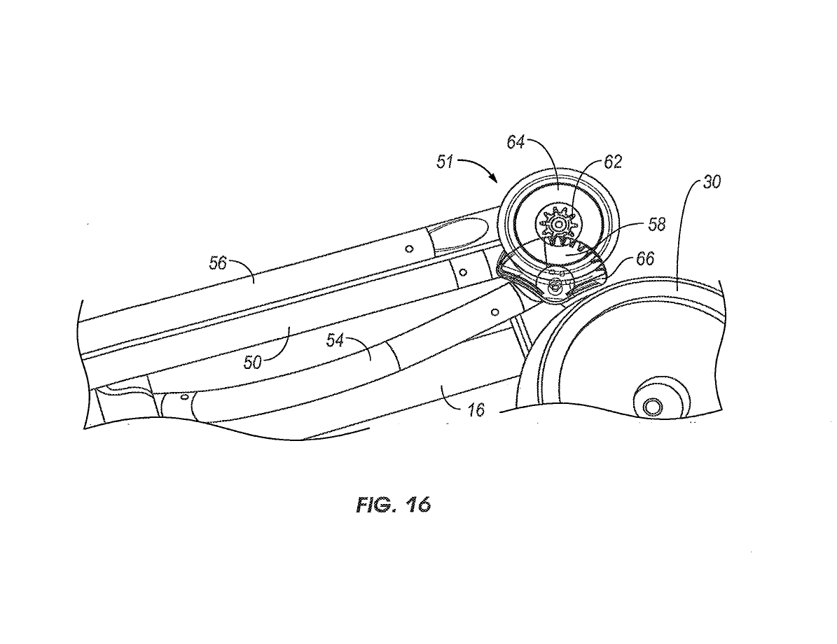

More specifically, upon movement of the frame supporting members 54 from their fully opened position of FIG. 14 to their partially open position of FIG. 15, the frame gear member 58 pivots about pivot pin 60 which rotates the handle bar gear member 62 which pivots both of the handle bar components 56 forward from the open position of FIG. 14 to the partially open position of FIG. 15. The gears and handle bar components are configured such that upon movement of the frame supporting members 54 to their fully collapsed positions relative to the frame members 50 as shown in FIG. 16, the handle bar components 56 are moved to their fully collapsed positions as shown in FIG. 16. Similarly, upon movement of the frame supporting members 54 from their fully collapsed position of FIG. 16 toward their fully open position of FIG. 14, the handle bar components 56 are moved through the gear arrangement toward its fully open position as well.

Although the illustrated and described gear arrangement 51 may be used to achieve the desired movement of the handle bar 56 to its fully collapsed position upon movement of the frame supporting members 54 to their fully collapsed position, and to achieve the desired movement of the handle bar 56 to its fully open position upon movement of the frame supporting members 54 to their fully open position, a variety of other arrangements may be used in addition to, or instead of, gears for achieving this, such as mechanical linkages, a drive mechanism in operative engagement with the handle bars, cable connections, pneumatics, and others. The handle bar gear member 62 resides within a gear housing 64, and frame gear member 58 resides within frame gear member enclosure 66 which also accommodates a portion of the gear housing therein, so the frame gear member 58 and handle bar gear member 62 are covered at all times throughout collapsing, opening and use of the stroller.

With reference to FIG. 14A, the above described gear arrangement 51 can be modified to provide a latching mechanism suitable for use in connection with inventive aspects of strollers of the present invention. A latch member 67 is provided at the end 56b of the lateral handle bar component 56 which is spring biased to its extended position extending outwardly from the end 56b, as shown in FIG. 14A. The latch member 67 is movable to a retracted position not extending outwardly from the end 56b. A recess 69 for receiving the latch member 67 when it is in its extended position is provided in the gear housing 64 to receive and engage the latch member 67 therein, and thereby engage the handle bar member 56. Due to the single degree of freedom of the stroller linkage, this prevents the stroller from being moved toward its collapsed or folded position. The latch member 67 can be released from the recess 69 by moving the latch to its retracted position to disengage the latch member 67 and thereby disengage the handle bar member 56 to allow rotational movement of the handle bar member and accordingly allow movement of the stroller toward its collapsed position. An arcuate slot 71 is provided in the gear housing 64 which slidably receives and retains a pin or rivet 73 on the frame member 50 to limit the extent of pivotal movement of the frame member 50 relative to the handle bar component 56 to provide alignment of the recess 69 with the latch member 67 to assure the latch member is properly received and engaged in the recess 69 when the stroller is in its open position and the latch member 67 is spring biased into the recess 69. The end 56b is arcuate to correspond to the arcuate or circular perimeter of the gear housing 64, whereby after the latch has been disengaged and the stroller has been moved to its collapsed position, upon movement of the stroller toward its open position the latch member 67 is spring biased against the arcuate perimeter of the gear housing 64 until the stroller is fully open, at which point the latch member 67 is aligned with, and spring biased into, the recess 69 to prevent movement of the stroller toward its collapsed position until the latch member 67 is retracted.

With reference now to FIGS. 11-13, the stroller 10 has a drive mechanism 70 through which the stroller 10 may be moved back and forth between its open and collapsed positions. A rear threaded member 72 is mounted in the guide rail 16 for rotation within the guide rail interior about the longitudinal axis of the rear threaded member, with the longitudinal axis of the rear threaded member being coaxial with the longitudinal axis 18 of the guide rail. The rear threaded member 72 is supported by bearings 74a and 74b at each end thereof, and a threaded member pulley 76 is fixedly connected to the rear threaded member 72. It is preferred that the threaded member pulley 76 is mounted in close proximity to the bearing 74b, so that lateral forces exerted on the threaded member pulley 76 are taken upon by the bearing 74b such that separate bearings are not required for the front threaded member 86 which is discussed below. A motor 78 is mounted in a fixed position on the guide rail and has a drive pulley 80 connected to its shaft and a belt (not shown) extends between the drive pulley 80 and threaded member pulley 76 through which the threaded member pulley 76 is rotated about its longitudinal axis upon actuation of the motor 78. A rear nut member 82 is in threaded engagement with the rear threaded member 72, with the rear nut member 82 having a mounting portion 82a which extends outwardly of the guide rail 16 through the longitudinally extending slot 84 in the guide rail 16.

Accordingly, as the motor 78 is actuated, the motor 78 effects rotation of the rear threaded member 72 through the belt and pulleys (with the lateral forces exerted on the threaded member pulley 76 by the belt being taken up by the bearings 74a and 74b) whereby the nut member 82 (which is prevented from rotating together with the rear threaded member 72 due to the mounting portion 82a of the rear nut member 82 extending outwardly of the slot 84 and bearing against the sides of the slot when the rear threaded member 72 rotates) is driven longitudinally along the rear threaded member 72. The rear collar 34 is mounted to the mounting portion 82a of the rear nut member 82 such that the rear collar 34 and the rear member securing portion 46 connected thereto moves longitudinally along the guide rail 16 together with the rear nut member 82 as the rear threaded member 72 is rotated by the motor 78. With the rear wheel support structure 32 engaged with the rear collar 34, the longitudinal movement of the rear collar 72 along the guide rail 16 thereby effects movement of the rear wheel support structure 32 between its collapsed and open positions, with the rear collar 34 moving in a first longitudinal direction along the guide rail 16 upon rotation of the rear threaded member 72 in first rotational direction, and the rear collar 34 moving in a second longitudinal direction along the guide rail 16 upon rotation of the rear threaded member 72 in an opposition, second rotational direction to move the rear wheel support structure between its collapsed and open positions. Hence, the drive mechanism 70 is operatively engaged with the rear wheel support structure 32 to move the rear wheels 30 between their collapsed and open positions.

With continued reference to FIGS. 11-13, a front threaded member 86 is mounted in the guide rail 16 for rotation within the guide rail interior about the longitudinal axis of the front threaded member, with the longitudinal axis of the front threaded member being coaxial with the longitudinal axis 18 of the guide rail 16 in a manner similar to the rear threaded member 72. The rear end 86a of the front threaded member 86 is coupled to the rear threaded member 72 through coupling member 88 such that the front threaded member 86 and the rear threaded member 72 rotate together. The front end 86b of the front threaded member 86 is supported in a suitable recess in the rear side of the front abutment member which allows rotation of the front threaded member 86 about its longitudinal axis, which is coaxial with the longitudinal axis of the rear threaded member 72.

A front nut member 90 is in threaded engagement with the front threaded member 86, with the front nut member 82 having a mounting portion 90a which extends outwardly of the guide rail 16 through the longitudinally extending slot 84 in the guide rail 16. Accordingly, as the motor 78 is actuated, the motor 78 effects rotation of the front threaded member 86 (simultaneously and in the same rotational direction as the rear threaded member 72) whereby the front nut member 90 (which is prevented from rotating together with the front threaded member 86 due to the mounting portion 90a of the front nut member 82 extending outwardly of the slot 84 and bearing against the sides of the slot when the front threaded member 86 rotates) is driven longitudinally along the front threaded member 86. The front collar 26 is mounted to the mounting portion 90a of the front nut member 90 such that the front collar 90 and the front wheel connector securing portion 28 connected thereto moves longitudinally along the guide rail 16 together with the front nut member 90 as the front threaded member 86 is rotated by the motor 78. With the front wheel support structure 14 engaged with the front collar 26, the longitudinal movement of the front collar 26 along the guide rail 16 thereby effects movement of the front wheel support structure 14 between its collapsed and open positions, with the front collar 26 moving in a first longitudinal direction along the guide rail 16 upon rotation of the front threaded member 86 in first rotational direction, and the front collar 90 moving in a second longitudinal direction along the guide rail 16 upon rotation of the front threaded member 86 in an opposition, second rotational direction to move the front wheel support structure 14 between its collapsed and open positions. Hence, the drive mechanism 70 is operatively engaged with the front wheel support structure 14 to move the front wheels 12 between their collapsed and open positions.

As mentioned above, the front and rear threaded members 86 and 72 are coaxial and are coupled together so that they rotate simultaneously in the same direction. They also have opposite threads (not shown) such that when the front and rear threaded members 86 and 72 rotate together in a first rotational direction the front and rear collars 26 and 34 move toward one another to move the front and rear wheel support structures 14 and 32 toward their collapsed positions, and when the front and rear threaded members rotate together in a second, opposite rotational direction the front and rear collars 26 and 34 move away from one another to move the front and rear wheel support structures 14 and 32 toward their open positions. Due to differences in the linkages of the front and rear wheel support structures 14 and 32 of the stroller 10, the threads of the front and rear threaded members 86 and 72 are different from each other, such that upon the same amount of rotational movement of the front and rear threaded members 86 and 72 the rear collar 34 is displaced a greater distance along the longitudinal axis 18 of the guide rail 16 than the front collar 26 is displaced along the longitudinal axis 18 of the guide rail 16 (with the simultaneous displacement of the front and rear collars 26 and 34 being in opposite directions). It will be readily apparent to those skilled in the art that a single threaded member may be provided instead of two separate threaded members, with the single threaded member having two distinct, opposite thread portions.

Accordingly, it will be appreciated that with the coupled front and rear threaded members being considered part of the frame, the stroller 10 provides a frame, a front wheel support structure, and a rear wheel support structure which define a linkage having a single degree of freedom, such that movement of any one of the coupled threaded members, front wheel support structure, or rear wheel support structure 34 relative to one another toward their collapsed or open positions may effect movement of the others toward their collapsed or open positions. By accurately controlling and/or preventing rotation of the coupled front and rear threaded members, the movement and/or securing in place of the front and rear wheel support structures may be achieved. Further, with the handle bars 56 operatively coupled to the frame supporting members 54 of the rear wheel assembly by the gear arrangement discussed above, the coupled threaded members, front wheel support structure, rear wheel support structure and handle bars form a linkage having a single degree of freedom, whereby by accurately controlling and/or preventing rotation of the coupled front and rear threaded members, the movement and/or securing in place of the handle bars, and the front and rear wheel support structures may be achieved.

A control switch 92 is provided, preferably in the handle bar 56 for ease of access, for effecting actuation of the drive mechanism 70. The control switch 92 is operatively connected to the motor 78 (which may be through a controller, such as a microprocessor, not shown) to control actuation of the motor 78, which in turn controls the drive mechanism 70, which in turn controls movement of the front and rear wheel support members 14 and 32 between their collapsed and open positions. Preferably, the wires extending between the control switch 92 and motor 78 are all disposed internally of the stroller elements, such as extending internally within hollow tubular members. The control switch 92, or a separate control switch and/or a common controller, may also be operatively coupled to one or more latch mechanisms to move the latch mechanisms from their latched positions in which they prevent the stroller from moving from its fully open position toward its collapsed position, to their unlatched positions in which they allow the stroller to move from its fully open position towards its collapsed position. The motor 78, or a separate drive, may be operatively connected to a control switch and/or controller to effect automatic movement of the latches upon actuation by the control switch 94. The unlatching of the one or more latches is preferably carried out prior to, or simultaneous with the initiation actuation of the motor 78 and drive mechanism 70 of which the motor may be a part.

In accordance with an aspect of the invention, a control switch may be provided at or in proximity with one or more latches on the stroller (or operatively engaged with one or more latches), such that upon, or subsequent to, manually unlatching the one or more latches the actuator is actuated to effect automatic movement of the desired one or more stroller components from a first position to a second position. That is, a control switch such as a position sensing switch (which may be an optical switch, electrical contact switch, or any other type of switch) may be provided which is operatively engaged with a controller which controls the actuation of the drive mechanism as desired (which may be in any of a wide variety of rates, sequences, options, etc.) The control switch or switches may be located and configured to be triggered or actuated during conventional manual unlatching of the latch or latches, or may be at a convenient location on the stroller which allows the control switch to be easily actuated while, or immediately subsequent to, unlatching of the latch or latches. It may be desirable to provide an arrangement in which two or more control switches associated with respective latches are required to both be actuated to effect automatic movement of the desired one or more stroller components from a first position to a second position.

A single control switch may actuate a single controller, such as a microprocessor, which in turn actuates two or more separate drive mechanisms. Alternatively, a single control switch may actuate two or more controllers which each in turn actuate one or more separate drive mechanisms.

The stroller 10 may also have a display 96, such as on the handle bar 56, to provide information to the user as to any of a wide variety of information such as confirmation that the front and rear wheel support structures are secured in their fully open positions, that latches are locked, that a brake is engaged, ambient temperature, distance traveled, time, or the like.

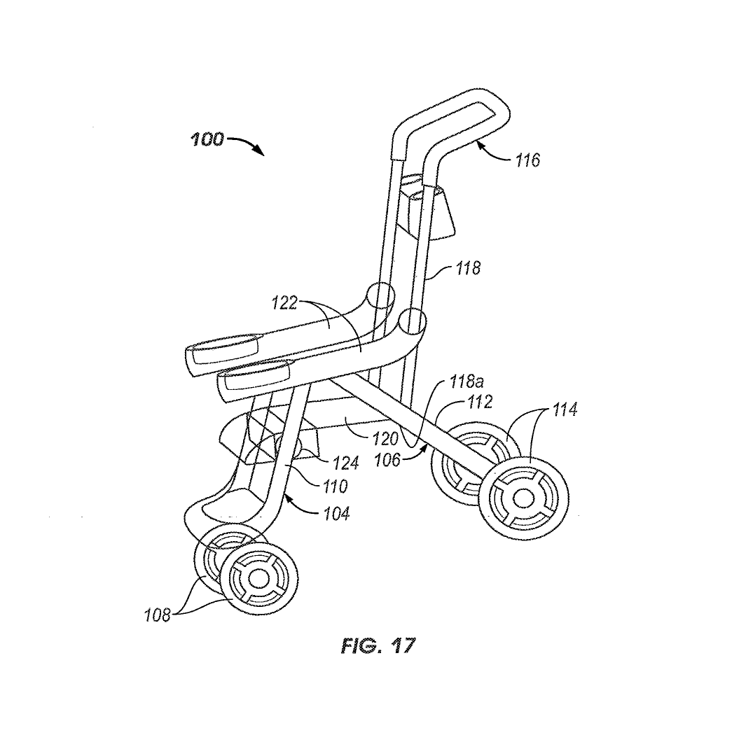

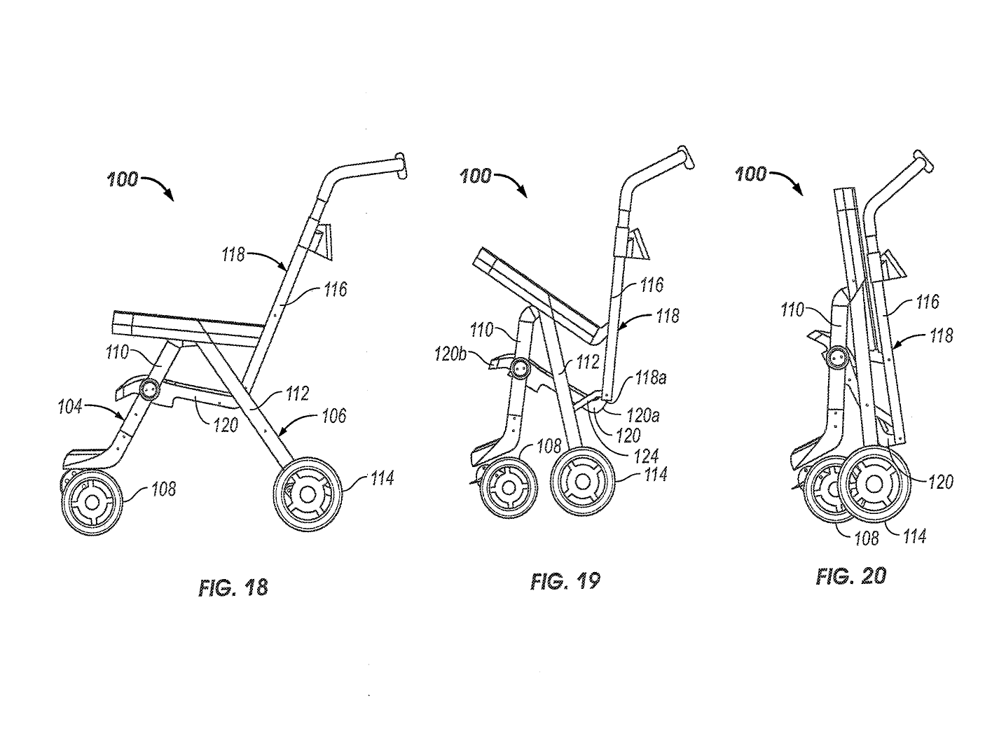

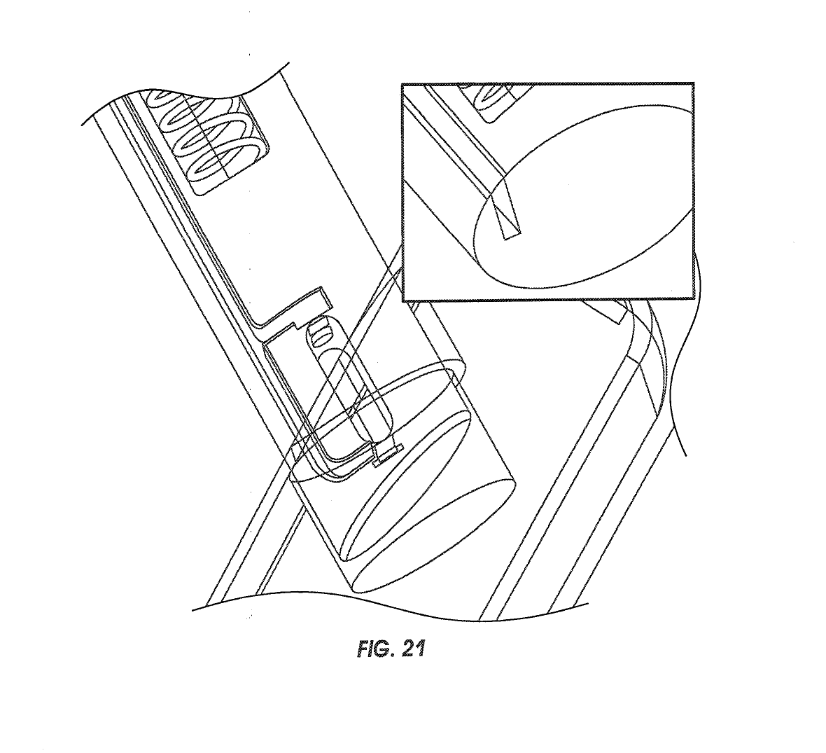

With reference now to FIGS. 17-20, a stroller 100 embodying various aspects of the present invention is illustrated. The stroller 100 is movable or foldable between a collapsed position (see FIG. 20) and an open or operative position (see FIGS. 17 and 18). An intermediate stroller position between collapsed and open is illustrated in FIG. 19.

The stroller 100 has a front wheel support structure 104 having a pair of laterally spaced front support legs 110 with front wheels 108 rotatably mounted thereon. The stroller 100 also has a rear wheel support structure 106 having a pair of laterally spaced rear support legs 112 with rear wheels 114 rotatably mounted thereon. The upper ends of the respective front support legs 100 and rear support legs 112 are pivotally connected to one another which allows the front and rear wheels 108 and 114 to pivot toward and away from one another.

As best seen in FIGS. 17 and 19, the stroller 100 also has a handlebar 116 with a pair of laterally spaced legs 118, which legs 118 are pivotally connected at their ends 118a to respective sides of the rear end 120a of a seat member 120 to allow pivotal movement between the seat member 120 and handlebar legs 118. The seat member 120 is also pivotally connected near its front end 120b to the front support legs 110 to allow pivotal movement between the seat member 120 and the front support legs 110. The stroller 100 has a pair of arms 122 (see FIG. 17) which are each pivotally connected at one of their ends to the handlebar legs 116 and pivotally connected to the rear support legs 112. A link 123 is provided extending between and pivotally connected to the lower end 118a of the handlebar and the rear support leg 112. Accordingly, the front support legs 110, rear support legs 112, seat member 120, arms 122, links 123 and handlebar 116 define a linkage having a single degree of freedom, such that each of these components move simultaneously between their collapsed and open position, and such that prevention of motion of various components relative to each other prevents movement of the stroller between its collapsed and open positions. The link 123 facilitates the linkage mechanism of the stroller 100 as having a single degree of freedom, with left and right sides coupled together by cross braces. A locking mechanism or latch may be provided which, when moved to its locking or latched position, allows locking of the stroller 100 in its open position during use.

In accordance with an aspect of the invention, a drive motor or mechanism 124 is operatively coupled to both the seat member 120 and front support legs 110 at their pivot axis such that, when actuated, the motor 124 pivots the seat member 120 relative to the front support legs 110 (as seen in comparing FIGS. 18 through 20). Because the linkage mechanism of the stroller 100 has a single degree of freedom, the pivoting of the seat 120 relative to the front support legs 110 by the motor 124 effects movement of each of the front support legs 110, rear support legs 112, seat member 120, arms 122 and handlebar 116 between their open and collapsed positions. The illustrated stroller 100 has the motor 124 placed at the pivot axis between the seat 120 and front support member 110 with the shaft of the motor 124 coaxial with the pivot axis between the seat 120 and front support legs 110 in a direct drive system, with the motor 124 mounted to the front support leg 110 and the motor shaft connected to the seat member 120. However, it may desirable to have the motor 124 mounted at a different location on the stroller 100 such as under the seat 120 using an indirect drive system in which the motor is not located at the pivot axis, but is mounted to the front support member 110 and the motor shaft is operatively connected to the seat member 120.

Although the illustrated stroller 100 has the motor controlling pivoting movement of the front support leg 110 relative to the seat member 120, one or more motors may be placed at any one or more pivot axes of the linkage to pivot any two pivotally connected members of the single degree of freedom linkage, whereby due to the single degree of freedom of the linkage the one or more motors may control movement of the stroller between its open and collapsed positions. Also, in accordance with a further aspect of the invention, one or more motors or other drives may be provided a suitable location away from the stroller component or components which are desired to be moved, with a suitable operative connection extending between the one or more drives and the stroller component or components to be moved by the drive. Also, in accordance with another aspect of the present invention, a stroller may be provided in which separate drive mechanisms move different components of the stroller which are not interconnected as a single degree of freedom linkage, or one drive mechanism may drive and effect movement of a plurality of different components of the stroller which are not interconnected, or one drive mechanism may drive a plurality of different components of the stroller which are interconnected as a single degree of freedom linkage with another drive mechanism driving one or more additional components of the stroller.

In accordance with another aspect of the invention, a stroller may be provided in which a drive mechanism is operatively connected with any one or more stroller components to move the one or more stroller components between any first desired position and any second desired position. Such stroller components may be wheel support structures, handlebars, cup holders, canopies, or any other stroller component for which it is desired to easily and automatically move from a first position to a second position. Such movement may be to achieve compactness in a first position and operational use in a second position, but the invention is not limited to this and there is a virtually limitless number of potential advantageous stroller embodiments in which it may be desirable to facilitate easy movement of one or more stroller components between first position and one or more other positions.

A stroller may be provided in which a drive mechanism is operatively connected with one or more components which are not related to moving the front or rear wheels, or left and right wheels, between open and collapsed positions. As an example, additional stroller components such as visors, cup holders, etc. may have a drive mechanism operatively connected therewith to move them between a first desired position and one or more other desired positions, which movement may be carried out in conjunction with the opening and collapsing movement of the stroller and/or independently. Accordingly, by merely actuating a readily accessible control switch which is operatively connected to a drive mechanism of the stroller (which operative connection may be direct or through a controller), one or more stroller components operatively connected to the drive mechanism (which operative connection may be direct or indirect) may be easily moved from a first desired position to a second desired position.

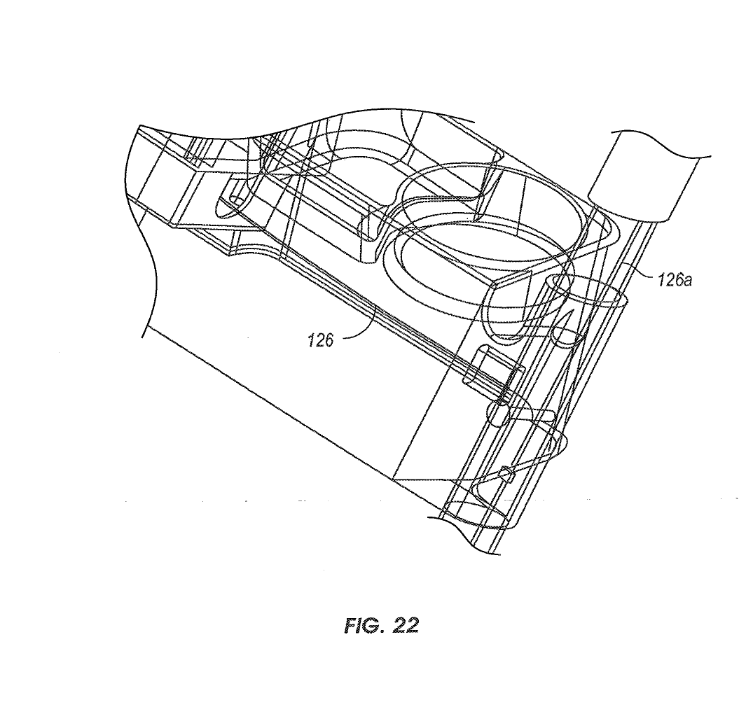

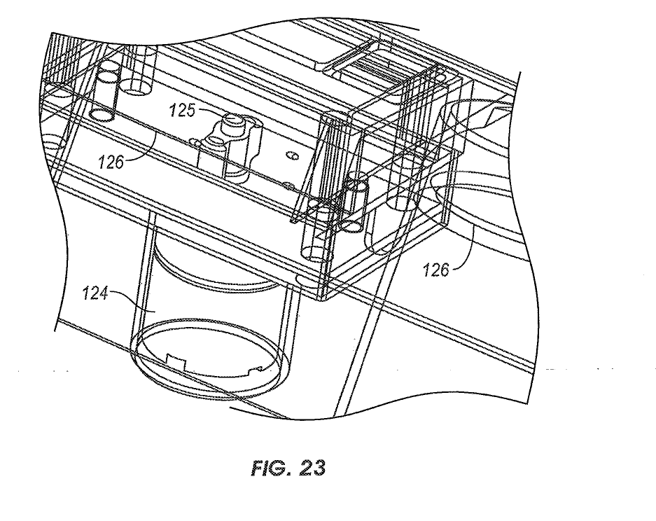

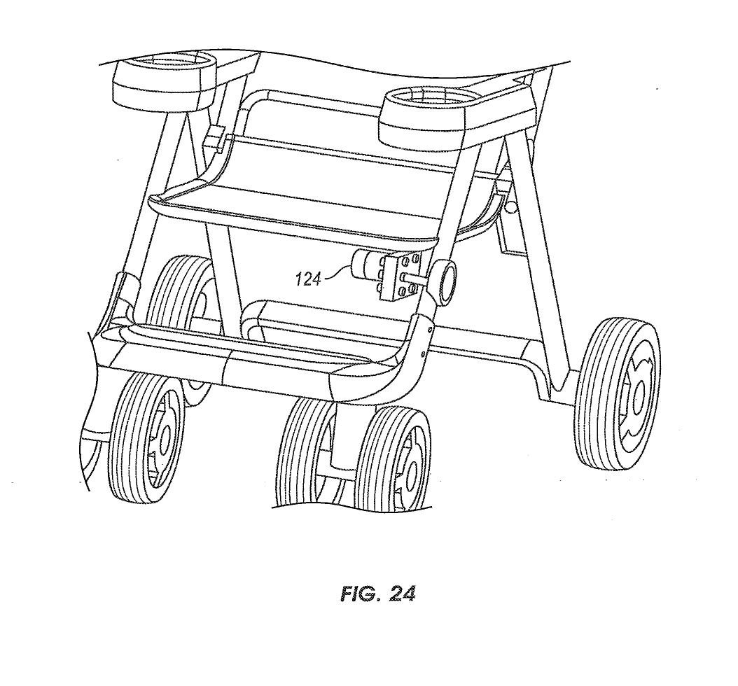

With reference to FIGS. 21-23, the stroller 100 may be provided with one or more latches or locking mechanisms (such as in FIG. 21 or any other latches or locking mechanisms) which are movable between a latched or locked position in which the stroller is prevented from moving out of its open position, and an unlatched or unlocked position in which the stroller is allowed to move freely out of its open position toward its collapsed position. With reference to FIGS. 22 and 23, the latches can be controlled by a small latch release motor 125 disposed in the handlebar 116, a cup holder or the like extending across the handlebar, or another suitable location on the stroller 100, with the shaft of the latch release motor 125 operatively engaged with latch release cables 126 which extend to the latch or locking release mechanisms on either side of the stroller. Upon actuation of the latch release motor, the latch release cables 126 are pulled to release the latch or latches. Separate or, preferably linked, cables 126a also extend to the handlebar 116 to a manual latch cable pulling mechanism (not shown) to allow manual unlatching of the latches, particularly in the event of failure or obstruction of the latch release motor 125. The latch release cables preferably also extend and reside with the components of the stroller and are not exposed or visible.

In accordance with another aspect of the invention, the stroller may be designed so that the releasing of the latches is synchronized with the movement of one or more other components of the stroller to their collapsed positions. This may be done through mechanical linkages or the like, through a suitable controller, both, or in other ways.

A resistance sensing device and/or timer may be operatively connected to the controller to stop movement and/or move toward the unfolded or open position when folding is interrupted, e.g. when too much resistance toward folding movement is encountered or when fully closed position is not achieved within a predetermined time. Alternatively, or additionally, a clutch may be provided between the motor and the elements to which it is connected to provide slippage of the driving force of the motor if too much resistance is encountered.

In accordance with another aspect of the invention, a manual override may be provided to allow manual movement of the stroller between its open and closed positions and/or manual movement of any stroller components between their first and second positions which would normally be carried out automatically by a drive mechanism. Such manual override may be desirable for any of a number of reasons, such as the power source being too low to effect the desired automatic movement or the failure of any parts. A wide variety of manual override mechanism may be utilized in connection with the present invention. For instance, a clutch or clutches may be provided between one or more drive mechanism elements and their associated stroller components for use as a manual override, whereby the clutch may be moved to a position in which it effects disengagement of the drive mechanism. As another example, a mechanical lever or rotary element may be provided at any point in the drive mechanism and/or between the drive mechanism and one or more stroller components associated with the drive mechanism, which is movable between an automatic position (in which a drive mechanism is operatively engaged with one or more stroller components to move the one or more stroller components automatically) and a manual position (in which a drive mechanism is disengaged from its operative engagement with one or more stroller components). For instance, with reference to the drive mechanism 70 of the stroller 10 a disengaging mechanism, such as a rotary disengaging element, may be provided which is movable from an automatic position in which the disengaging mechanism allows and/or maintains the operative engagement between the mounting portion 82a of rear nut member 82 (which extends outwardly of the guide rail 16 through the longitudinally extending slot 84 in the guide rail 16) and the rear collar 34 which is mounted to the mounting portion 82a of the rear nut member 82 such that the rear collar 34 and the rear member securing portion 46 connected thereto moves longitudinally along the guide rail 16 together with the rear nut member 82 as the rear threaded member 72 is rotated—and a manual position in which the disengaging mechanism disengages the mounting portion 82a of rear nut member 82 (which extends outwardly of the guide rail 16 through the longitudinally extending slot 84 in the guide rail 16) from the mounting portion 82a of the rear nut member 82 such that the rear collar 34 and the rear member securing portion 46 connected thereto may be moved manually, longitudinally along the guide rail 16 disengaged from the threaded member. Accordingly, when the disengaging mechanism is moved to its manual position, the rear collar may slide freely along the guide rail 16 by manual movement. The same, similar, or other disengaging mechanism may be provided for the front collar to allow the front collar to slide freely along the guide rail when its associated disengaging mechanism is moved to its manual position.

When in its manual position, the disengaging mechanism may engage one or more locking mechanisms when the stroller is moved to its open position and/or closed position to retain the stroller in its open position and/or closed position, such as to prevent the collars from sliding away from their open positions during use and/or away from their closed positions during transport or storage, with the disengaging mechanism being configured such that it does not engage the locking mechanism(s) when in its automatic position (in which the drive mechanism may prevent movement of the stroller away from its open position during use and/or prevent movement of the stroller toward its open position during transport or storage. The locking mechanism(s) may be manually released.

It will be appreciated that the above is merely by way of example, and that a wide variety of disengaging mechanisms may be utilized with a wide variety of different stroller designs, without departing from the inventive concepts of the present invention.

The movement or movements of the inventive strollers of the present invention can be carried out in a wide variety of ways, such as telescoping of components, sliding of components, pivoting of components, rectilinear movement of components, cam driven or guided movement of components, or any other known linkage which allows movement of two or more components relative to one another.

In accordance with one aspect of the present invention, virtually any stroller construction which has one or more front wheels and one or more rear wheels, or having any other wheel configuration such as a circular arrangement of the wheels, left and right wheels, or any other arrangement, in which the stroller has some type of drive for moving at least one of the wheels from a first position to a second position may be constructed. In accordance with another aspect of the invention, virtually any stroller construction can be utilized which allows automatic movement of at least one its wheels from an open position to a collapsed position, or back and forth between collapsed and open positions, or between an extended position and a retracted position. In accordance with another aspect of the invention, a stroller may be provided having a frame with one or more components, which may be wheel components and/or other stroller components or attachments (or components to which attachments may be connected) with a drive operatively connected with the one or more components to move them from a first position to a second position. This may be used for automatic movement of the components between any desired first and second positions. In accordance with another aspect of the invention, one or more stroller components or attachments may be moved between three or more selective positions by the drive mechanism and/or control switches, and or one or more controllers.

In accordance with an aspect of the invention, a controller may be used to control the drive. The controller may actuate the drive mechanism(s) for a predetermined period of time to move the stroller between its fully open and fully collapsed positions, and/or sensor(s) may be used to limit the actuation of the drive mechanism(s) when the component(s) reach and/or approach their fully open and/or fully collapsed positions. The controller and drive may be constructed to allow the drive to move or operate at different speeds or rate of movement over different portions of its movement, which (depending on the stroller construction and operative engagement of the drive with the stroller components) may allow the stroller components to be moved at a constant or approximately constant speed, or may allow the stroller components to be moved at different speeds over different portions of their movement. By way of example, it may be desirable to have one or more stroller components move quickly during their initial movement(s) and more slowly during their final movement(s), or vice-versa.

In accordance with another aspect of the present invention, a stroller may be provided having latch or locking components operatively connected with the drive mechanism, or a separate drive mechanism, which latches are movable between a locking position which maintains the stroller in its collapsed position and an unlocked position which allows the stroller to move from its collapsed position to it open position.

Backup mechanical systems may be provided to serve as the drive for moving the wheels and/or other stroller components. A mechanical system(s) may use elements common with the automatic system(s), use independent element(s), or both.

### Lightweight Collapsible Stroller

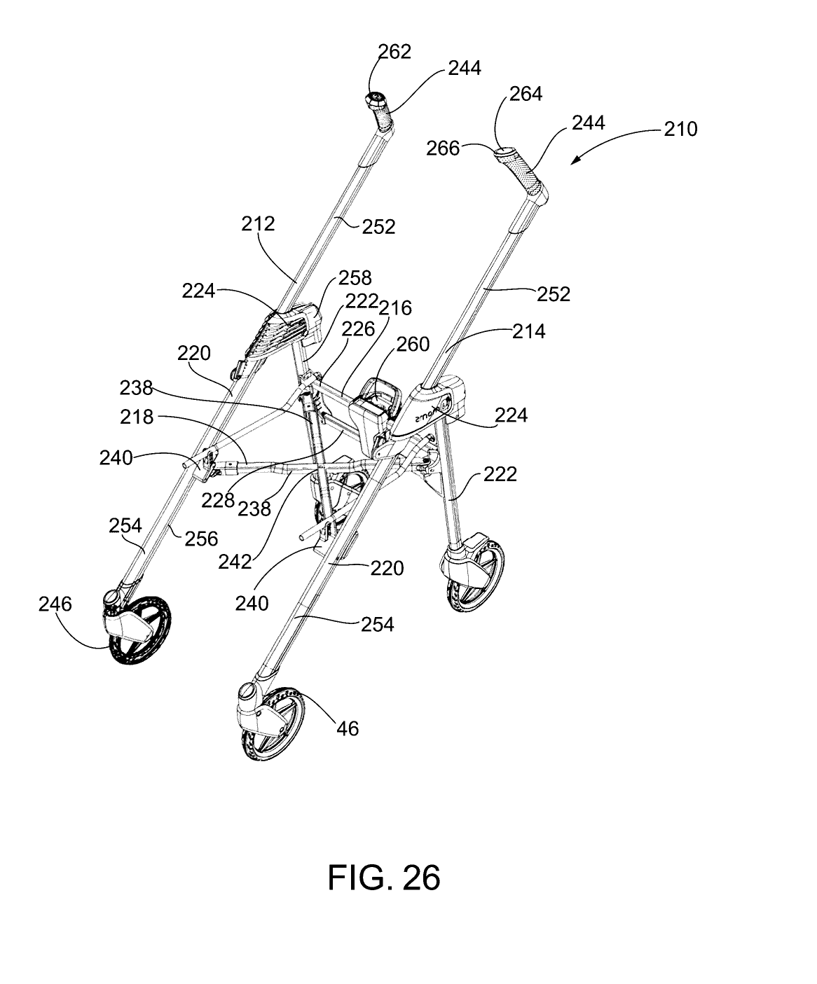

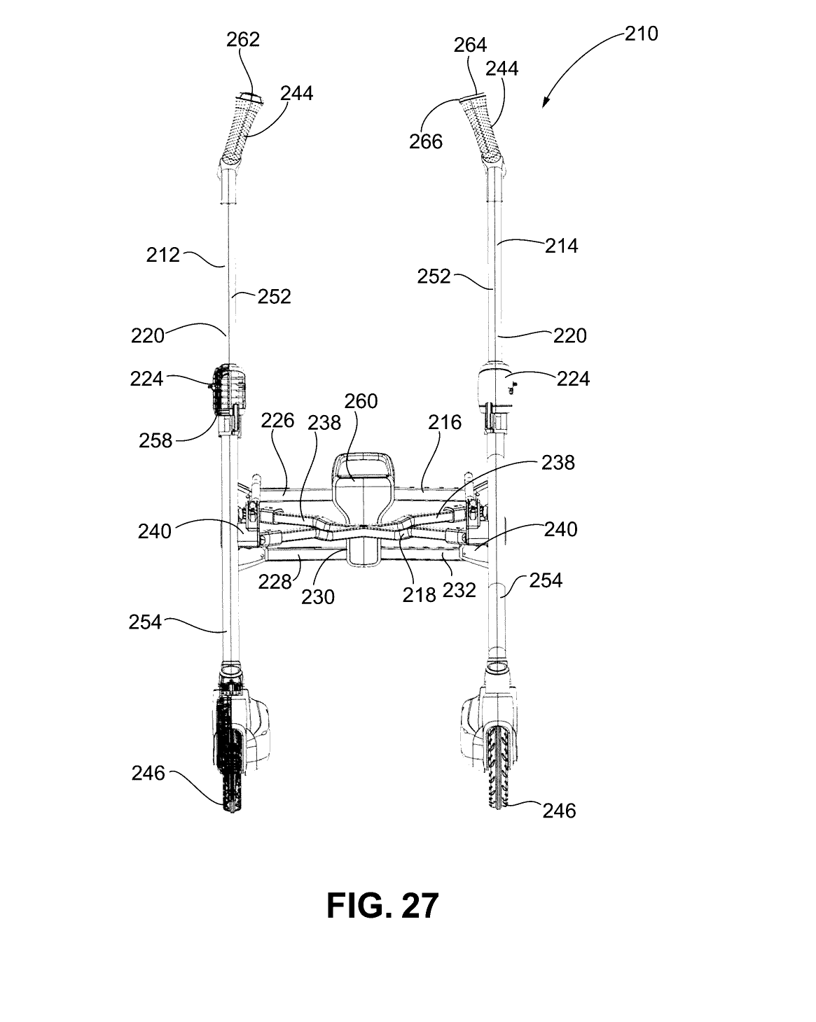

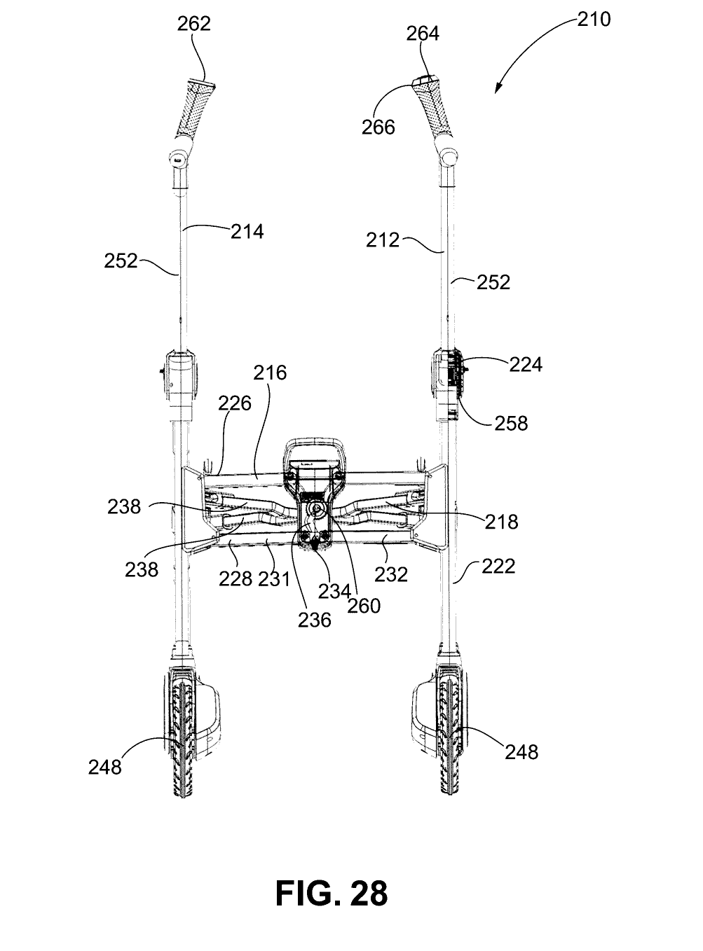

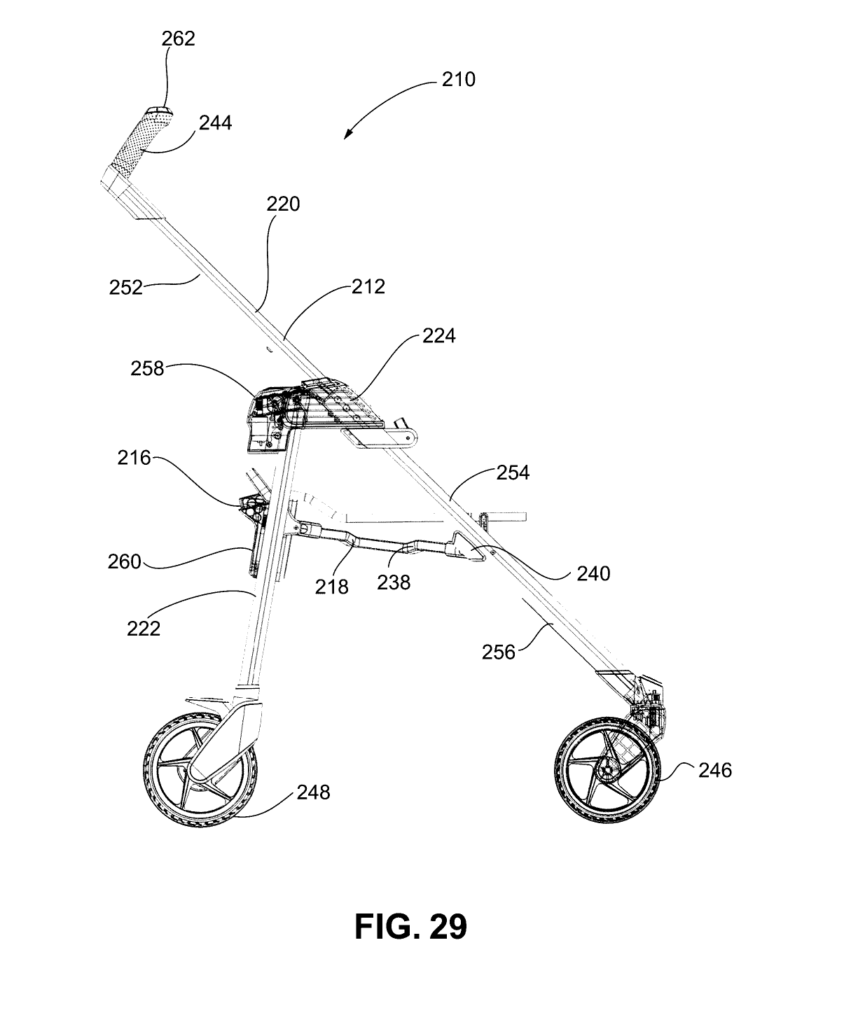

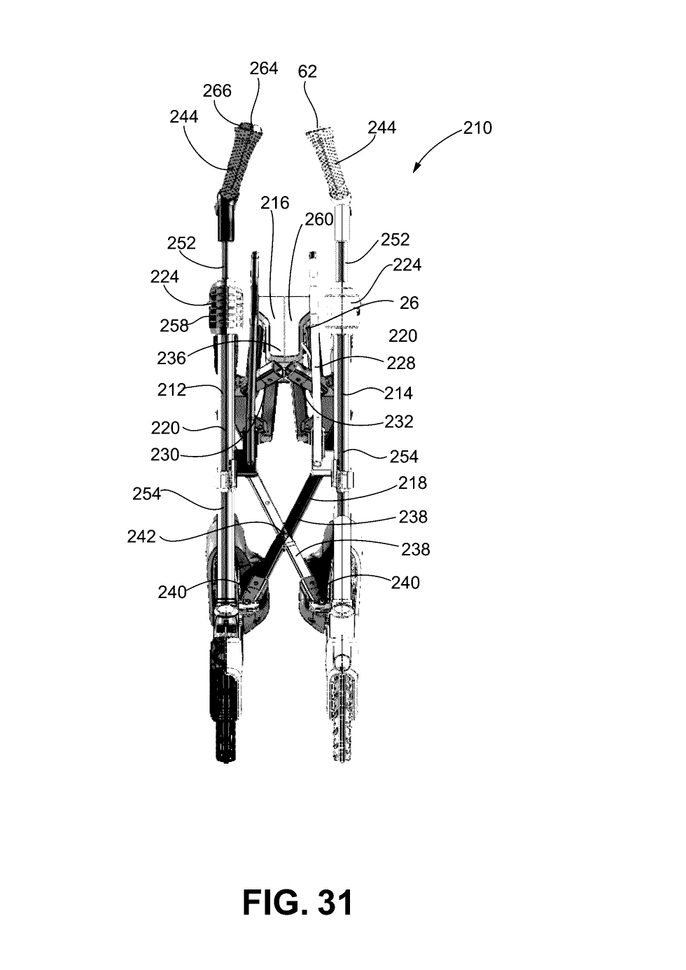

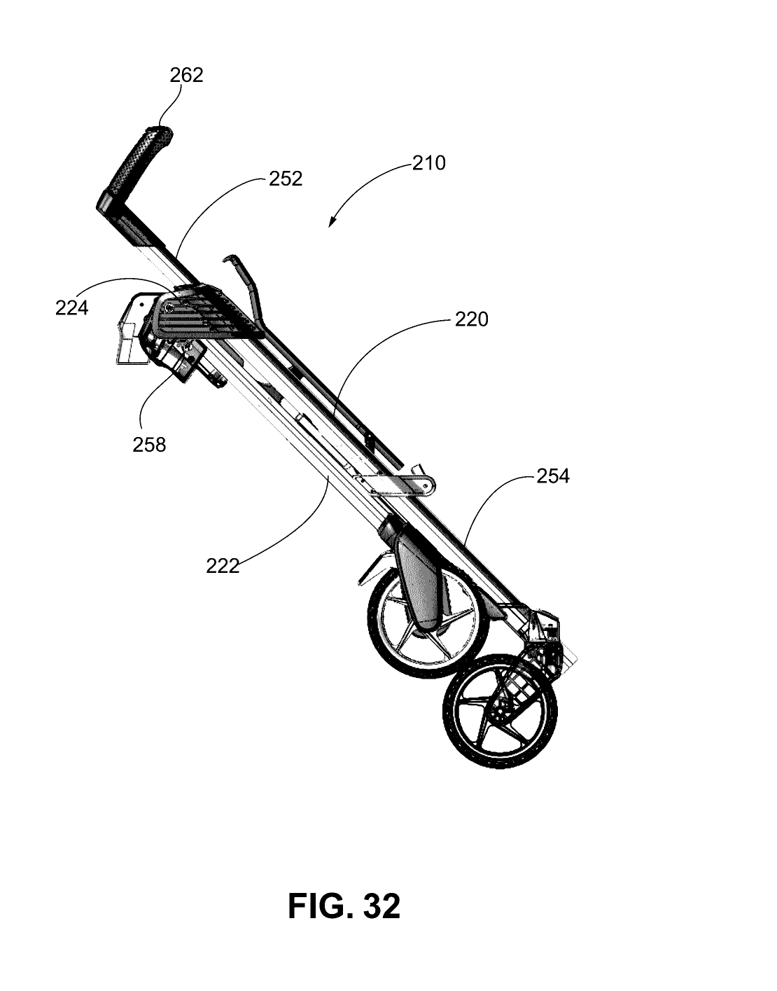

With reference to FIGS. 26-34, a stroller 210 includes a right frame 212, a left frame 214, and a linkage (e.g., a parallelogram linkage 216 and/or a scissor linkage 218) connected therebetween. The frames 212, 214 and linkage 216, 218 may be formed from any suitable material strong enough to support the stroller 210 and occupant including hard plastics and metal. In certain embodiments, the frames 212, 214 are formed from hollow tubular members to reduce the weight of the stroller 210.

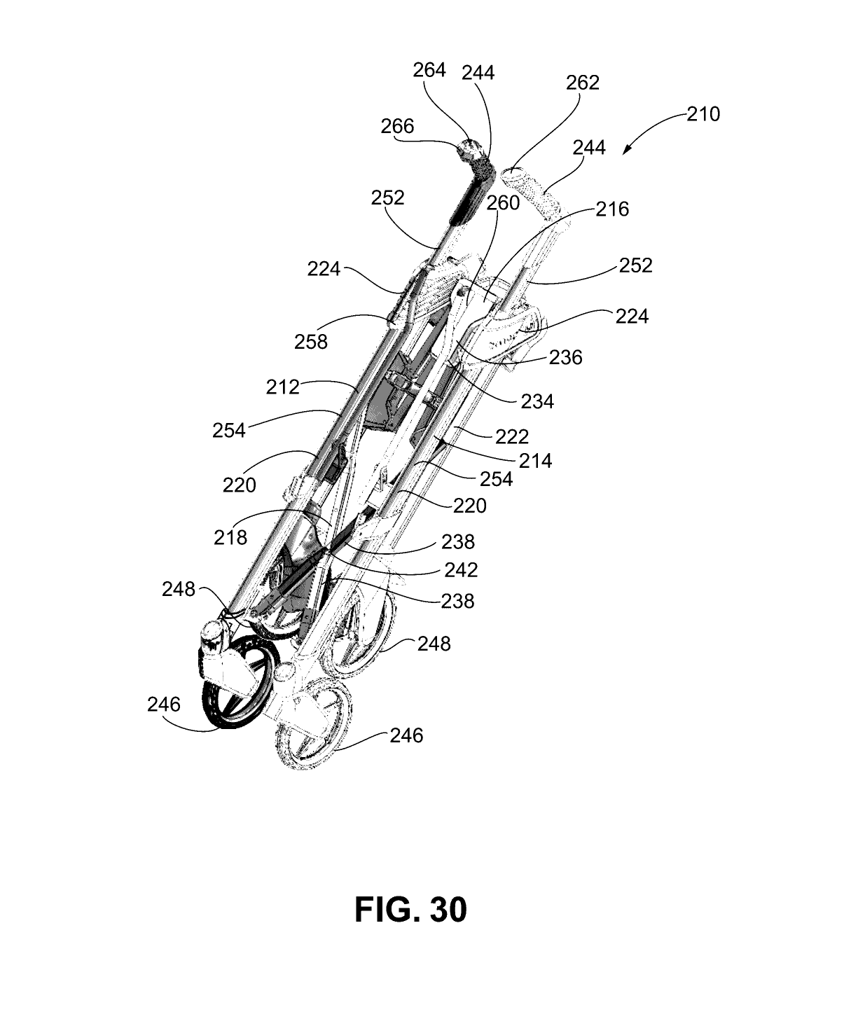

The right frame 212 and left frame 214 are substantially identical in appearance and construction. The right frame 212 is described hereinafter. However, it is understood that the left frame 214 is constructed to mirror the right frame 212. The right frame 212 includes a front support 220 rotatably connected to a rear support 222 at a frame joint 224. The front support 220 and the rear support 222 are movable from an open position to a closed position. In the open position, the front support 220 is positioned at approximately a 45 degree angle relative to the rear support 222. In the closed position, the front support 220 and rear support 222 are approximately parallel. However, these angles are not intended to be limiting and may vary within the scope of the present invention. In one exemplary embodiment, the stroller in the open position is depicted in FIGS. 26-29. The stroller in the closed position is depicted in FIGS. 30-32.

The linkage connecting the right frame 212 to the left frame 214 may be any suitable structural member including, but not limited to, the parallelogram linkage 216 and/or the scissor linkage 218. In one non-limiting embodiment, a parallelogram linkage 216 is formed of a foldable upper horizontal member 226 and a foldable lower horizontal member 228, wherein the members 226, 228 are connected between the rear supports 222 of the right frame 212 and the left frame 214. The horizontal members 226, 228 each include a first section 230 and a second section 232 connected by a folding joint 234. The parallelogram linkage 216 further includes a latch 236 engaged with the folding joint 234 which, when locked, maintains the horizontal members 226, 228 in an extended position and which, when released, permits the folding joint 234 to transition to the folded position. The parallelogram linkage 216 is configured to transition from the extended position to the folded position concurrently with the transition of the frames 212, 214 from the open position to the closed position. A parallelogram linkage 216 containing two horizontal members 226, 228 is found to offer advantages compared to other known configurations for connecting frame structures of a stroller. Specifically, since the members 226, 228 are relatively small and since there is a large space between the horizontal members 226, 228 and the ground, a user will not kick or bump the linkage 216 while pushing the stroller 210. In addition, since the parallelogram linkage 216 takes up only a small portion of the rear supports 222, there is sufficient space to hang storage devices such as bags or panniers off of the rear supports 222 without obstructing the folding motion of the linkage 216. Finally, the linkage 216 comprising two parallel horizontal members 226, 228 is generally believed to be visually appealing and less cluttered than alternative linkage designs which include more parts and fewer straight lines.

In certain embodiments, the stroller 210 further includes the scissor linkage 218. The scissor linkage 218 includes two substantially rigid members 238 connected between a rear support 222 and a front support 220 of the opposing frame. The rigid members 238 are connected to the front support 220 at a slidable joint 240 capable of sliding upward and downward along a lower portion of the front support 220. The slidable joints 240 are configured to slide downward along the front supports 220 concurrently with the transition of the frames 212, 214 from the open position to the closed position. In certain embodiments, the rigid members 238 are connected together at a rotatable center joint 242. The members 238 are rotated together around the center joint 242 as the frames 212, 214 transition from the open position to the closed position.

The stroller 210 may further include additional elements extending from the frames to facilitate pushing the stroller. For example, in certain embodiments, handles 244 extend from the top of the front supports 220 for pushing the stroller.

Additionally, the stroller 210 includes front 246 and rear wheels 248 attached to the lower end of the front support 220 and rear supports 222, respectively. In one embodiment, the wheels 246, 248 are connected to the frames 212, 214 through a suspension system for absorbing bumps or depressions in the ground to make pushing the stroller 210 easier and to improve ride comfort for the child occupant. The suspension system may be a spring based suspension system or any other suitable system as is known in the art.

The stroller 210 may further include a foot stand (not shown) which may further assist in keeping the stroller upright in the folded (e.g., closed) position. The foot stand may extend between the lower portions of the front supports 220 and may also house additional electronic features such as day time running lights (not shown).

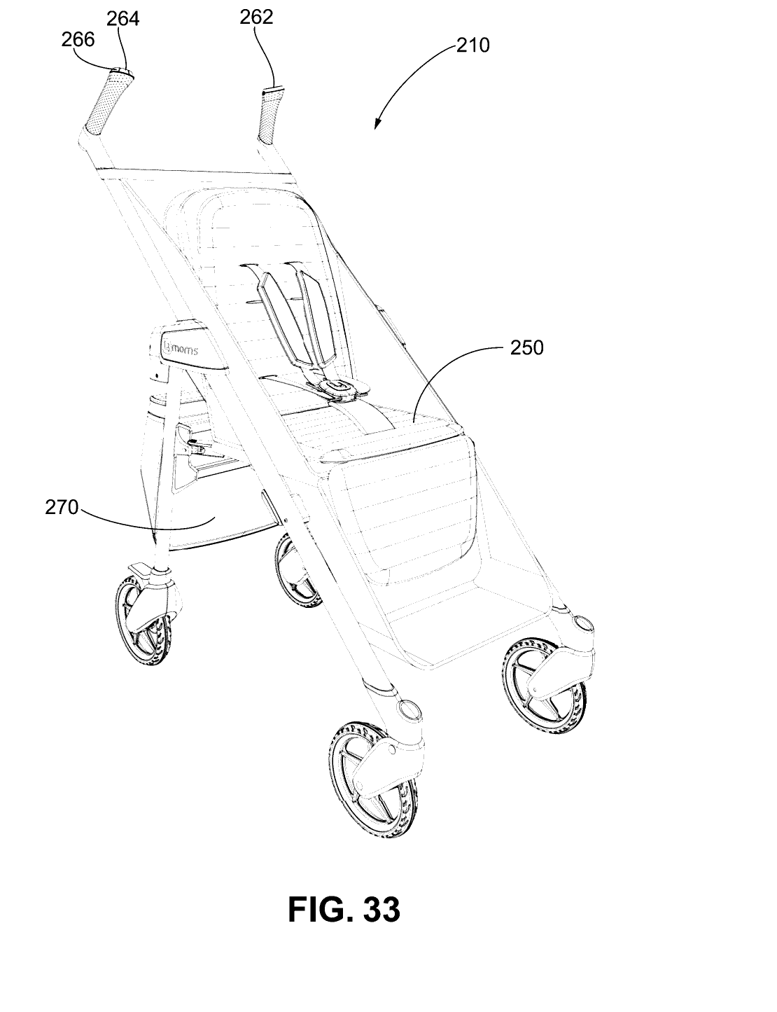

With reference to FIG. 33, in certain embodiments, the lower portion of the front supports 220 may provide an attachment mechanism for a child support area including a child seat 250. The child support area may be anchored to the front supports 220 at a position between the slidable joint 240 and frame joint 224, such that movement of the slidable joint 240 is not obstructed by seat 250. A cover or umbrella (not shown) may also be connected to the frames 212, 214, for protecting the child from exposure to the sun. In certain embodiments, the cover (not shown) is connected to the upper portion of the front supports 220, at a point above the frame joint 224.

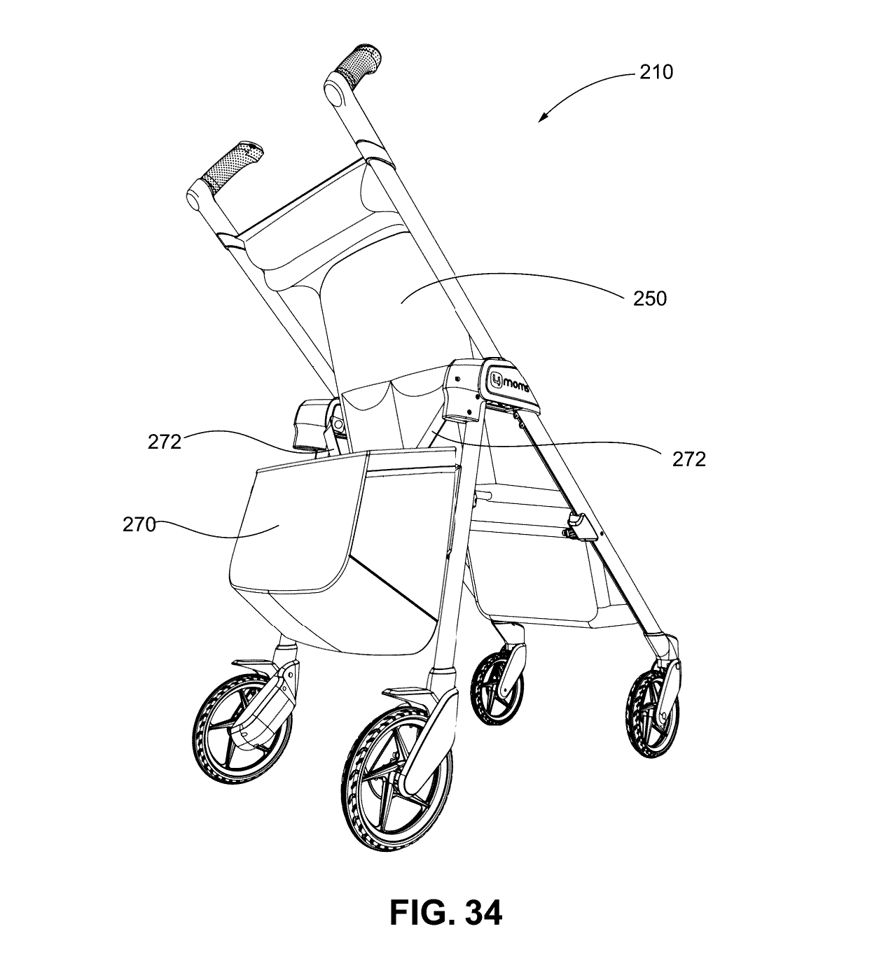

With reference to FIGS. 33 and 34, a storage bag 270 may be attached to the rear supports 222 of the stroller 210. The storage bag can be used to carry supplies for the child occupant or for the user, such as food items, clothing, diapers, toys, etc. With most folding strollers, storage bags are generally folded up in connection with the folding of the stroller frame. It was important to remove all items from the bag before folding the stroller so that nothing would be damaged. Alternatively, the bag could be removed before folding the stroller. When manually closing a stroller, a user would typically notice if objects were still in the bag and could remove the objects or bag from the stroller before continuing to fold the stroller. A unique problem with power folding strollers, such as the stroller 210 of the present invention, is that the user may initiate automatic folding of the stroller 210 without realizing that objects are contained within the bag. Since the folding process is automatic, the bag may collapse breaking objects contained therein, before the user realizes that the bag was loaded. Therefore, in a preferred and non-limiting embodiment of the present invention, the storage bag 270 is configured to remain in an unfolded (e.g., expanded) position while the stroller 210 transitions between the open and closed positions. To maintain the bag 270 in the expanded position, in one embodiment, the bag 270 further includes cables 272 fixedly connected to the frame 212, 214. For example, the cables 272 may be anchored to the frame joints 224. The cables 272 may be any sort of webbing, fabric, or material which is sufficiently strong to support the weight of the bag 270 and objects contained therein. The cables 272 are coupled to the bag 270 at a flexible joint. The cables 272 and flexible joint are configured such that, as shown in FIG. 34, when the stroller 210 is in the open position, the cables 272 are oriented at approximately a 45 degree angle relative to the ground. As the stroller 210 transitions to the closed position, the fixed ends of the cables 272 are brought together such that, when the stroller 210 is in the closed position, the cables 272 are substantially parallel. In this way, the bag 270 does not collapse as the stroller 210 transitions between the open and closed positions.

Telescoping Tube Assembly

With continued reference to FIGS. 26-34, in a non-limiting embodiment, the front supports 220 of the stroller 210 are formed with a telescoping tube-in-tube design to reduce weight and improve overall appearance. In certain other embodiments of the stroller 210, rather than a telescoping tube-in-tube design, the front support 220 could be constructed as a non-coaxial tube with an external telescoping guide, as is known in the art.

In a tube-in-tube configuration, the front support 220 includes an inner tube 252 and a hollow outer tube 254. The outer tube 254 extends from an end of the front support 220 to the frame joint 224. In the embodiment of the stroller 210, depicted in FIGS. 26-34, the outer tube 254 is positioned at the lower portion of the front support 220, and the inner tube 252 is positioned at the upper portion of the front support 220. However, it is understood that this configuration may be reversed, such that the outer tube 254 is positioned at the upper portion of the stroller 210. The outer tube 254 includes a longitudinal slot extending, at least partially, along the length of the outer tube 254. The slidable joint 240 of the scissor linkage 218 is configured to be received within the slot 256.

Generally, a tube 254 having a longitudinal slot 256 would lack rigidity unless additional stiffening structures are disposed within the tube to contribute additional structural stability. Accordingly, if no additional structural members were included in the outer tube 254, when the stroller 210 is pushed with substantial force, the front supports 220 may bend or flex causing the stroller 210 to feel unstable or poorly made. However, inserting additional structural supports into the outer tube 254 is difficult because the inner tube 252 is configured to insert farther within the outer tube 254 as the stroller 210 transitions to the closed position. Thus, there is limited space in the outer tube 254 for including additional structural supports.

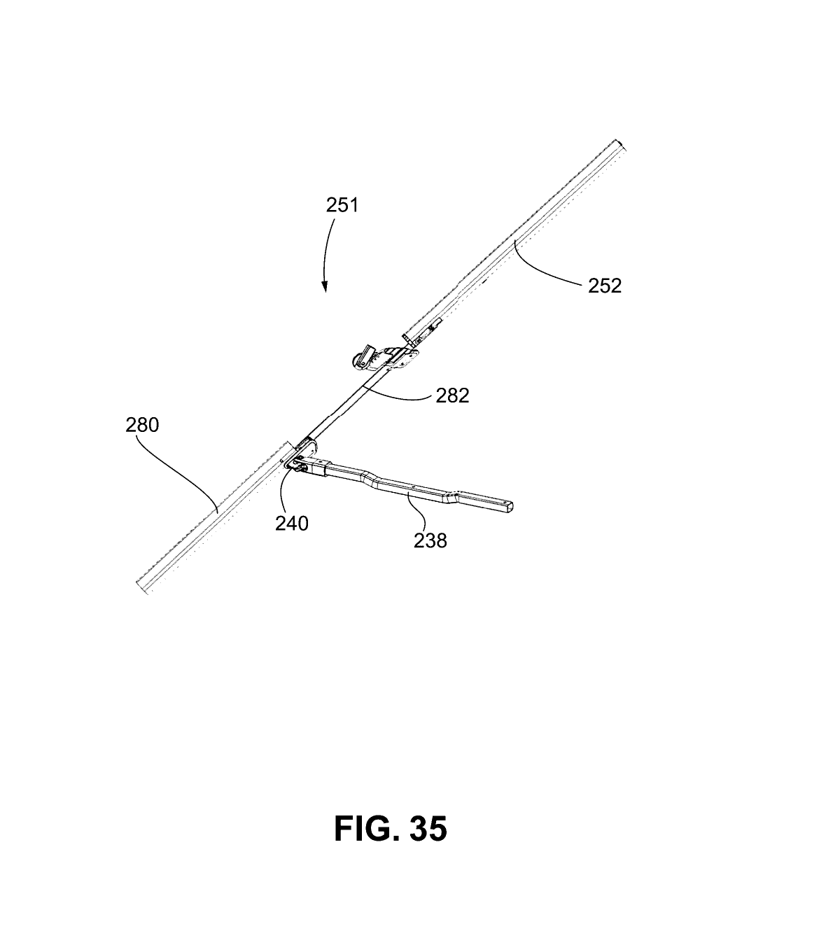

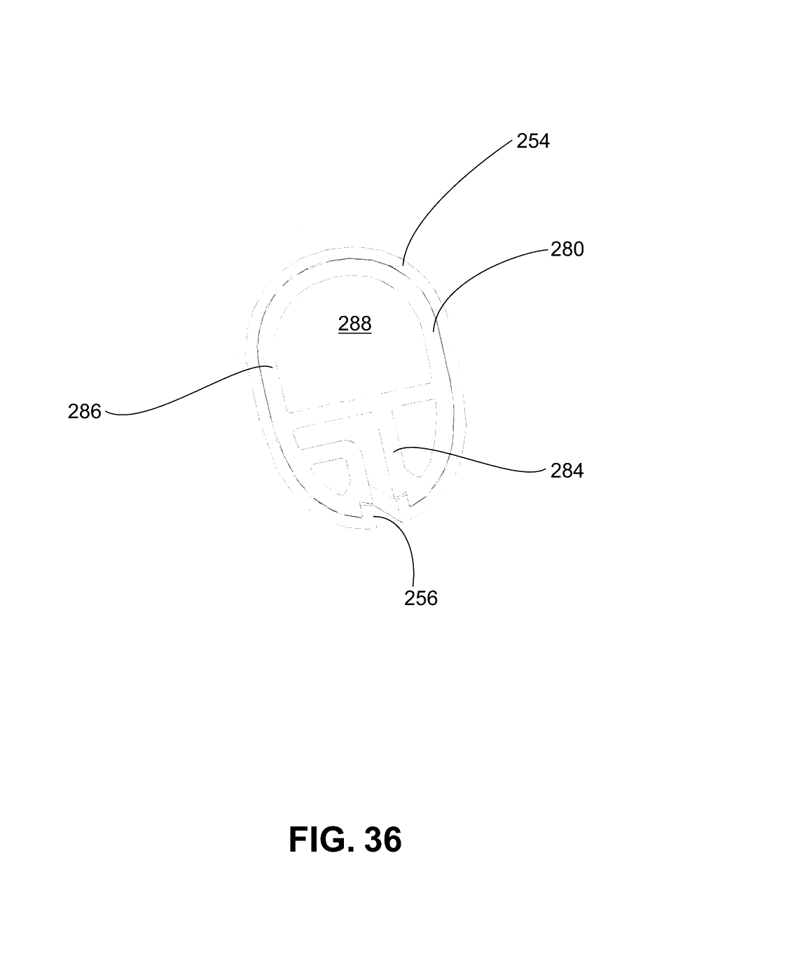

With reference to FIGS. 35 and 36, to counteract this lack of rigidity, the stroller includes an inner tube assembly 251 consisting of the inner tube 252 which is inserted partially within the outer tube 254, a tube stiffener 280, and an extension member 282 extending between an end of the inner tube 252 and the tube stiffener 280. The inner tube 252 is inserted within the outer tube 254 approximately 5 to 6 inches when the stroller is in the open position and is configured to insert farther into the outer tube 254 as the stroller transitions to the closed position. The tube stiffener 280 is a substantially hollow member disposed within the outer tube 254 below the slidable joint 240 when the front support is in the open position. The tube stiffener 280 includes a slot 284 which corresponds with the slot 256 of the outer tube 254. The tube stiffener 280 provides rigidity for the lower portion of the outer tube 254. When the stroller is in the open position, the extension member 282 extends from an end of the inner tube 252 to the slidable joint 240. As the stroller 210 transitions from the open position to the closed position, the extension member 282 pushes on the slidable joint 240 advancing the joint 240 downward through the slot 256 of the outer tube 254 and the corresponding slot 284 of the tube stiffener 280. As the extension member 282 is advanced downward, the extension member 282 is also received within the slot of the tube stiffener 280.

As shown in FIG. 36, the tube stiffener 280 may further include a portion having an unbroken sidewall 286 defining an entirely enclosed portion 288. The slot 284 is separate from the enclosed portion 288. As described above, an unbroken tubular member has increased rigidity compared to a member having a slot. By including the unbroken enclosed portion 288, the rigidity of the tube stiffener is enhanced. Alternatively, the tube stiffener 280 could include a cross member extending longitudinally along the hollow interior of the tube. The cross member would contribute rigidity to the tube stiffener 280. However, including a cross member extending along the entire length of the tube stiffener 280 would add additional weight.

In this configuration, it is understood that the outer tube 254 is effectively divided into three segments when the stroller 210 is in the open position. The first segment is the portion of the tube 254 between the front wheels 246 and the slidable joint 240. The tube stiffener 280 is disposed within this segment and contributes additional rigidity to this segment of the outer tube 254. The second segment is the portion of the outer tube 254 from the slidable joint 240 to the inserted end of the inner tube 252. This segment of the outer tube 254 lacks rigidity since the only additional structure in this segment of the outer tube 254 is the extension member 282. However, the rigidity of the other segments of the outer tube 254 has been found to be sufficient to ensure proper function of the stroller 210 even though this middle segment lacks rigidity. The third segment corresponds to the 5 to 6 inches of overlap between the inner tube 252 and the outer tube 254. In this segment, the inner tube 252 provides additional rigidity for the outer tube 254.

Alternatively, the slot 256 of the outer tube 254 could be manufactured to extend only along the portion of the outer tube 254 between the slidable joint 240 and lower end of the outer tube 254 (e.g., the portion of the outer tube 254 which includes the tube stiffener 280). In that way, the rigidity of the second segment of the outer tube 254 would be preserved since it would not include one slot 256. However, machining a slot extending only partially along the length of the outer tube 254 is more expensive than is machining the slot 256 along the entire length of the outer tube 254.

In a non-limiting embodiment of the inner tube assembly 251, the slidable joint 240 includes a key (not shown), which functions as a locking structure for the outer tube 254. The key is inserted into the slot 256 of the outer tube 254. The rigid member 238 of the scissor linkage 218 is connected to the key to form the slidable joint 240. In this configuration, the slidable joint 240 is freely rotatable, relative to the key, along both the horizontal and vertical axis. When the stroller 210 is in the open position, the key provides additional rigidity for the outer tube 254, helping to prevent the middle segment of the other tube from flexing or twisting during use. As the stroller 210 transitions to the closed position, the key slides downward along the slot 256 as the rigid members 238 are being rotated together about the center joint 242. Thus, the slidable joint 240 must freely rotate to accommodate both the downward motion of the key and the horizontal rotation of the rigid member 238.

Drive Systems

With reference again to FIGS. 26-34, the stroller 210 further includes one or more drive systems (e.g., an electric motor, hydraulic system, or manually operable mechanical system) for transitioning the stroller 210 between the open and closed positions. In one non-limiting embodiment, the stroller includes two driving subsystems, namely, a system for transitioning the frames 212, 214 between the open and closed positions, and a system for latching and folding the parallelogram linkage 216.

Cable Drive

The drive system for the frame consists of a drive mechanism 258 coupled to the front support 220. The drive mechanism 258 transitions the right 212 and/or left frame 214 between the open and closed positions by inserting or removing the inner tube 252 from the outer tube 254. With reference to FIG. 38, the drive mechanism includes a cable drive 312 coupled to a first spool 314 and a second spool 316. It is understood that the spools 314, 316 may be separate structures or integrally formed. A first cable 318 and a second cable 320 are connected to the spools 314, 316. The first cable 318 and the second cable 320 are disposed within the hollow portion of the front support and extend longitudinally along the length of the front support from the frame joint toward the upper end of the front support. The spools 314, 316 are configured such that when the first spool 314 is full, the second spool 316 is empty. Accordingly, when the stroller transitions from the open position to the closed position, one spool is rotated to release the cable while the other spool winds the cable inward. In this way, the drive mechanism pulls on the inner tube to effectuate the transition to the closed position. When the stroller is transitioned to the open position, the process is reversed, meaning that the spool which received the cable when closing the stroller releases the cable when opening and vice versa.

In one preferred non-limiting embodiment, the cable drive 312 is directly connected to the first spool 314 and the second spool 316 such that a single revolution of the cable drive 312 causes a single rotation of the spools 314, 316. In such a configuration, it is necessary that the spools 314, 316 have a narrow diameter so that only a small amount of cable is drawn in or released by each successive revolution of the cable drive 312. Accordingly, a narrow gauge cable must also be used to fit on the narrow spool. It has been determined that cables formed from synthetic polymers such as ultra-high molecular weight polyethylene (UHMWPE) form an effective thin cable having good mechanical strength. Connecting the cable drive 312 directly to the spindle reduces the weight of the drive mechanism by reducing the number of parts. Alternatively, the cable drive 312 may be connected to the spools 314, 316 through a gear box (not shown). The gear box permits slower revolution of the spools 314, 316, which permits use of a larger diameter spool and cable. However, adding a gear box to the drive mechanism increases the total weight of the system.

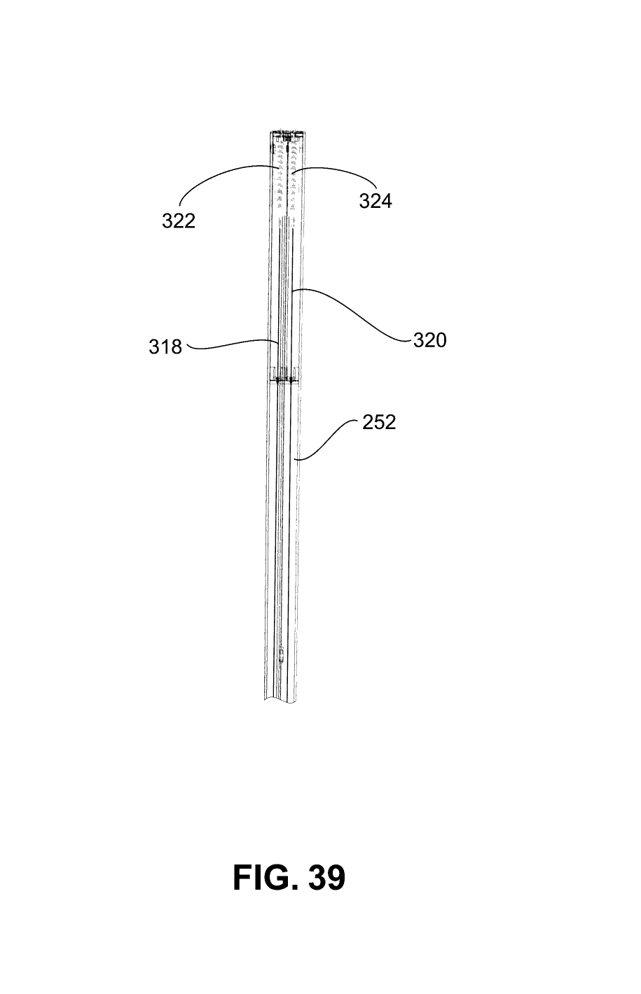

With reference to FIG. 39, the present invention recognizes that for drive mechanisms having narrow spools, the difference in the amount of cable wound or unwound by each revolution of the spindle is substantially different based on whether the spool is fully loaded or empty. Therefore, in the cable drive system of the present invention, in which, at the beginning of the transition from closed position to the open position, one spool is empty and one is full, the amount of the cable being wound by one spool is substantially different from the amount of cable being unwound on the other spool. The discrepancy between the amount of cable being wound and unwound means that one cable will have excess slack when the drive mechanism is engaged. The excess slack could cause the cable to tangle during winding. To counteract this difference in the amount of cable being released, the drive system further includes a first biasing member, such as a first spring 322, and second biasing member, such as a second spring 324, connected in series with the first cable 318 and the second cable 320 and anchored to an upper portion of the front support. The springs 322, 324 remove excess slack from the cables 318, 320. In one non-limiting embodiment, the springs 322, 324 are in the extended position when the stroller is open and closed. However, during the transition, while the drive mechanism is engaged, the springs 322, 324 compress longitudinally toward the upper portion of the front support 20, thereby removing any slack in the cables 318, 320.

In the above described embodiment of the stroller and drive mechanism, the stroller includes only one drive mechanism coupled to the front support. A single drive mechanism can be used as long as the stroller is sufficiently rigid so that movement of one front support causes corresponding parallel movement of the opposing front support. Alternatively, the stroller may include a drive mechanism coupled to each of the front supports. In that case, the drive mechanisms may be configured to operate concurrently to synchronize movement (e.g., opening or closing) of the right frame and the left frame.

Parallelogram Drive

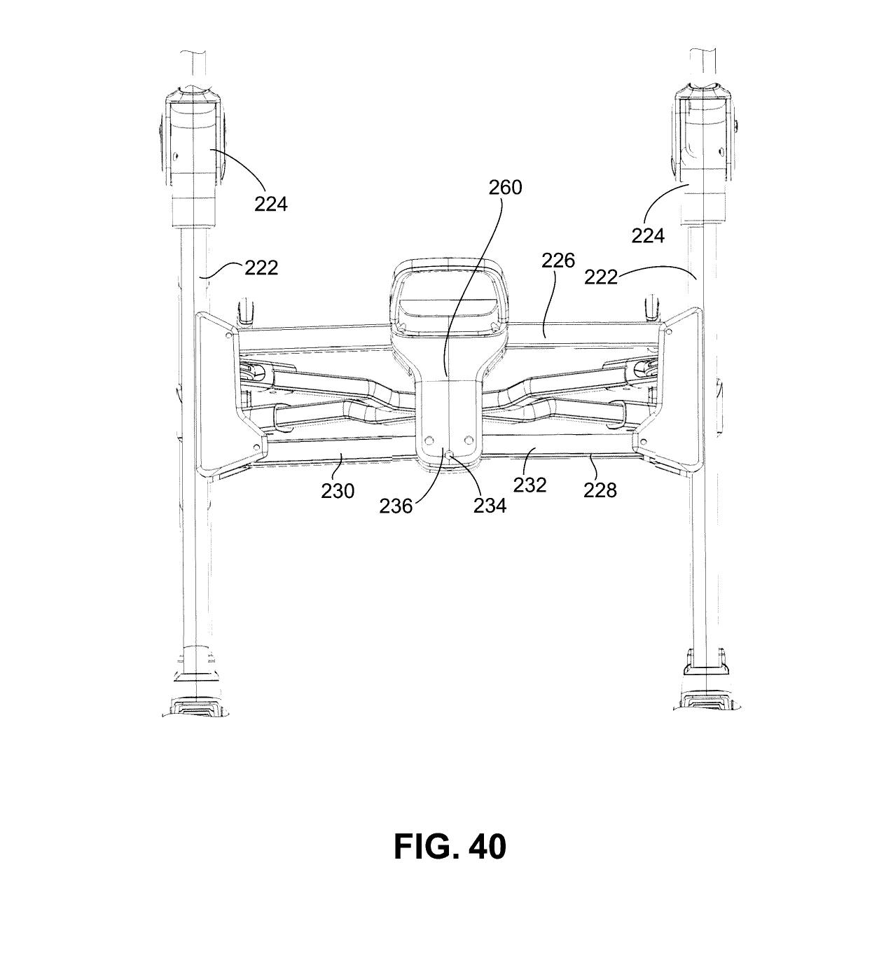

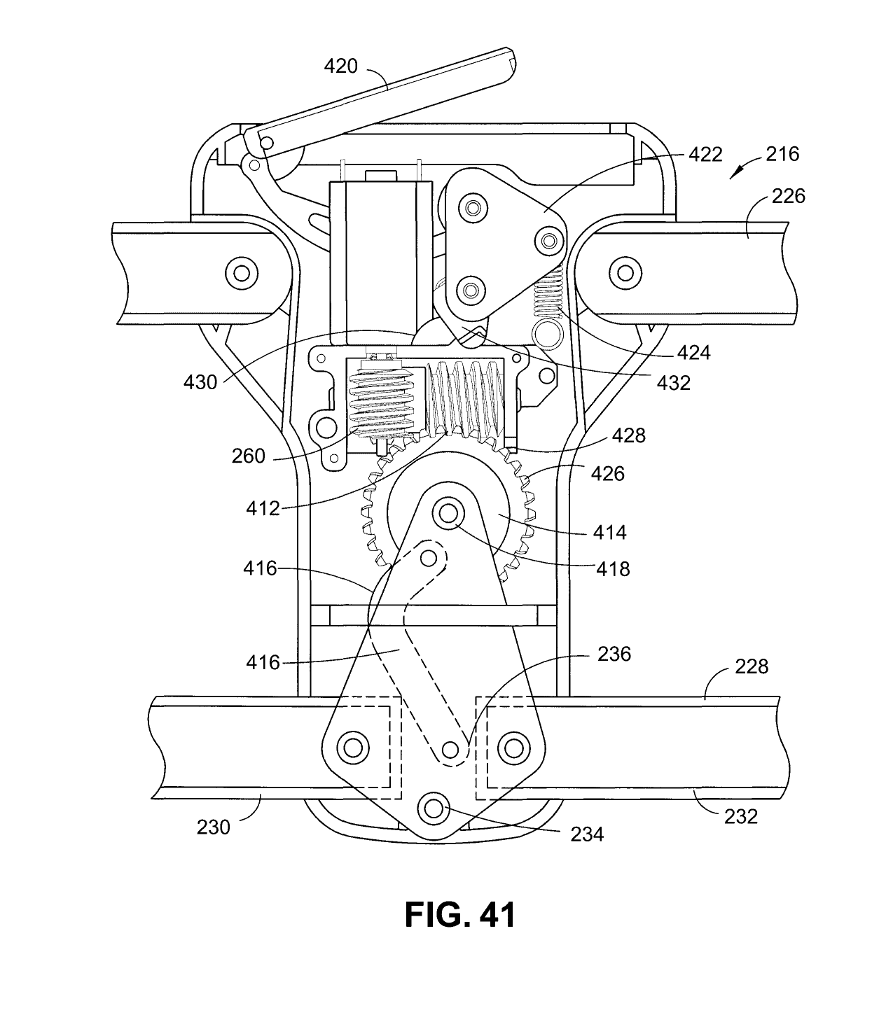

With reference to FIGS. 40 and 41, the stroller may further include a drive mechanism 260 coupled to the parallelogram linkage 216 for transitioning the horizontal members 226, 228 of the parallelogram linkage 216 from the extended position (when the stroller is in the open position) to the folded position (when the stroller is in the closed position). The drive mechanism 260 should also function as a latch or locking member for maintaining the parallelogram linkage 216 in the open position. In a preferred non-limiting embodiment, the drive mechanism 260 is driven by an electric motor; however, other drive mechanisms as are known in the art (mechanical, hydraulic, etc.) may also be used within the scope of the invention.

With specific reference to FIG. 41, in one non-limiting embodiment, the drive mechanism 260 includes a screw drive 412 coupled to a rotatable gear 414. Rotation of the gear 414 drives a locking support element 416 which is connected between the gear 414 and the folding joint 234 of the lower horizontal member 228. When the parallelogram linkage 216 is in the open (e.g., extended) position, locking support element 416 is a latch for preventing the horizontal members 226, 228 from folding. More specifically, in the open position, the locking support element 416 is approximately singular (i.e., in alignment) with an axis 418 of the gear 414 to effectively counteract any upward or downward force applied to the horizontal members 226, 228. However, the drive mechanism 260 is configured so that the gear 414 and locking support element 416 are stopped just short (e.g., approximately 10 degrees short) of the singular (i.e., aligned) position. Stopping rotation of the gear 414 short of the singular position ensures that the gear 414 will not be accidently rotated past the singular position. Since the drive mechanism 260 cannot be driven backwards, if the gear 414 were accidently advanced past the singular position, the transition between the closed and open position would need to be repeated to lock the horizontal member 226 in place. It has been determined that maintaining the locking support element 416 in an approximately singular position (within 10 degrees of singular) is sufficient to counteract folding forces and to effectively maintain and lock the parallelogram linkage 216 in the open position.

With continued reference to FIG. 41, in one non-limiting embodiment, the drive mechanism 260 further includes a manual override clutch for transitioning the drive mechanism 260 from an automatically folding configuration to a manually folding configuration. The manual clutch includes a lever 420 coupled to a rotatable cam 422. In the engaged (i.e., automatic) configuration, the lever 420 orients the cam 422 to exert a downward force on the screw drive 412 to maintain contact between the screw drive 412 and gear 414. A spring 424 also coupled to the cam 422 provides additional downward force for maintaining the contact between the screw drive 412 and gear 414. When the lever 420 is released (i.e., transitioned to the manual position), the cam 422 rotates, thereby disengaging the screw drive 412 from the gear 414. When the screw drive 412 is disengaged from the gear 414, the user can manually fold the stroller by applying downward force to the horizontal members 226, 228.

A potential problem with a screw drive 412 which is configured to engage and disengage with a gear 414 is aligning the threads 426 of the screw drive 412 with the teeth 428 of the gear 414. If the threads 426 and teeth 428 are not aligned when contact between the gear 414 and screw drive 412 is established, the possibility exists that the threads 426 will be pressed against the upper portion of the gear teeth 428, rather than into the gear 414, causing damage to the teeth 428 and/or threads 426. In a preferred embodiment, the drive mechanism 260 prevents damage to the teeth 428 and gears 414 by initially applying a light preload and slowly rotating the screw drive 412 until the gear teeth 428 and threads 426 of the screw drive 412 catch and align. Once the gear 414 and threads 426 are correctly aligned, additional compressive force between the screw drive 412 and gear 414 is applied and the rotation speed of the screw drive 412 is increased. However, the gears 414 and screw drive 412 are not subjected to this additional force until it is determined that the screw thread 426 and gear 414 are aligned. In certain embodiments, the drive mechanism 260 further comprises a sensor (not shown) for determining whether the screw drive 412 and the teeth 428 of the gear 414 are correctly aligned. If the sensor determines that the alignment is correct, there is no need to apply the light preload force for aligning the gear 414. If the sensor determines that the gear 414 is not in alignment, the light preload is applied. In an alternative embodiment, the drive mechanism 260 does not include an alignment sensor. In that case, the preload pressure will be applied each time that the gear 414 is brought into contact with the screw drive 412, whether or not they are in alignment.

The drive mechanism 260 may further include a visual indicator (not shown) such as a display, switch, or lighted button for informing the user about what position the drive system is in. For example, the visual indicator could indicate three possible stages: auto, in which the gear 414 and screw drive 412 are engaged and locked together such that full power can be applied to open or close the stroller 210; manual, in which the gear 414 and screw drive 412 are not engaged allowing users to manually open or close the stroller 210; or auto but disengaged, in which the gear 414 is not properly aligned and light pressure will be applied to align the gear 414. Alternatively, the position of the lever 420 may be sufficient to indicate to a user whether the clutch is in the automatic or manual position.

The present invention also recognizes the possibility that a user may try to force the stroller 210 to close while the drive mechanism is in the automatic position and the gear 414 is engaged with the screw drive 412. Such forcing motion would potentially strip the gear 414 damaging the drive mechanism 260. To counteract such forcing motion, in one preferred embodiment, the drive mechanism 260 is configured to automatically transition from the engaged to disengaged position. Specifically, when a user applies substantial downward force to the horizontal members 226, 228, the cam 422 will rotate, thereby disengaging the screw drive 412 from the gear 414.

Synchronization Between Drive Mechanisms

With reference to FIGS. 38 and 41, the drive mechanisms 258, 260 further include a synchronizing connection between the frame drive mechanism 258 and the parallelogram drive mechanism 260 to ensure that the frame drive mechanism 258 will not engage when the parallelogram drive mechanism 260 is in the manual (i.e., disengaged) position. In one non-limiting embodiment, the connection 430 includes a rotatable cam 432 coupled with the parallelogram drive mechanism 260 which is in mechanical connection with a corresponding rotatable cam 326 of the frame drive system 258 through a cable 430. When the parallelogram drive mechanism 260 transitions from the engaged position to the disengaged (i.e., the manual) position, the cam 432 rotates causing the corresponding cam 326 of the frame drive mechanism 258, which is connected by the cable 430, to rotate. Rotation of the cam 326 of the frame drive mechanism 258 causes the cable drive 312 to disengage from the spools 314, 316 to prevent rotation. When the parallelogram drive mechanism 260 is transitioned to the automatic position, the cam 326 of the frame drive mechanism 258 is rotated to reinitiate connection between the spools 314, 316 and cable drive 312 to permit folding movement of the front support 220.

Electrical Components and Systems

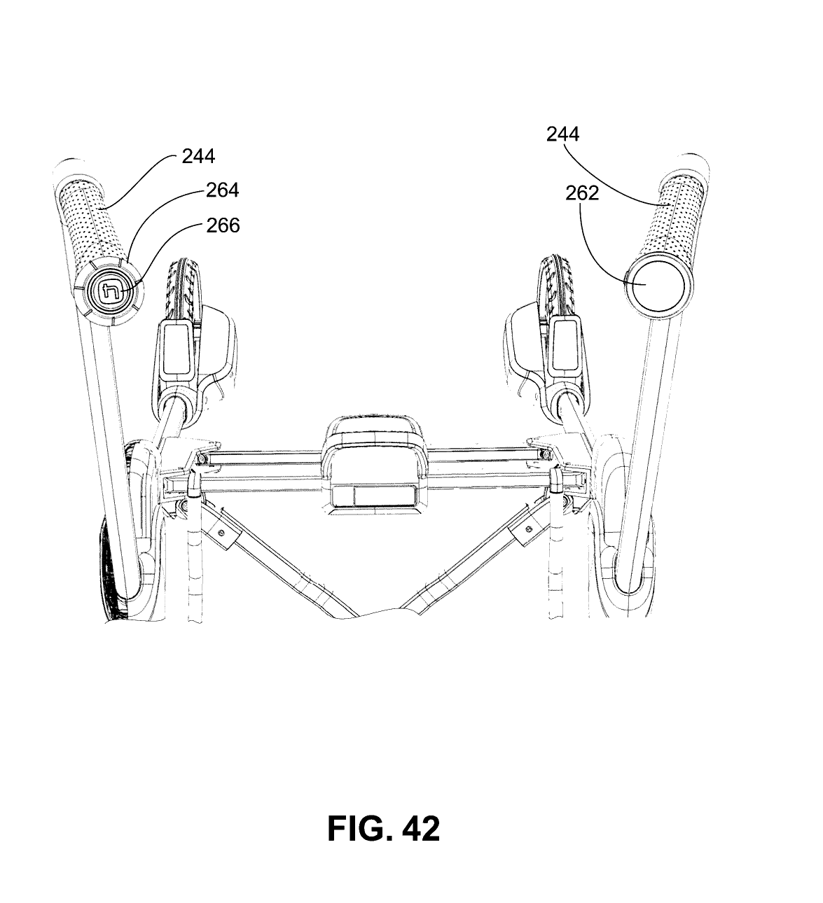

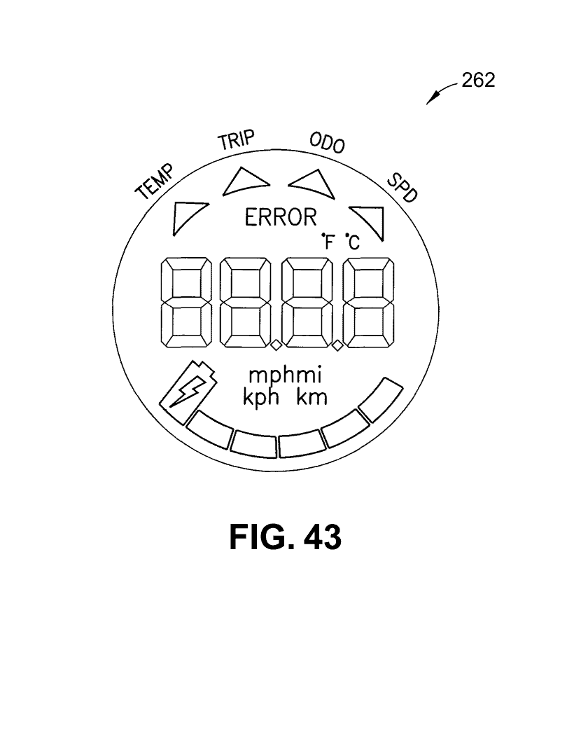

In addition to the above described drive mechanisms, the stroller may include numerous other electrical systems within the scope of the present invention. For example, the stroller may include headlights, daytime running lights, as well as a user interface system. Several user interface options are provided within the scope of the present invention ranging from a simple interface to a complete interface offering information about the stroller and surrounding environment. With reference to FIGS. 42 and 43, in one embodiment, the user interface is presented on a LCD visual display 262 disposed on an end of the handles 244 of the stroller. An exemplary schematic drawing of a visual interface 262 in accordance with the present invention is depicted in FIG. 43. The visual interface 262 displays information from the plurality of sensors on the stroller including speed, baby on board, open or closed, temperature, total distance traveled, and time, as well as other relevant information important to a user.

In one non-limiting embodiment, the electronics systems of the stroller 210 are powered by an on-board battery that is charged as the stroller is pushed. In certain embodiments, this charging is accomplished by generators housed in the stroller wheels combined with circuitry used to direct the power generated by the stroller back into the battery. An exemplary generator for use with a power folding stroller is disclosed in U.S. Pat. No. 8,193,650, issued on Jun. 5, 2012, which is hereby incorporated by reference in its entirety. Optionally, the stroller may also be charged via an AC adapter, such as a wall adapter.

In one non-limiting embodiment, the above described electronics (e.g., drive mechanisms, sensors, headlights, visual displays, and odometers) are controlled by one or more microcontrollers. Although all control can be handled by a single microcontroller, it is sometimes advantageous to use multiple microcontrollers for a cost advantage. For example, one or more microcontrollers are used to control and monitor the various electronic components associated with power folding and unfolding. In one preferred embodiment, the drive mechanisms are controlled via several of the microcontroller ports which in turn control the motor drive electronics. In one embodiment, the motor drive electronics consist of an H-bridge style circuit allowing the motors to be run in a bi-directional manner and at various speeds via pulse-width modulation (PWM). The microcontroller may utilize several addition ports to monitor various sensors which provide information about the position of the frame, the position of the latch, and whether the stroller has a child on board. Remaining microcontroller ports are dedicated to a user interface of the stroller, which provides a means for the user to interact with the stroller and where the stroller communicates information to the user.

Control Software

In certain configurations, the various electronic components of the stroller 210 are controlled by software systems responsible for utilizing the electrical system to manipulate the mechanical system in a safe and efficient manner. Sensors contained in the electrical system are routed back from the microcontroller which contains the software used to process the sensors data and determine an appropriate action. There are three major sections to the software.

The first section handles the user interface where information is communicated to the user regarding the state of the stroller's mechanical and electrical systems, and where the user can interface with the stroller, for example, to request the stroller to fold or unfold. The second section handles monitoring the state or condition of the stroller. The software will interpret the various signals received from the sensors and determine whether the stroller is in a useable state (e.g., mechanically and structurally sound), whether the stroller is occupied, whether the stroller is broken, etc. The third section handles the motion of the stroller through the folding and unfolding process. Throughout the folding and unfolding process, the software must monitor various safety protocols to protect the occupant, the user, and the mechanics.

In one embodiment, the software for controlling folding and unfolding comprises an activation sequence controlled through an activation switch 264. The activation sequence may include obtaining information from one or more object sensors having the ability to detect the presence of objects within the interior portion of the stroller and to interrupt and/or prevent movement of the stroller in the direction toward its collapsed condition when the object sensor detects the presence of an object within the interior portion of the stroller. The object sensor or sensors may be of any known type such as a mechanical weight sensor, a proximity sensor, a motion sensor, a light beam sensor, or any other device having the ability to detect the presence of an object within the interior of the stroller. The sensor or sensors may be electronic and may send a signal that is electrically acted upon to prevent or interrupt power to the motor, and/or the sensors may be mechanical and actuate a physical lock or a brake to prevent further collapsing or the full collapsing movement of the stroller. Sensors may also be used to detect the presence of modular add-on devices connected to the stroller, such that movement of the stroller to its collapsed condition is prevented when a connected add-on is detected, thereby preventing potential damage to the add-on device.

In a preferred embodiment, the activation switch 264 is a dead man switch disposed on the handles 244 of the stroller. A dead man switch must be engaged (i.e., pressed downward) throughout the entire opening or closing movement. Releasing the switch pauses the folding or unfolding movement of the stroller. Pressing the switch a second time continues the movement. The switch may further include a twisting element 266 for priming the activation sequence prior to initiating the opening or closing action.

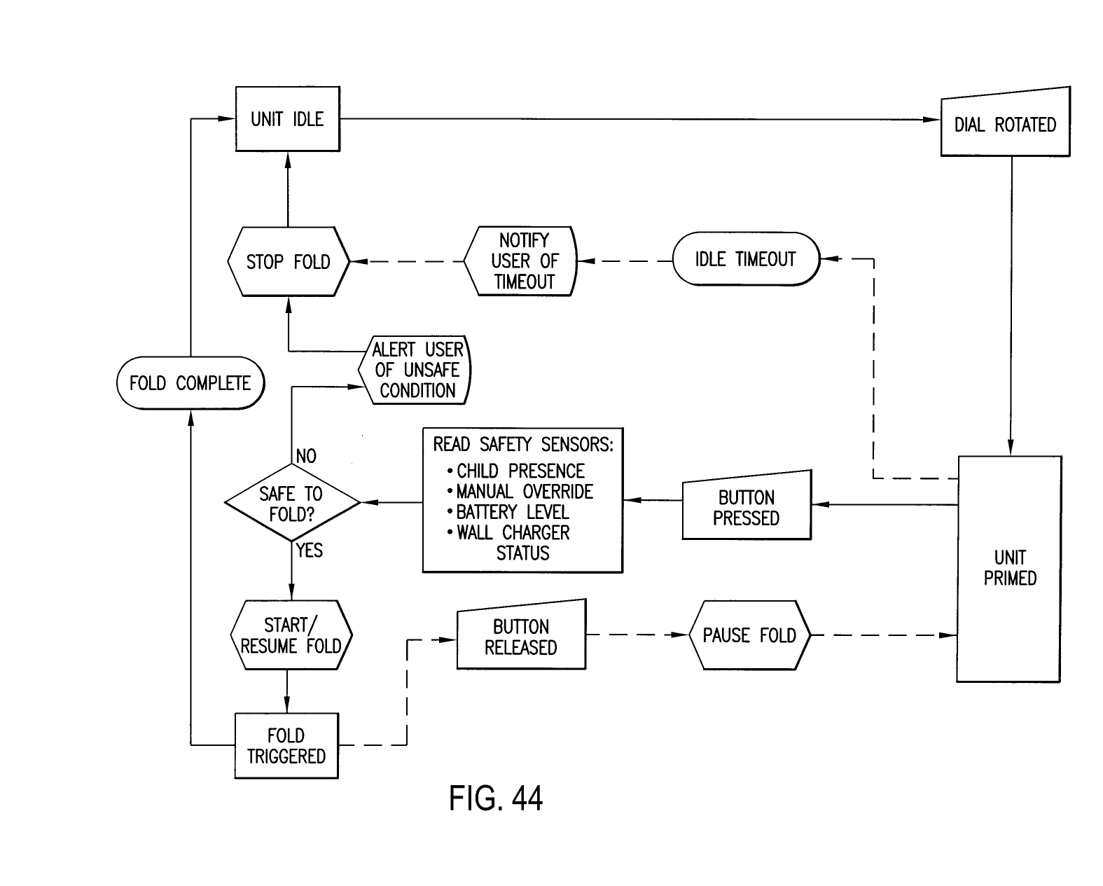

With reference to FIG. 44, a non-limiting embodiment of the activation sequence for the stroller is depicted. As indicated in the exemplary activation sequence, at most times, the stroller control unit is idle. Engagement of a twisting element or dial primes the control unit, essentially waking it up from idle. The activation switch may include an indicator, such as a sound or light, which demonstrates that the control unit has transitioned from idle to primed. After priming, the user initiates activation (opening or closing the stroller) by pressing the activation switch. In certain embodiments, the unit will only remain primed for a limited time period, after which, the unit will “timeout”. At that point, the unit may include means to inform the user that the priming has timed out and the unit is returning to idle. When the activation switch is engaged (i.e., depressed), the unit is configured to receive and evaluate safety data from a plurality of safety sensors disposed on the stroller. Relevant safety data includes whether a child is present, whether the clutch is in the manual position, and the battery level of the power supply. The stroller may also monitor external conditions such as whether the stroller is connected to an external power source, in which case folding or unfolding may be prevented. In certain embodiments, the stroller may alert the user of unsafe conditions such as by describing the condition on a visual display. If the sensors indicate that the stroller is safe to fold or unfold, the folding movement is started or resumed. Folding continues until folding is complete or until the activation switch is released to pause the folding process. When folding is paused, the unit remains primed until either the button is pressed to resume folding or until the unit times out and returns to idle.

The software further includes a frame folding sequence integrated with sensors for determining frame position. The position sensors utilized at selective locations on the frame to send a signal indicative of the positions of one or more components or elements of the stroller. The position sensors can be used for several purposes, such as sending a signal to the display to provide a visual and/or audio indication to the user as to the current position or of the deployment or the collapsing of the stroller, and/or to provide an interrupting signal (or non-signal) if a position sensor or sensors are not engaged as they would be during proper deployment and/or collapsing of the stroller. Any one or more of several known types of sensors may be utilized, such as rotary encoders at any one or more frame component pivot points, and/or limit or contact switches which are engaged as selective elements of the stroller move to their proper positions, or improper positions, during deployment and/or collapsing of the stroller. By way of example, position sensors may be mounted to the stroller at positions which provide indication that the stroller has moved to its fully-deployed condition, its fully-collapsed condition, or any condition in-between; and/or position sensors may be mounted at locations to detect the engagement or lack of engagement of latches. Position sensors may operate in conjunction with electronic timer controls such that a signal to effect stoppage of power to the motor is sent if the position sensor is not engaged within a predetermined time period.

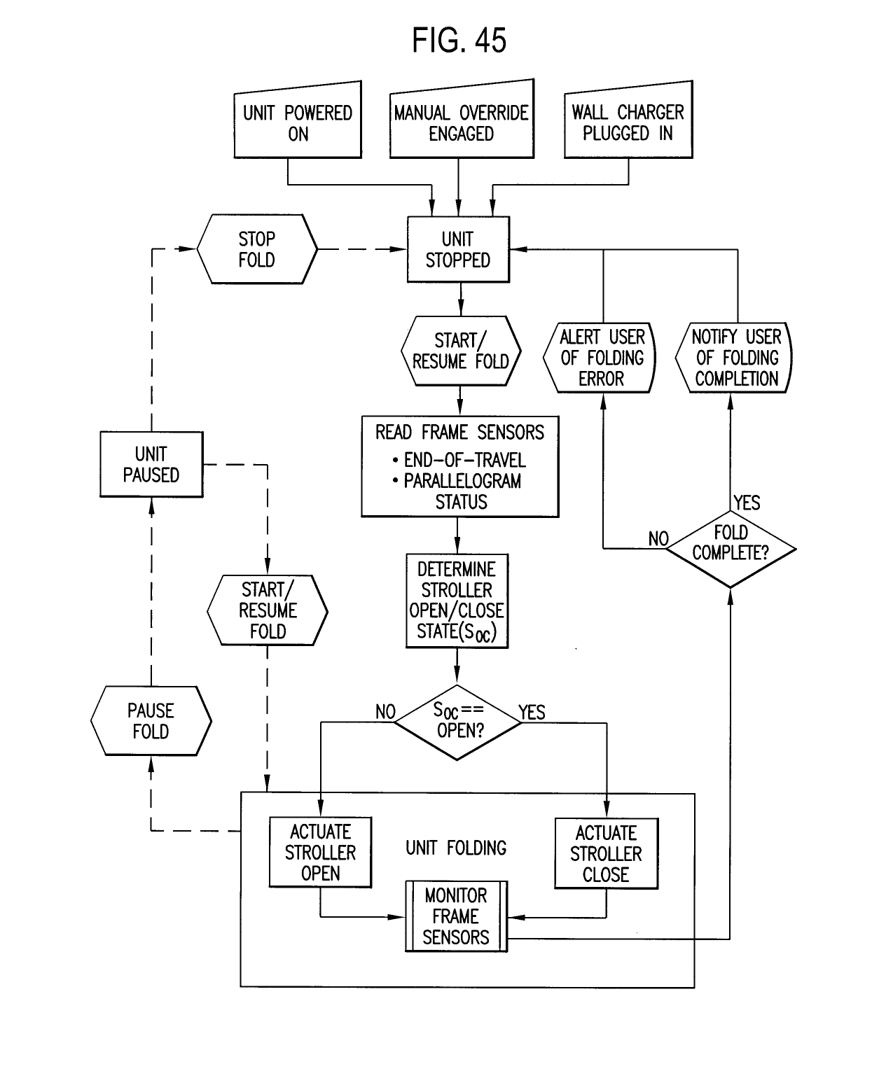

With reference to FIG. 45, in one preferred and non-limiting embodiment, the frame folding process begins by receiving information about whether the unit power is on, whether the manual clutch override is engaged, and whether the wall charger is plugged in. The unit controller must be turned on during folding. However, folding is prevented when the clutch is in the manual position and when the stroller is plugged into a wall charger. When folding is activated by pressing the activation button, the unit receives information from a plurality of frame sensors including the status of the parallelogram linkage (latched or unlatched), the location of the sliding joint (down or up), or whether the telescoping tube is extended or nested. The information from the frame sensors is used to determine whether the stroller is in the open or closed position. Based on the information, actuation of the stroller open or stroller close functionality occurs. During actuation, the unit continues to monitor the frame sensors to determine when opening or closing is complete. If folding or unfolding is completed, the user is notified that the action was successful. Otherwise, the user is alerted that a folding error occurred. It is noted that, as described with regard to the activation sequence, the user can pause folding by releasing the dead man switch. Folding is resumed by pressing the switch to continue folding or unfolding actuation. If the unit remains paused for a period of time, folding times out and the unit returns to the idle or stop folding position until the user reactivates the system by priming the activation switch.

Stroller with Floating Linkage

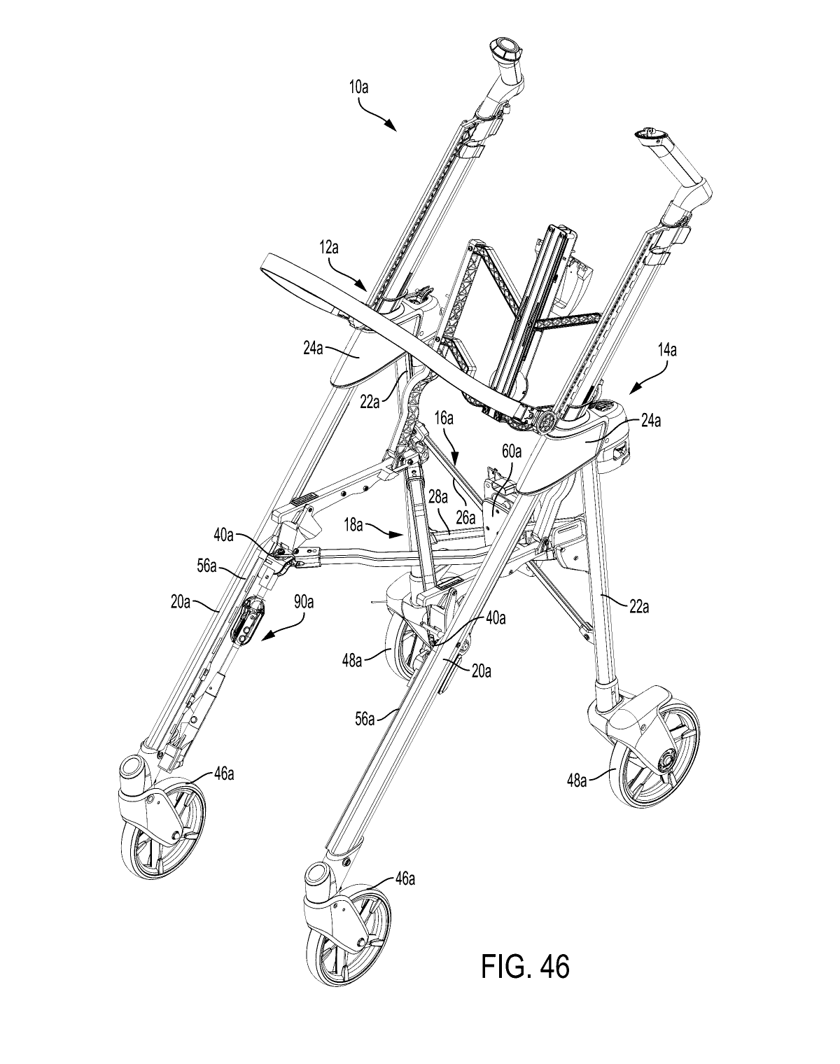

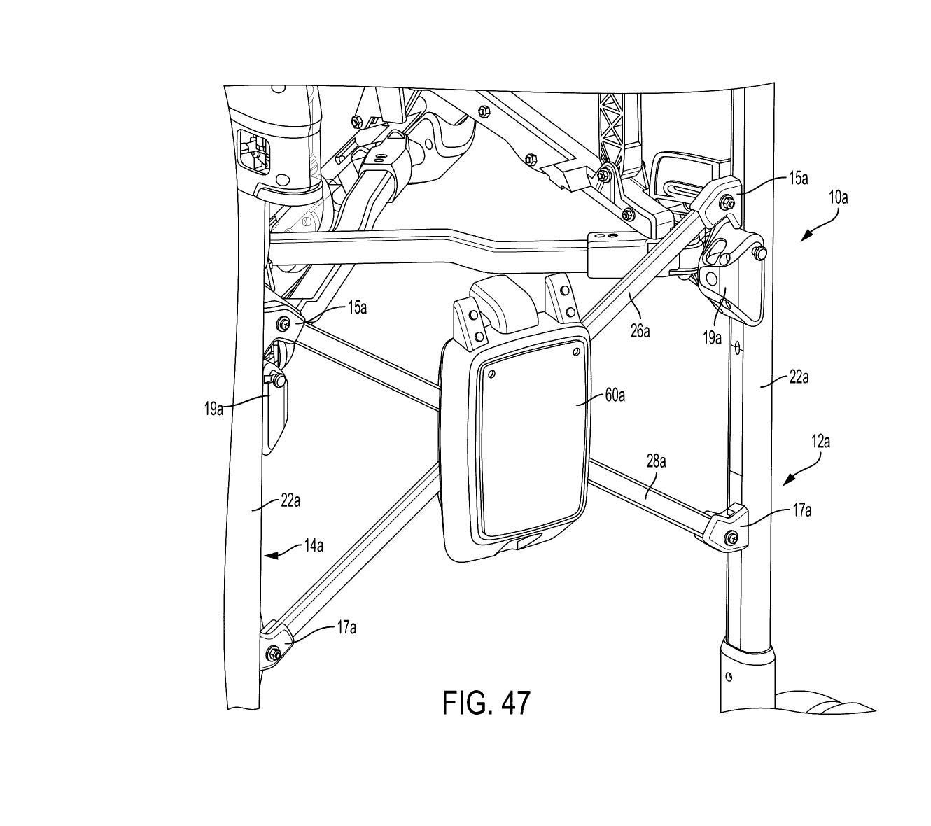

With reference to FIGS. 46-51, another embodiment of a collapsible stroller 10a is illustrated. As in previously described embodiments, the stroller 10a includes a frame with a right side (referred to herein as right frame 12a) and a left side (referred to herein as left frame 14a). The frame is supported by front wheels 46a and rear wheels 48a (shown in FIGS. 46, 50, and 51). The frame is transitionable from an open position to a closed position. As was the case in previously described embodiments of a stroller 210 the frames 12a, 14a can be formed from hollow tubular members and/or telescoping assemblies to reduce the weight and/or to improve appearance. The right frame 12a and left frame 14a are substantially identical in appearance and construction. The right frame 12a is described hereinafter. However, it is understood that the left frame 14a is constructed to mirror the right frame 12a. The right frame 12a includes a front support 20a rotatably connected to a rear support 22a at a frame joint 24a. The front support 20a and the rear support 22a are movable from an open position to a closed position. In the open position, the front support 20a is positioned at approximately a 45 degree angle relative to the rear support 22a. In the closed position, the front support 20a and rear support 22a are approximately parallel. However, these angles are not intended to be limiting and may vary within the scope of the present invention. In one exemplary embodiment, the stroller 10a in the open position is depicted in FIGS. 46-48. The stroller 10a in the closed position is depicted in FIG. 24.

As shown in FIGS. 46-49, the right frame 12a and the left frame 14a are connected by one or more linkage assemblies, such as a rear linkage 16a and a horizontal or seat linkage 18a. The horizontal linkage 18a is substantially equivalent to the scissor linkage 218 (shown in FIGS. 26-29) discussed above in connection with previously described embodiments. The rear linkage 16a replaces the previously described parallelogram linkage 216 (shown in FIGS. 26-29).

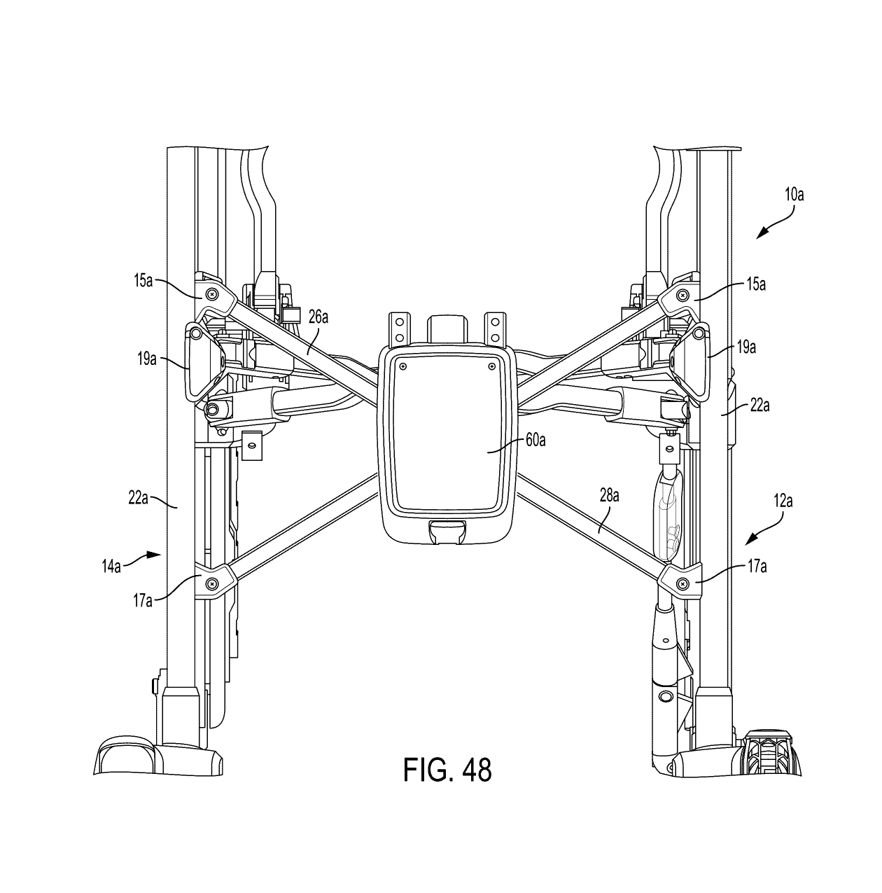

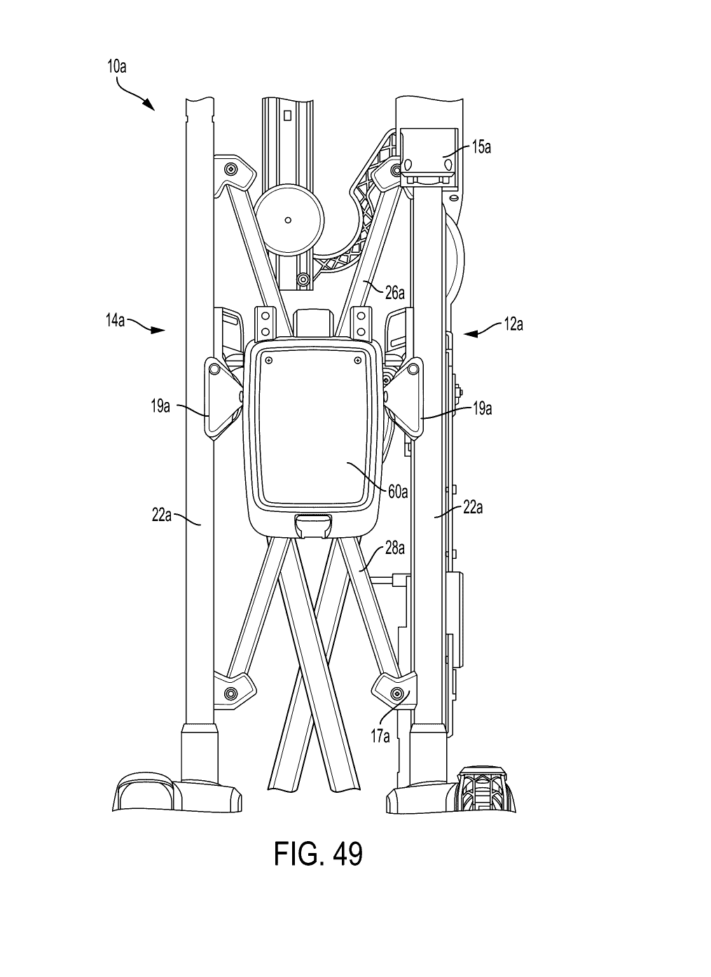

In some embodiments, the rear linkage 16a is a scissor or x-shaped assembly including a first member 26a or beam and a second member 28a or beam. The first member 26a and the second member 28a extend between the right frame 12a and the left frame 14a, and are connected to one another at a central pivot point or joint, located behind the battery pack 60a (shown in FIGS. 46-49). The first member 26a and the second member 28a are connected to the right frame 12a and the left frame 14a respectively at sliders 15a, 17a (shown in FIGS. 48 and 49). Specifically, the sliders 15a, 17a comprise a rotatable connector attached to ends of the member 26a, 28a and a protrusion or fin (not shown) extending therefrom. The protrusion or fin is slidably inserted in a slot or channel extending longitudinally along a portion of each rear support 22a.

In use, as the stroller 10a transitions from the open position to the closed position, the rear supports 22a rotate toward the front supports 20a and the right frame 12a moves toward the left frame 14a. As a result of the movement of the right frame 12a toward the left frame 14a, the sliders 15a, 17a move away from one another. When the stroller 10a is in the closed position, the sliders 15a, 17a are constrained within the slots of the rear supports 22a, but are otherwise free to move in the up and down directions. This configuration is referred to as a fully floating configuration, since the ends of each member 26a, 28a freely move in the up and down directions within the slots or channels. As the stroller 10a transitions from the closed position to the open position, the sliders 15a, 17a move toward one another. In the fully open position, upper sliders 15a rest against fixed joints 19a (shown in FIGS. 46-49) and are prevented from moving farther in the downward direction. Accordingly, in this fully open position, the linkage 16a is able to provide stiffness to the frame 12a, 14a and endure operational loads for the stroller 10a.

As shown in FIGS. 46-49 electronic devices, such as a battery pack 60a can be connected to the rear linkage 16a. The battery pack 60a can include batteries and other electronic devices for providing power to electrical system of the stroller 10a, such as the drive mechanism, described hereinabove, that opens and closes the stroller 10a. In the embodiment illustrated in FIGS. 46-49, the battery pack 60a does not include motors or mechanical systems for moving the rear linkage 16a. However, in other embodiments, a dedicated motor or drive mechanism may be enclosed in the battery pack 60a and integrated with the rear linkage 16a to effectuate folding and unfolding of the rear linkage 16a. The motor or drive mechanism may be configured to operate simultaneously and in conjunction with drive mechanism for other portions of the stroller 10a. Alternatively or in addition, the rear linkage 16a can include one or more latch or lock mechanisms. The latch or lock mechanism can maintain the rear linkage 16a in its open and/or closed position and prevent, for example, a user from attempting to open or close the stroller 10a manually (e.g., without operating the drive mechanisms). In some embodiments, the latch or lock mechanism can engage or disengage automatically prior to actuating the drive mechanism to transition the stroller 10a from the open position to the closed position or vice versa.

Collapsible Stroller with Kickstand

With reference now to FIGS. 46, 50, and 51, a kickstand or foot stand (referred to herein as a stand structure 90a) for the stroller 10a is illustrated. The stand structure 90a is configured to automatically extend from the frame 12a, 14a when the stroller 10a transitions to the closed position. It is noted that in FIGS. 46, 50, and 51, the stand structure 90a is only shown extending from the front support 20a of the right frame 12a. However, the stroller 10a can include a stand structure 90a connected to the front support 20a of both the right frame 12a and the left frame 14a for improved stability.

The stand structure 90a functions as follows. The stand structure 90a is mounted to a portion of the sliding joint 40a or key and is partially inserted in the slot 56a or channel extending longitudinally through the front support 20a of the frame 12a, 14a. The stand structure 90a can be an elongated rigid member that, when the stroller 10a is in its open position, is held alongside the front support 20a of the frame 12a, 14a. When the stroller 10a is in the open position, the stand structure 90a can be hidden from view by various aesthetic structures, storage structures, or soft textile portions connected to the frame 12a, 14a to improve appearance of the stroller 10a. As the stroller 10a transitions from the open position to the closed position, the sliding joint 40a or key pushes the stand structure 90a in a downward direction such that, in the fully closed position, the stand structure 90a at last partially extends beyond the end of the front support 20a and front wheel 46a.

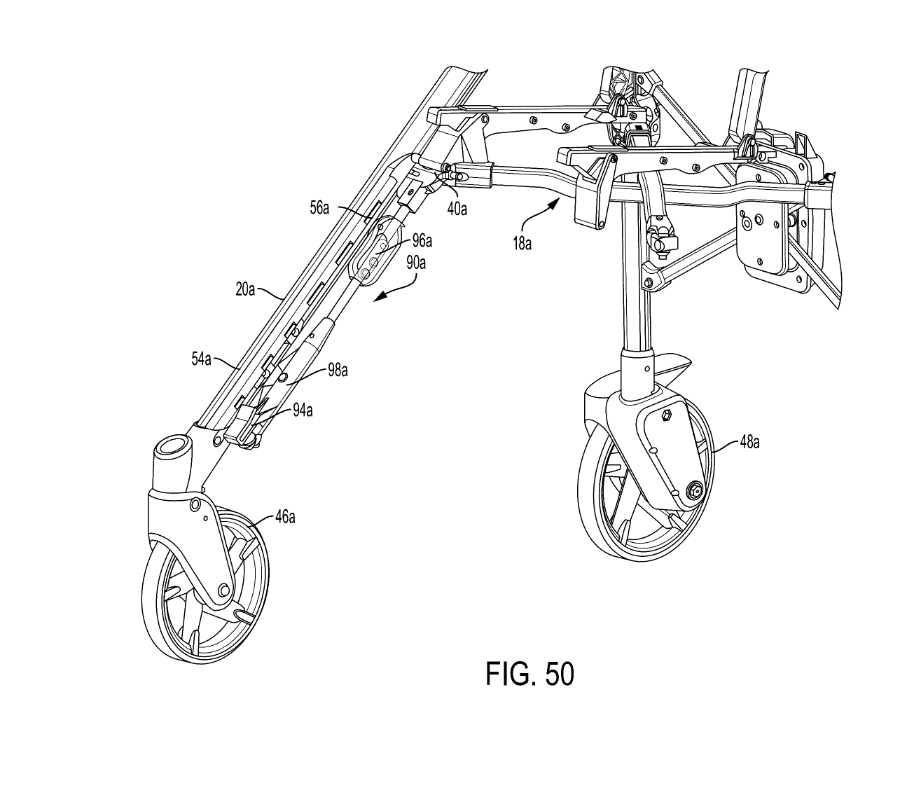

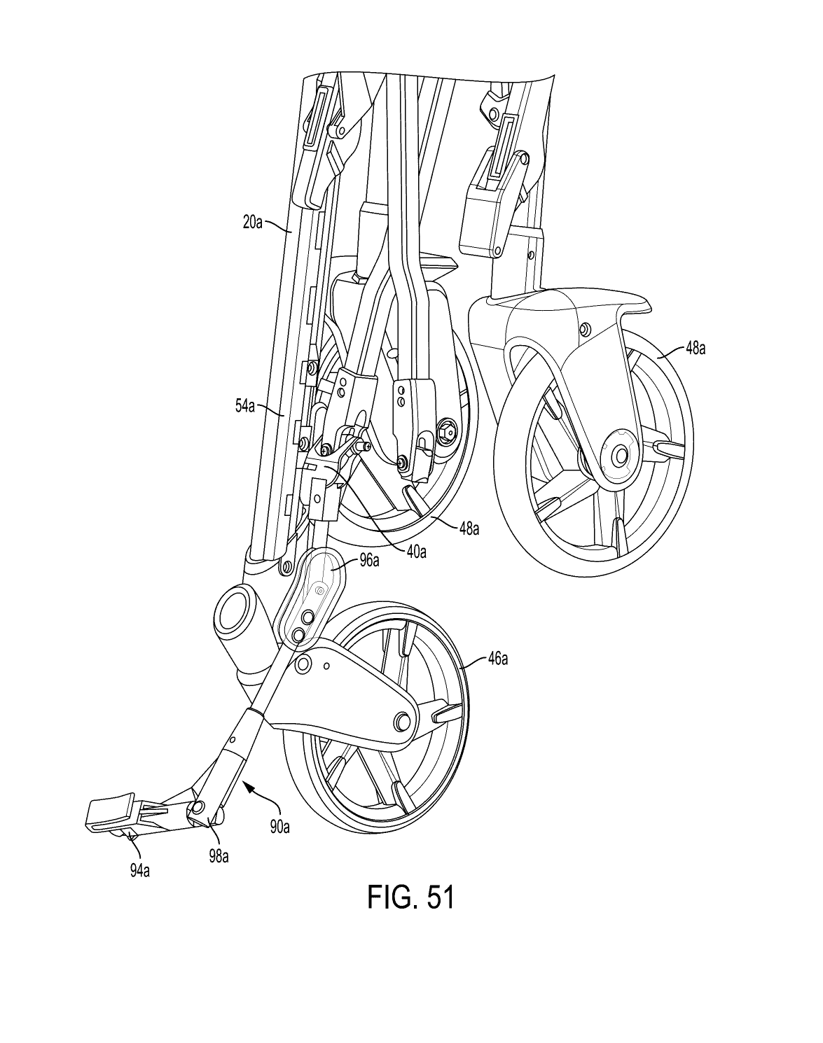

With specific reference to FIGS. 50 and 51, the stand structure 90a may include one or more bending joints, namely, a proximal bending joint 96a and a distal bending joint 98a. The bending joints 96a, 98a cause the stand structure 90a to curl upward and outward as it transitions to the closed position. The stand structure 90a is shown in the retracted position (e.g., when the stroller 10a is in the open position) in FIG. 50 and in the extended position (e.g., when the stroller 10a is in the fully closed position) in FIG. 51. Specifically, as the stand structure 90a transitions to the closed position, the proximal bending joint 96a rotates, such that distal portions of the stand structure 90a curl away from the front wheel 46a. The distal bending joint 98a rotates so that the distal end or contact surface 94a of the stand structure 90a can rest against the ground to support the stroller 10a. When the stroller 10a is in its fully closed position, the stroller 10a can be tipped forward such that it rests on at least three contact points, namely, the front right and left wheels 46a, and the contact surface 94a of the stand structures 90a. In embodiments of the stroller 90a having two stand structures 90a (e.g., a stand structure 90a extending from each of the right frame 12a and the left frame 14a) the stroller 10a can rest against four contact points for improved stability. In either case, the stroller 10a is supported in an upright orientation.

Stroller with Automatically Releasable Latch

In some preferred and non-liming embodiments, a stroller includes a frame with an automatically releasable latch mechanism for maintaining the stroller in an open position. The stroller further includes a drive mechanism mounted to the frame which, upon actuation, transitions the frame between the open position and the closed position. In some examples, the latch prevents the stroller from closing unexpectedly even when the drive mechanism is not engaged and/or does not function as expected. Further, the latch contributes to stability of the stroller in its open position by blocking movement of collapsible or movable portions of the frame until the drive mechanism is actuated to transition the stroller between the open and closed positions. The latch is mounted to the frame and is configured to release upon actuation of the drive mechanism so that the stroller can close. Thus, unlike in previously described examples, in which the stroller included a latch driven by a separate and independent motor or drive, the automatically releasable latch is released by the same drive mechanism that opens and closes the stroller. Using a single drive mechanism is simpler than embodiments with multiple motors and, advantageously, avoids difficulties of synchronizing actuation of separate motors as must occur in previously described examples. In some instances, while the stroller includes only a single drive mechanism, the operation of the latch can be distinct from the portion of the drive mechanism which opens and closes the stroller. For example, the drive mechanism may include a cable drive which causes rotation of a spool to open or close the stroller. The drive mechanism may also include linearly actuated components for releasing the latch.

A variety of different types of stroller frames can be adapted to include an automatically releasable latch. For example, the frame can include one or more foldable components as shown, for example, in FIGS. 14-16. The latch may be positioned to engage the foldable components to prevent movement of one component relative to the other component. Upon actuation of the drive mechanism, the latch is released, which allows the foldable components to fold or rotate toward one another, thereby closing the stroller. In other examples, the frame can include portions which slide relative to one another as the stroller closes. For example, the stroller can include symmetrical right and left frame portions connected by one or more substantially horizontal linkage members. As shown, for example, in FIGS. 26-31, the right frame portion and/or the left portion can include a front support and a rear support. The front support and/or the rear support can include telescoping tube arrangements having an inner tube slidably inserted into a fixed outer tube. The latch can be positioned to block insertion of the inner tube into the outer tube, thereby preventing the stroller from closing. Upon actuation of the drive mechanism, the latch is automatically released, thereby allowing the inner tube to be drawn into the outer tube.

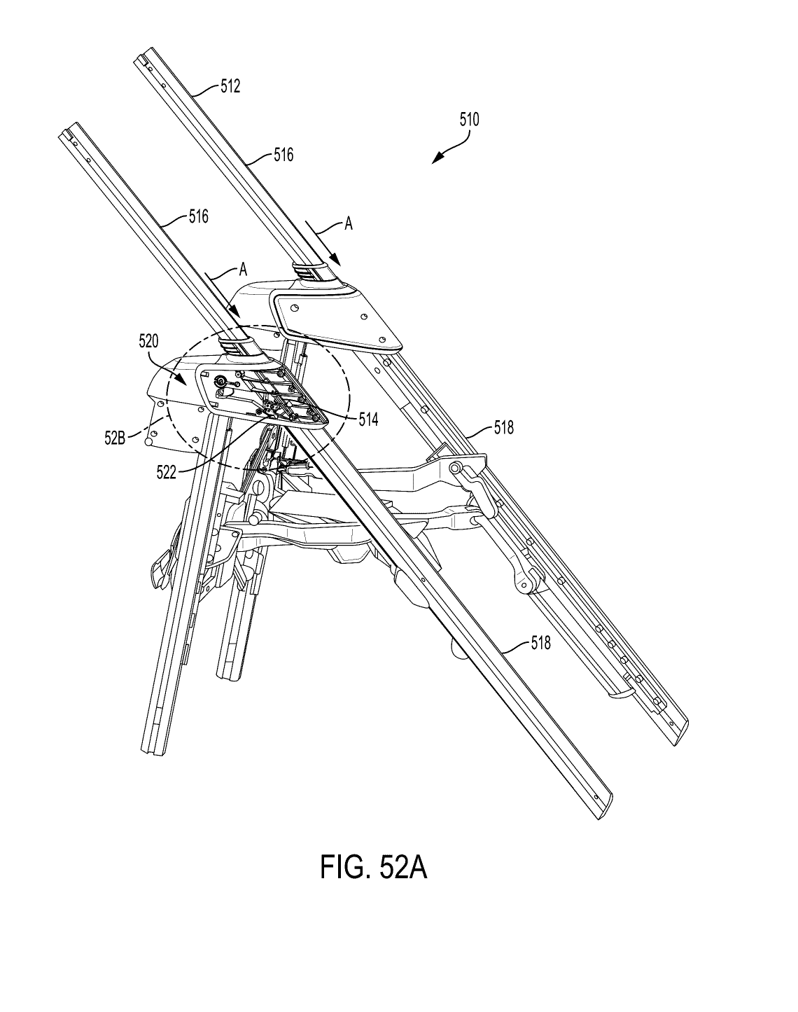

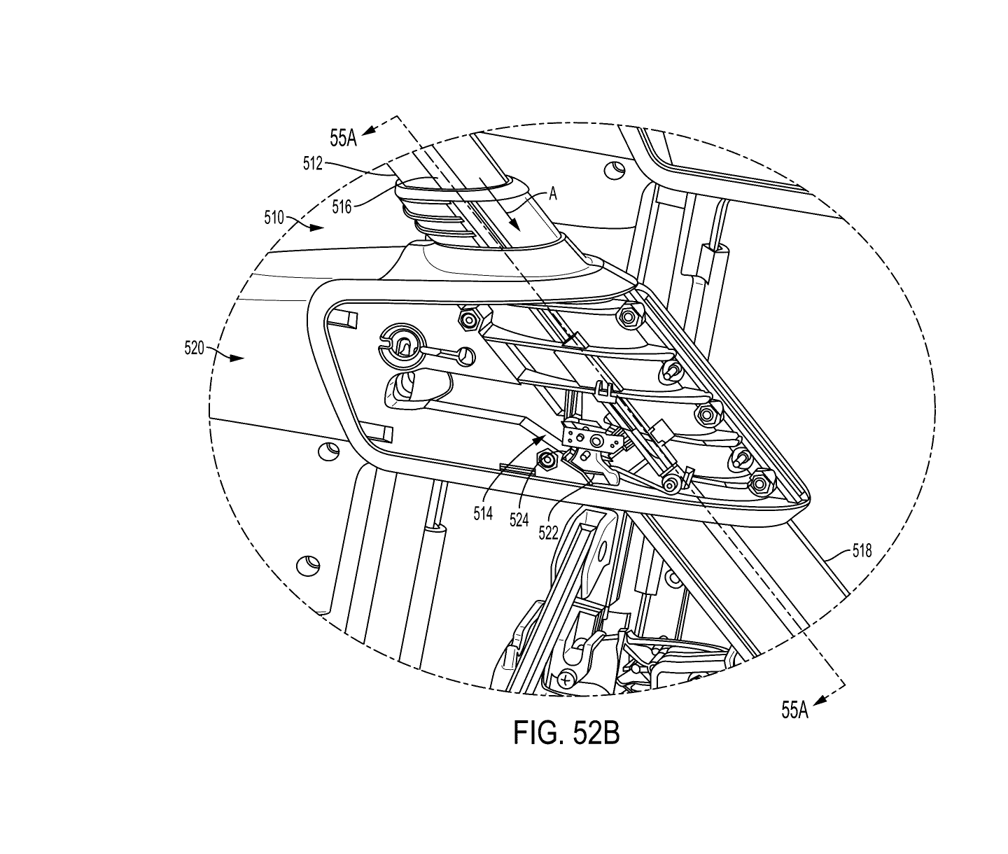

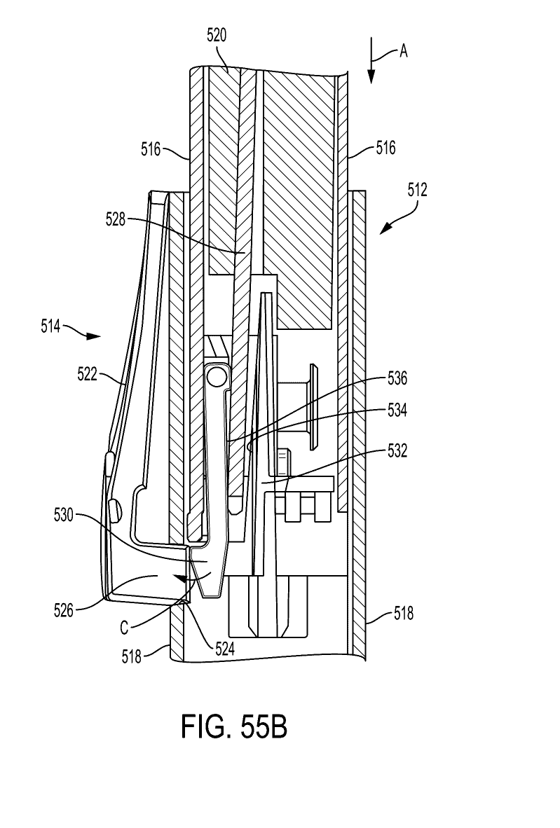

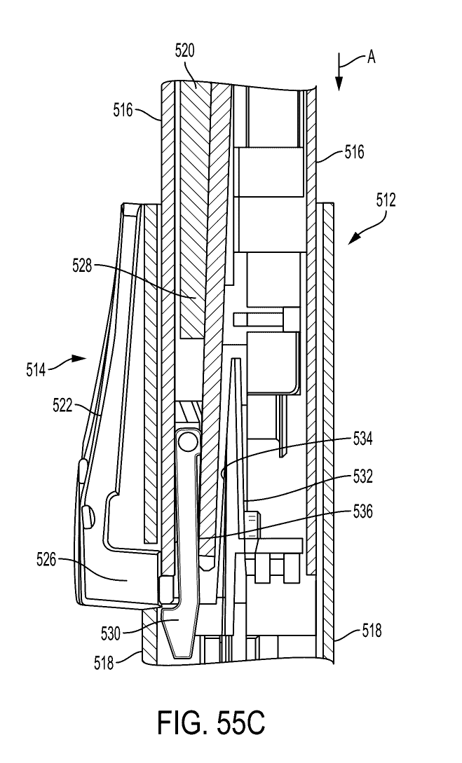

With reference to FIGS. 52A-55C, a preferred and non-limiting embodiment of a lightweight collapsible stroller 510 having a frame 512 and an automatically releasing latch mechanism 514 is illustrated. The frame 512 includes a first portion, such as an inner tube 516, which is movable relative to a second portion, such as an outer tube 518, thereby transitioning the frame 512 between an open position and a closed position. A frame 512 in an open position is shown in FIG. 52A. A lightweight collapsible stroller in a closed position is shown in FIGS. 30-32. In some examples, the first and second portions can form a telescoping tube arrangement in which the inner tube 516 is slidably inserted in the outer tube 518. In that case, as the frame 512 transitions from the open position to the closed position, the inner tube 516 slides into the outer tube 518 in the direction of arrow A (shown in FIGS. 52A, 52B, and 55A-55C) to shorten portions of the frame 512 for more convenient folding, transport, and storage of the stroller 510. In some examples, the stroller 510 further includes a child seat (shown in FIG. 33) connected to the frame 512. The stroller 512 can also include wheels (shown in FIGS. 46-51). For example, wheels can be mounted to the outer tube 518, as well as a rear support member of the frame 512.

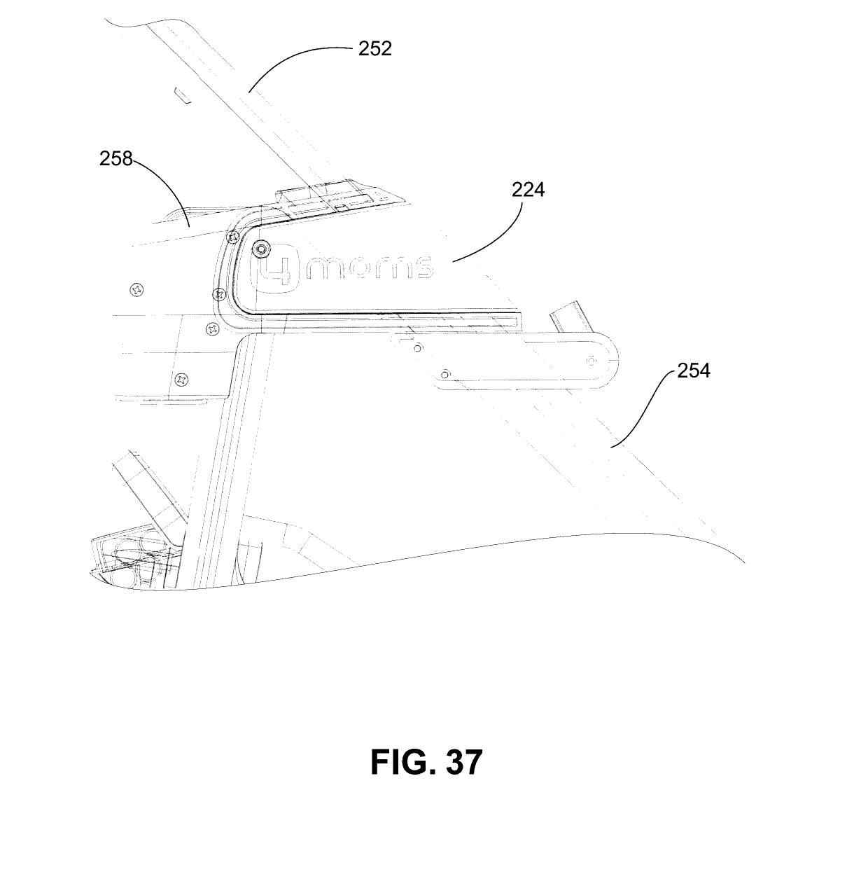

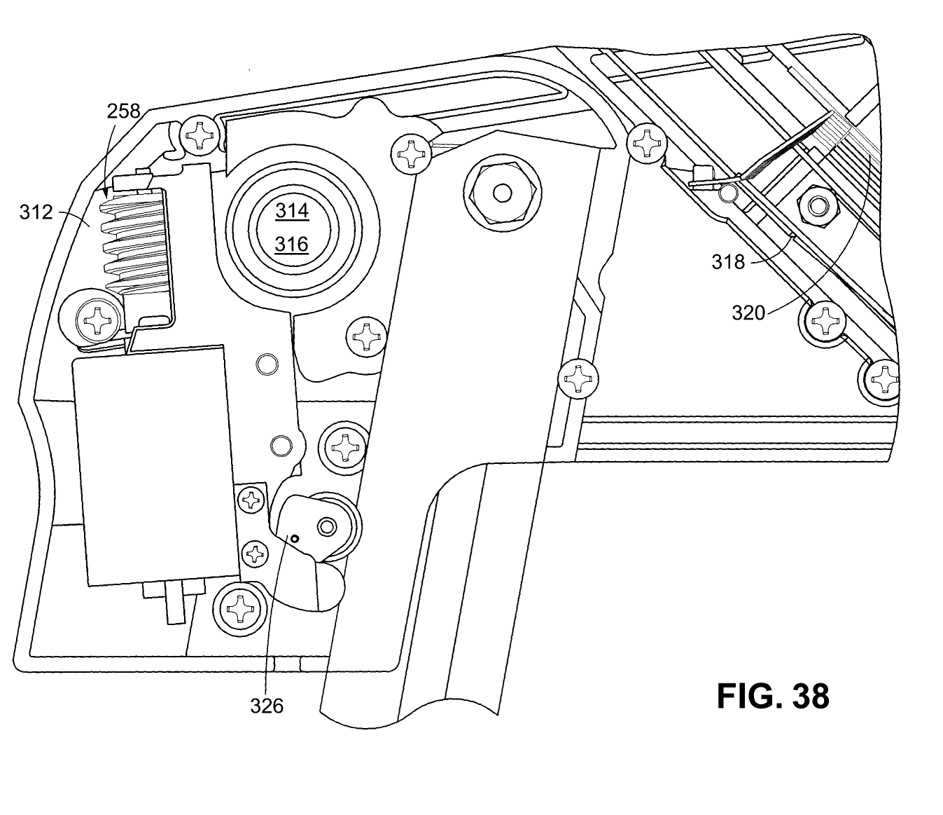

The stroller 510 also includes a drive mechanism, such as a cable drive 520, coupled to the frame 512 and configured to draw the inner tube 516 into the outer tube 518. The cable drive 520 can include a spool rotated by a motor and a cable having a first end received by the spool and a second end connected to a portion of the frame 512. For example, the cable can be connected to the inner tube 516 to draw the inner tube into the outer tube 518. Portions for an exemplary cable drive are illustrated in FIGS. 37 and 38.

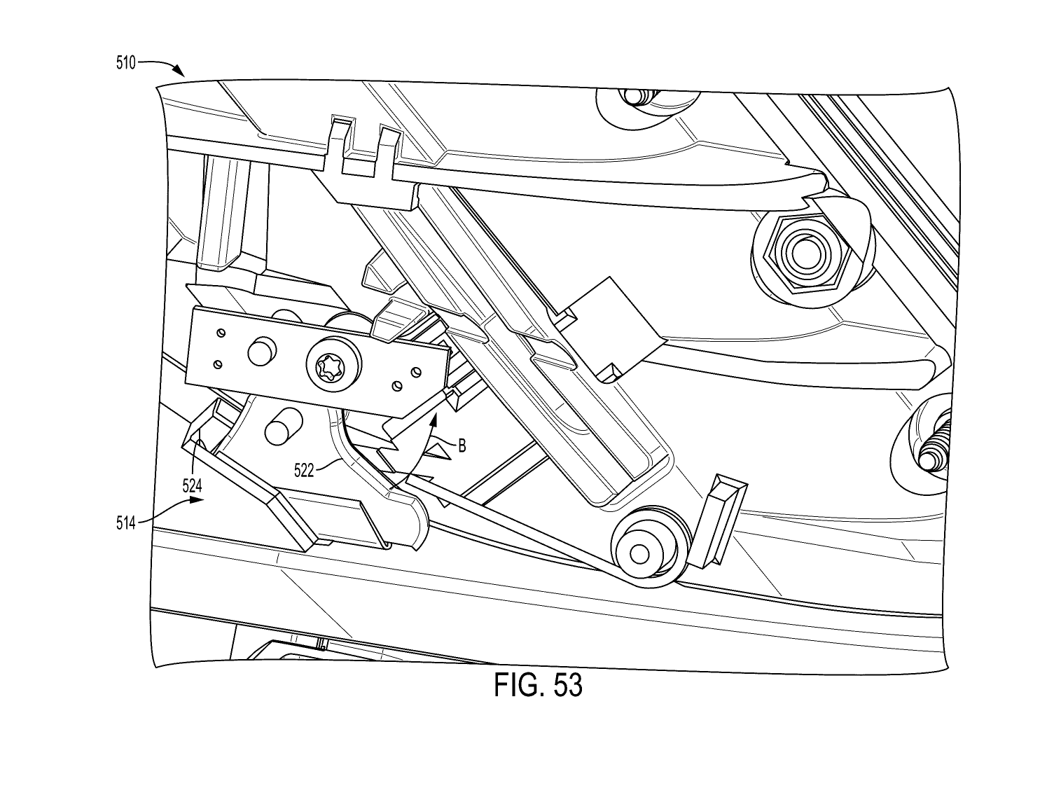

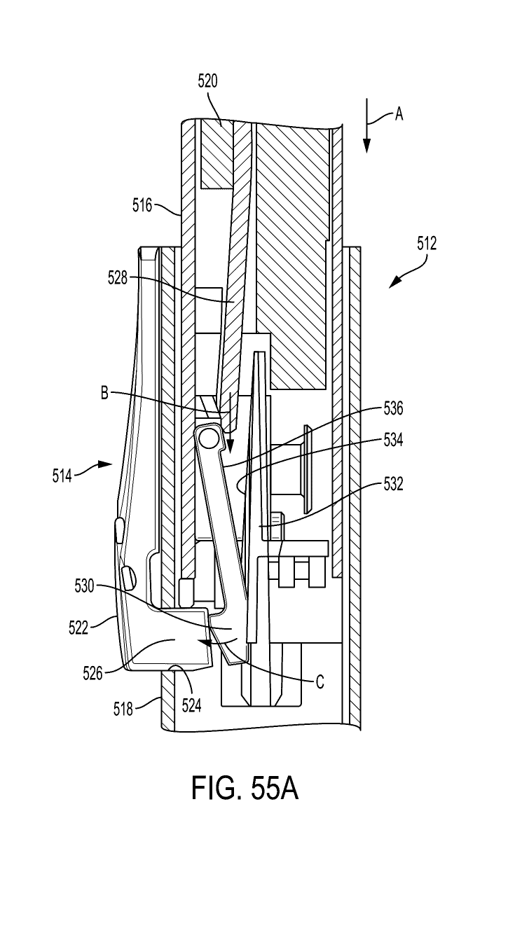

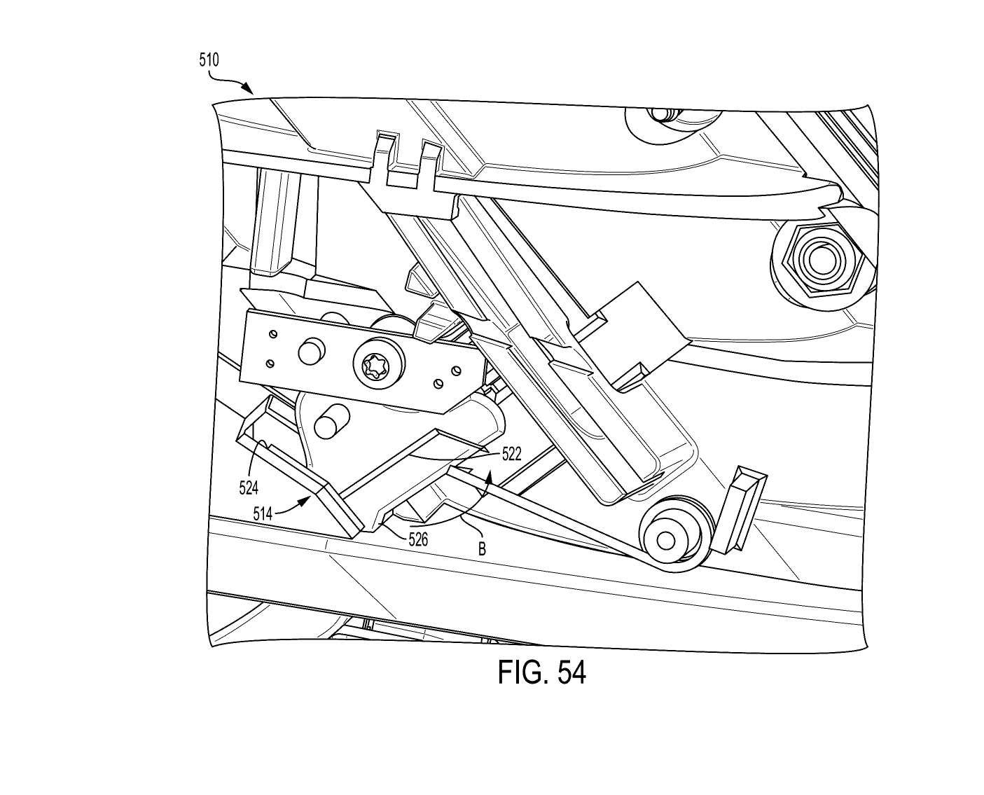

As shown in FIGS. 52B-54, the latch mechanism 514 includes a lever or latch 522, which is pivotally or rotatably mounted to the frame 512. An end 526 (shown in FIG. 54) of the lever or latch 522 is positioned to engage at least a portion of the inner tube when the frame 512 is in its open position to prevent the inner tube 516 from moving relative to the outer tube. For example, the latch 522 may be aligned with a hole or opening 524 of the outer tube 518. When the stroller 510 is in the open position, as shown in FIGS. 53 and 55A, the end 526 of the lever or latch 522 passes through the hole or opening 524 of the outer tube 518 and towards the inner tube 516. An end of the inner tube 516 is pressed against an end portion 526 (shown in FIGS. 55A-55C) of the lever or latch 522 forming a blocking engagement therebetween. The blocking engagement between the inner tube 516 and the lever or latch 522 prevents the inner tube 516 from being inserted into the outer tube 518.

As shown in FIGS. 55A-55C, a mechanism for releasing the lever or latch 522 can include a linearly actuated element 528 that is driven through the inner tube 516 by the drive mechanism or cable drive 520 in the direction of arrow B (shown in FIGS. 54 and 55A). Movement of the linearly actuated element 528 is transferred to the lever or latch 522 through a latch release hammer 530, which pivots toward the lever or latch 522, as shown by arrow C (shown in FIGS. 55A and 55B), to remove the engagement between the lever or latch 522 and the inner tube 516. The release hammer 530 is shaped to provide sufficient contact with the latch 522 to hold the latch 522 away from the inner tube 516, so that the inner tube 516 passes into the outer tube 518 when the stroller 510 is being closed. In some instances, the end portion of the release hammer 530 in contact with the lever or latch 522 may be slightly angled. The mechanism for releasing the latch 522 can also include a plane or wedge 532 having a surface 534 which is angled toward the latch release hammer 530. When driven through the inner tube 516 by the drive mechanism or cable drive 520, the linearly actuated element 528 is positioned to slide along the angled surface 534 to bring the linearly actuated element 528 into contact with a rear surface 536 of the latch release hammer 530, as shown in FIG. 55B. Continued forward movement of the linearly actuated element 528 in the direction of arrow B causes the latch release hammer 530 to pivot toward to the latch 522.

In order to close the stroller 510, a user actuates the drive mechanism or cable drive 520 of the stroller 510 by an affirmative action, such as pressing an actuation button. As shown in FIG. 55A, when the stroller 510 is in the open position, the lever or latch 522 is closed such that the end portion 526 of the lever or latch 522 is inserted through the opening 524 of the outer tube 518 to block movement of the inner tube 516. The latch release hammer 530 is in a depressed position and is not exerting a force against the lever or latch 522. In a similar manner, the linearly actuated element 528 is not in contact with the release hammer 530. In this position, the latch 522 blocks the inner tube 516 from being inserted into the outer tube 518.

Once the drive mechanism is actuated, as shown in FIG. 55B, the stroller 510 transitions to an intermediate position, in which the drive mechanism or cable drive 520 drives the linearly actuated element 528 partially forward. The linearly actuated element 528 slides along the angled surface 534 of the wedge 532 and into contact with the latch release hammer 530. Continued forward movement of the linearly actuated element 520 exerts a force on the rear surface 536 of the release hammer 520. As a result of the force, the latch release hammer 530 pivots or swings in the direction of arrow C to lift the latch 522 away from the end of the inner tube 516. In this way, actuation of the drive mechanism automatically releases the latch 522.

As shown in FIG. 55C, once the latch 522 is released, the frame 512 begins to transition to the closed position. For example, upon release of the latch 522, the cable drive 520 can begin to draw the inner tube 516 into the outer tube 518. In particular, as shown in FIG. 55C, the inner tube 516 slides into the outer tube 518 between the latch release hammer 530 and the latch 522 to close the stroller.

Although the power-folding and/or collapsible strollers have been described in detail for the purpose of illustration, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof. Further, although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A stroller comprising:
a frame comprising a first portion movable relative to a second portion;
a drive mechanism coupled to the frame, which moves the first portion relative to the second portion, thereby transitioning the frame between an open position and a closed position; and
a latch mounted to the frame and positioned to engage at least a portion of the first portion or the second portion when the frame is in its open position to restrict the first portion from moving relative to the second portion,
wherein, upon actuation, the drive mechanism causes the latch to release and the first portion of the frame to move relative to the second portion of the frame, thereby allowing the frame to transition to the closed position.

2. The stroller of claim 1, wherein the second portion of the frame comprises an outer tube, and the first portion of the frame comprises an inner tube which is at least partially received within the outer tube.

3. The stroller of claim 1, wherein the drive mechanism comprises a cable drive, at least one spool rotated by the cable drive, and at least one cable having a first end received by the at least one spool and a second end connected to the frame.

4. The stroller of claim 1, wherein the latch is pivotally mounted to the second portion and biased to engage the first portion of the frame.

5. The stroller of claim 4, wherein the engagement between the latch and the first portion is a blocking engagement in which a portion of the latch blocks the movement of the first portion of the frame relative to the second portion.

6. The stroller of claim 4, wherein, upon actuation, the drive mechanism causes the latch to pivot away from the first portion of the frame.

7. The stroller of claim 1, wherein the drive mechanism comprises a motor and a linearly actuated element extending from the motor toward the latch.

8. The stroller of claim 7, wherein the frame further comprises a latch release hammer, and wherein actuation of the motor causes the linearly actuated element to contact the latch release hammer, thereby causing the latch release hammer to press against the latch to release the latch.

9. The stroller of claim 8, wherein the frame further comprises a wedge having an angled surface positioned to direct the linearly actuated element to the latch release hammer.

10. The stroller of claim 9, wherein, upon actuation of the drive mechanism, the linearly actuated element slides along the angled surface of the wedge, thereby bringing the linearly actuated element into contact with the release hammer.

11. The stroller of claim 1, further comprising an actuation button for actuating the drive mechanism to transition the stroller from the open position to the closed position or from the closed position to the open position.

12. The stroller of claim 1, further comprising a child seat mounted to the frame.

13. The stroller of claim 1, further comprising a plurality of wheels rotatably mounted to the frame.

14. A stroller comprising:
a frame comprising a fixed outer tube and an inner tube at least partially slidably inserted in the outer tube;
a drive mechanism coupled to the frame, which causes the inner tube to slide into the outer tube as the frame transitions between an open position and a closed position; and
at least one latch mounted to the outer tube and positioned to engage at least a portion of the inner tube when the frame is in its open position to restrict the inner tube from sliding into the outer tube,
wherein, upon actuation, the drive mechanism causes the latch to release the inner tube, thereby allowing the frame to transition to the closed position.

15. The stroller of claim 14, wherein the latch is pivotally mounted to the outer tube and biased to engage an end of the inner tube when the stroller is in the open position.

16. The stroller of claim 15, wherein the engagement between the latch and the inner tube is a blocking engagement in which the latch blocks the inner tube from sliding into the outer tube.

17. The stroller of claim 15, wherein, upon actuation, the drive mechanism causes the latch to pivot away from the end of the inner tube.

18. The stroller of claim 14, wherein the drive mechanism comprises a cable drive and at least one cable having a first end received by the at least one spool and a second end connected to the frame.

19. The stroller of claim 18, wherein the drive mechanism further comprises a linearly actuated element extending from the cable drive through the inner tube toward the latch.

20. The stroller of claim 19, wherein the frame further comprises a latch release hammer disposed in the inner tube, and wherein actuation of the cable drive causes the linearly actuated element to contact the latch release hammer, thereby causing the latch release hammer to press against the latch to release the latch.
